(19) United States
(12) Patent Application Publication
(10) Pub. No.: US 2014/0058737 A1
(43) Pub. Date: Feb. 27, 2014

(54) HYBRID SOUND SIGNAL DECODER, HYBRID SOUND SIGNAL ENCODER, SOUND SIGNAL DECODING METHOD, AND SOUND SIGNAL ENCODING METHOD

(71) Applicants: Tomokazu Ishikawa, Osaka (JP); Takeshi Norimatsu, Hyogo (JP); Kok Seng Chong, Singapore (SG); Dan Zhao, Singapore (SG)

(72) Inventors: Tomokazu Ishikawa, Osaka (JP); Takeshi Norimatsu, Hyogo (JP); Kok Seng Chong, Singapore (SG); Dan Zhao, Singapore (SG)

(73) Assignee: PANASONIC CORPORATION, Osaka (JP)

(21) Appl. No.: 13/996,644

(22) PCT Filed: Oct. 24, 2012
(86) PCT No.: PCT/JP2012/006802

§ 371 Date: Jun. 21, 2013

(30) Foreign Application Priority Data
Oct. 28, 2011 (JP) 2011-236912

(51) Int. Cl. G10L 19/002

(52) U.S. Cl. CPC G10L 19/002
USPC 704/500

(57) ABSTRACT

A hybrid sound signal decoder decodes a bitstream including audio frames encoded by an audio encoding process using a low delay filter bank and speech frames encoded by a speech encoding process using linear prediction coefficients. When a current frame to be decoded is an ith frame which is an initial speech frame after switching from an audio frame to a speech frame, the hybrid sound signal decoder generates sub-frames which are a signal corresponding to an i−1th frame before being encoded, using a sub-frame which is a signal generated using a signal of the i−1th frame before being encoded, the signal of the i−1th frame being obtained by decoding the ith frame.

### TECHNICAL FIELD

The present invention relates to a hybrid sound signal decoder and a hybrid sound signal encoder capable of switching between a speech codec and an audio codec.

### BACKGROUND ART

Hybrid codec (see Patent Literature (PTL) 1, for example) is a codec which combines the advantages of audio codec and speech codec (see Non-Patent Literature (NPL) 1, for example). By switching between the audio codec and the speech codec, the hybrid codec can code a sound signal which is a mixture of content consisting mainly of a speech signal and content consisting mainly of an audio signal, using a coding method suitable for each type of content. Thus, the hybrid codec can stably compress and code the sound signal at low bit rate.

### CITATION LIST

### Patent Literature

[PTL 1] Fuchs, Guillaume “Apparatus and method for encoding/decoding and audio signal using an aliasing switch scheme”, International Patent Application Publication No. 2010/003532 A1

### Non Patent Literature

[NPL 1] Milan Jelinek, “Wideband Speech Coding Advances in VMR-WB Standard”, IEEE Transactions on Audio, Speech and Language Processing, 15 (4), 1167-1179 (2007)
[NPL 2] Chi-Min Liu and Wen-Chieh Lee, “A unified fast algorithm for cosine modulated filterbanks in current audio standards”, J. Audio Engineering 47 (12), 1061-1075 (1999)

### SUMMARY OF INVENTION

### Technical Problem

To increase the sound quality of the hybrid codec, Advanced Audio Coding—Enhanced Low Delay (AAC-ELD) mode can be used as the audio codec, for example.

However, in a coding scheme such as AAC-ELD mode, coding is performed using samples overlapping with previous frames, thereby introducing aliasing and an unnatural sound when the audio codec is switched to the speech codec which can complete the coding only with the samples within a current frame. Although PTL 1 discloses a signal process to be performed at a portion where the coding mode is switched, this process is not adaptable to a coding scheme such as AAC-ELD mode which requires an overlapping process with plural previous frames. Therefore, the method of PTL 1 cannot reduce the aliasing.

An object of the present invention is to provide a hybrid codec (a hybrid sound signal decoder and a hybrid sound signal encoder) which reduces aliasing introduced at a portion where the codec is switched between the speech codec and the audio codec, in the case of using, as the audio codec, a coding scheme such as AAC-ELD mode which requires an overlapping process with plural previous frames.

### Solution to Problem

A hybrid sound signal decoder according to an aspect of the present invention is a hybrid sound signal decoder which decodes a bitstream including audio frames encoded by an audio encoding process using a low delay filter bank and speech frames encoded by a speech encoding process using linear prediction coefficients, the hybrid sound signal decoder including: a low delay transform decoder which decodes the audio frames using an inverse low delay filter bank process; a speech signal decoder which decodes the speech frames; and a block switching unit configured to perform control to (i) allow a current frame included in the bitstream to be decoded by the low delay transform decoder when the current frame is an audio frame and (ii) allow the current frame to be decoded by the speech signal decoder when the current frame is a speech frame, wherein when the current frame is an ith frame which is an initial speech frame after switching from an audio frame to a speech frame, the ith frame includes an encoded first signal generated using a signal of an i−1th frame before being encoded, the i−1th frame being one frame previous to the ith frame, and the block switching unit is configured to (1) generate a signal corresponding to a first half of the i−1th frame before being encoded, by adding (a) a signal obtained by applying a window on a sum of a signal corresponding to a first half of a frame represented by a second signal and a signal obtained by folding a signal corresponding to a latter half of the frame represented by the second signal, (b) a signal obtained by applying a window on the first signal obtained by decoding of the ith frame by the speech signal decoder, and (c) a signal corresponding to a first half of a frame represented by a third signal, the second signal being obtained by applying a window on a reconstructed signal of an i−3th frame that is three frames previous to the ith frame, the reconstructed signal of the i−3th frame being obtained by decoding, by the low delay transform decoder, of an i−2th frame that is two frames previous to the ith frame, the third signal corresponding to the i−3th frame among frames represented by a signal obtained by applying the inverse low delay filter bank process and a window on the i−1th frame, and generate a signal corresponding to a latter half of the i−1th frame before being encoded, by adding (a) a signal obtained by applying a window on a sum of the signal corresponding to the latter half of the frame represented by the second signal and a signal obtained by folding the signal corresponding to the first half of the frame represented by the second signal, (b) a signal obtained by folding and applying a window on the first signal, and (c) a signal corresponding to a latter half of the frame represented by the third signal, or (2) generate the signal corresponding to the first half of the i−1th frame before being encoded, by adding (a) the signal obtained by applying a window on a sum of the signal corresponding to the first half of the frame represented by the second signal and the signal obtained by folding the signal corresponding to the latter half of the frame represented by the second signal, (b) the signal obtained by folding and applying a window on the first signal, and (c) the signal corresponding to the first half of the frame represented by the third signal, and generate the signal corresponding to the latter half of the i−1th frame before being encoded, by adding (a) the signal obtained by applying a window on a sum of the signal corresponding to the latter half of the frame represented by the second signal and the signal obtained by folding the signal corresponding to the first half of the frame represented by the second signal, (b) the signal obtained by applying a window on the first signal, and (c) the signal corresponding to the latter half of the frame represented by the third signal.

It is to be noted that these general or specific aspects may be implemented using a system, a method, an integrated circuit, a computer program, or a computer-readable recording medium such as CD-ROM, or any combination of systems, methods, integrated circuits, computer programs, or recording media.

### Advantageous Effects of Invention

According to an aspect of the present invention, a hybrid codec (a hybrid sound signal decoder and a hybrid sound signal encoder) including an audio codec compliant with a coding scheme such as AAC-ELD mode which requires overlapping process with plural previous frames can reduce aliasing introduced at a portion where the codec is switched between a speech codec and the audio codec.

### BRIEF DESCRIPTION OF DRAWINGS

FIG. 1 illustrates an analysis window in an encoder of AAC-ELD.

FIG. 2 illustrates a decoding process in a decoder of AAC-ELD.

FIG. 3 illustrates a synthesis window in a decoder of AAC-ELD.

FIG. 4 illustrates an amount of delay in encoding and decoding processes of AAC-ELD.

FIG. 5 illustrates a transition frame.

FIG. 6 is a block diagram illustrating a configuration of a hybrid sound signal encoder according to Embodiment 1.

FIG. 7 illustrates frames encoded when the coding mode is switched from FD coding mode to ACELP coding mode.

FIG. 8A illustrates an example of a method of generating a component X.

FIG. 8B is a flowchart of a method of generating a component X.

FIG. 9 is a block diagram illustrating a configuration of a hybrid sound signal encoder including a TCX encoder.

FIG. 10 is a block diagram illustrating a configuration of a hybrid sound signal decoder according to Embodiment 1.

FIG. 11 schematically illustrates switching control performed by a block switching unit when a signal to be decoded is switched from a signal encoded in FD coding mode to a signal encoded in ACELP coding mode.

FIG. 12A illustrates a method of reconstructing a signal of a frame i−1.

FIG. 12B is a flowchart of a method of reconstructing a signal of a frame i−1.

FIG. 13 illustrates an amount of delay in encoding and decoding processes according to Embodiment 1.

FIG. 14 is a block diagram illustrating a configuration of a hybrid sound signal decoder including a TCX decoder.

FIG. 15 illustrates a method of reconstructing a signal of a frame i−1 using a synthesis error compensation device.

FIG. 16 illustrates a decoding process on synthesis error information.

FIG. 17 illustrates frames encoded when the coding mode is switched from ACELP coding mode to FD coding mode.

FIG. 18 schematically illustrates switching control performed by a block switching unit when a signal to be decoded is switched from a signal encoded in ACELP coding mode to a signal encoded in FD coding mode.

FIG. 19 is a flowchart of a method of reconstructing a signal of a frame i−1 according to Embodiment 2.

FIG. 20A illustrates an example of a method of reconstructing a signal of a frame i−1 according to Embodiment 2.

FIG. 20B illustrates an example of a method of reconstructing a signal of a frame i−1 according to Embodiment 2.

FIG. 21 illustrates an example of a method of reconstructing a signal of a frame i according to Embodiment 2.

FIG. 22 illustrates an example of a method of reconstructing a signal of a frame i+1 according to Embodiment 2.

FIG. 23 illustrates an amount of delay in encoding and decoding processes according to Embodiment 2.

FIG. 24 illustrates a method of reconstructing a signal of a frame i−1 using an SEC device.

FIG. 25 illustrates a method of reconstructing a signal of a frame i using an SEC device.

FIG. 26 illustrates a method of reconstructing a signal of a frame i+1 using an SEC device.

FIG. 27 illustrates frames encoded when the coding mode is switched from FD coding mode to TCX coding mode.

FIG. 28 schematically illustrates switching control performed by a block switching unit when a signal to be decoded is switched from a signal encoded in FD coding mode to a signal encoded in TCX coding mode.

FIG. 29 illustrates an amount of delay in encoding and decoding processes according to Embodiment 3.

FIG. 30 illustrates frames encoded when the coding mode is switched from TCX coding mode to FD coding mode.

FIG. 31 illustrates frames encoded when the coding mode is switched from TCX coding mode to FD coding mode.

FIG. 32 illustrates an example of a method of reconstructing a signal of a frame i−1 according to Embodiment 4.

FIG. 33 illustrates an amount of delay in encoding and decoding processes according to Embodiment 4.

### DESCRIPTION OF EMBODIMENTS

### (Underlying Knowledge Forming Basis of Invention)

Speech codec is designed particularly for coding a speech signal according to the characteristics of the speech signal (see NPL 1). Speech codec achieves good sound quality and low delay when coding the speech signal at low bit rate. However, speech codec is not suitable for coding an audio signal. Thus, the sound quality when the audio signal is coded by the speech codec is low compared to the sound quality when the audio signal is coded by the audio codec such as AAC.

Currently, typical speech codecs such as Algebraic Code Excited Linear Prediction (ACELP) coding mode or Transform Coded Excitation (TCX) coding mode are based on linear prediction domain coding (see PTL 1). In ACELP coding mode, after linear prediction analysis, algebraic codebook is applied to code an excitation signal. In TCX coding mode, transform coding is used on the excitation signal after linear prediction analysis.

In contrast, audio codec is suitable for coding an audio signal. However, when the audio codec is used for a speech signal, a high bit rate is usually required to achieve consistent sound quality like the speech codec.

Hybrid codec combines the advantages of the audio codec and the speech codec. There are two branches for the coding modes of a hybrid codec. One is frequency domain (FD) coding mode, such as AAC, corresponding to the audio codec. The other is linear prediction domain (LPD) coding mode corresponding to the speech codec.

Typically, orthogonal transform coding such as AAC-LD coding mode and AAC coding mode is used as FD coding mode. Typically used as the LPD coding mode are TCX coding mode that is a frequency domain representation of Linear Prediction Coefficient (LPC) residual, and ACELP coding mode that is a time domain representation of the LPC residual.

Hybrid codec changes the coding mode depending on whether a signal to be coded is a speech signal or an audio signal (see PTL 1). The coding mode is selected between ACELP coding mode and TCX coding mode, based on the closed-loop analysis-by-synthesis technology, for example.

For real time communication such as Voice over Internet Protocol (VoIP) and video conferencing, a low delay hybrid codec is more desirable. Here, to achieve low delay, AAC-ELD coding scheme (hereinafter also simply referred to as AAC-ELD), which is an extension of AAC and AAC-LD, is used as FD coding mode. The AAC-ELD coding scheme has the following characteristics to achieve a sufficiently low delay.

1. The number of samples in one frame (frame size N, which applies throughout the Description) of AAC-ELD is as small as 512 time domain samples and 480 time domain samples.

2. Look-ahead and block switching are disabled.

3. The analysis and synthesis filter banks are modified to adopt low delay filter banks. More specifically, a long window of 4N in length is used with more overlap with the past and less overlap with the future (N/4 values are actually zero).

4. The bit reservoir is minimized, or no bit reservoir is used at all.

5. The temporal noise shaping and long term prediction functions are adapted according to the low delay frame size.

Here, the transform and the inverse transform of AAC-ELD low delay filter banks are described. The background knowledge described below is used directly in the following description.

As has been discussed above, low delay analysis and synthesis filter banks are utilized in AAC-ELD. The low delay filter banks are defined as:

$$\begin{matrix}[ Math . 1 ] & \\ {X}_{k} = - 2 {\sum }_{n = - 2 N}^{2 N - 1} {x}_{n} cos [ \frac{π}{N} ( n + \frac{1}{2} - \frac{N}{2} ) ( k + \frac{1}{2} ) ] , 0 \leq k < N & ( Equation 1 )\end{matrix}$$

Here, xₙ is the windowed input signal (to be encoded). The inverse low delay filter banks of AAC-ELD are defined as:

$${y}_{n} = - \frac{1}{N} {\sum }_{k = 0}^{N - 1} {X}_{k} cos [ \frac{π}{N} ( n + \frac{1}{2} - \frac{N}{2} ) ( k + \frac{1}{2} ) ] , 0 \leq n < 4 N \qquad [ Math . 2 ]$$

Here, Xₖ is the decoded transformed coefficients.

Firstly, the transform process in the encoder of AAC-ELD (encoding process of AAC-ELD) is described.

In AAC-ELD, four frames are encoded for one frame. More particularly, when a frame i−1 is to be encoded, the frame i−1 is concatenated with three frames i−4, i−3, and i−2 that are previous to the frame i−1, to form an extended frame in a length of 4N, and this extended frame is encoded. When the size of one frame is N, the size of the frame to be encoded is 4N.

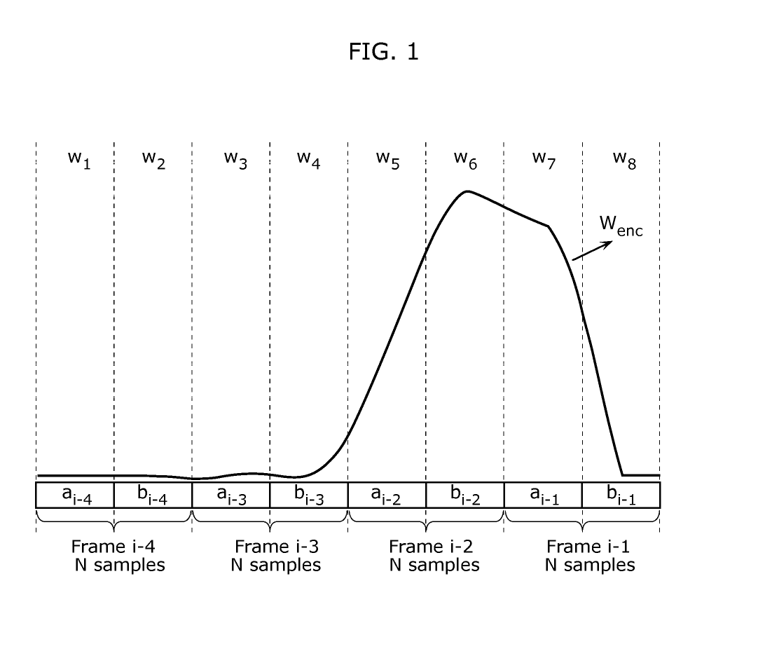

FIG. 1 illustrates the analysis window in the encoder (encoder window) of AAC-ELD, which is denoted as w_{enc}. The analysis window is in a length of 4N as described above.

For the convenience, each frame is divided into two sub-frames. For example, the frame i−1 is divided, and expressed in the form of a vector as [aᵢ₋₁, bᵢ₋₁]. Here, aᵢ₋₁ and bᵢ₋₁ are each in a length of N/2 samples. Correspondingly, the encoder window in a length of 4N is divided into eight parts, denoted as [w₁, w₂, w₃, w₄, w₅, w₆, w₇, w₈] as illustrated in FIG. 1. The extended frame is expressed as [aᵢ₋₄, bᵢ₋₄, aᵢ₋₃, bᵢ₋₃, aᵢ₋₂, bᵢ₋₂, aᵢ₋₁, bᵢ₋₁]. The encoder window is applied on the extended frame to obtain the windowed signal xₙ=[aᵢ₋₄w₁, bᵢ₋₄w₂, aᵢ₋₃w₃, bᵢ₋₃w₄, aᵢ₋₂w₅, bᵢ₋₂w₆, aᵢ₋₁w₇, bᵢ₋₁w₈].

Here, the low delay filter banks defined in Equation (1) above are used to transform the windowed signals xₙ. According to the above low delay filter banks, transformed spectral coefficients having a frame size of N are generated from the windowed signals xₙ having a frame size of 4N.

The basic algorithm of the low delay filter bank is the same as that of Modified Discrete Cosine Transform (MDCT). MDCT is a Fourier-related transform based on DCT-IV, and therefore there is a certain essentially equivalent relationship between the low delay filter bank and DCT-IV (see NPL 2). DCT-IV is defined as:

$${X}_{k} = DCT - IV ( {x}_{n} ) = {\sum }_{n = 0}^{N - 1} {x}_{n} cos [ \frac{π}{N} ( n + \frac{1}{2} ) ( k + \frac{1}{2} ) ] \qquad [ Math . 3 ]$$

DCT-IV has alternating even/odd boundary conditions as follows:

$$cos [ \frac{π}{N} ( - n - 1 + \frac{1}{2} ) ( k + \frac{1}{2} ) ] = cos [ \frac{π}{N} ( n + \frac{1}{2} ) ( k + \frac{1}{2} ) ] \\ cos [ \frac{π}{N} ( 2 N - n - 1 + \frac{1}{2} ) ( k + \frac{1}{2} ) ] = - cos [ \frac{π}{N} ( n + \frac{1}{2} ) ( k + \frac{1}{2} ) ] \qquad [ Math . 4 ]$$

With the boundary conditions, the signal of the frame i−1 transformed by the low delay filter banks can be expressed in terms of DCT-IV as follows:

[DCT−IV(−(aᵢ₋₄w₁)_{R}−bᵢ₋₄w₂+(aᵢ₋₂w₅)_{R}+bᵢ₋₂w₆),DCT−IV(−aᵢ₋₃w₃+(bᵢ₋₃w₄)_{R}+aᵢ₋₁w₇−(bᵢ₋₁w₈)_{R}] [Math. 5]

Here, (aᵢ₋₄w₁)_{R}, (aᵢ₋₂w₅)_{R}, (bᵢ₋₃w₄)_{R}, (bᵢ₋₁wₐ)_{R} are the reverse of the vector aᵢ₋₄w₁, aᵢ₋₂w₅, bᵢ₋₃w₄, bᵢ₋₁w₈, respectively.

Secondly, the inverse transform in the decoder of AAC-ELD (decoding process of AAC-ELD) is described.

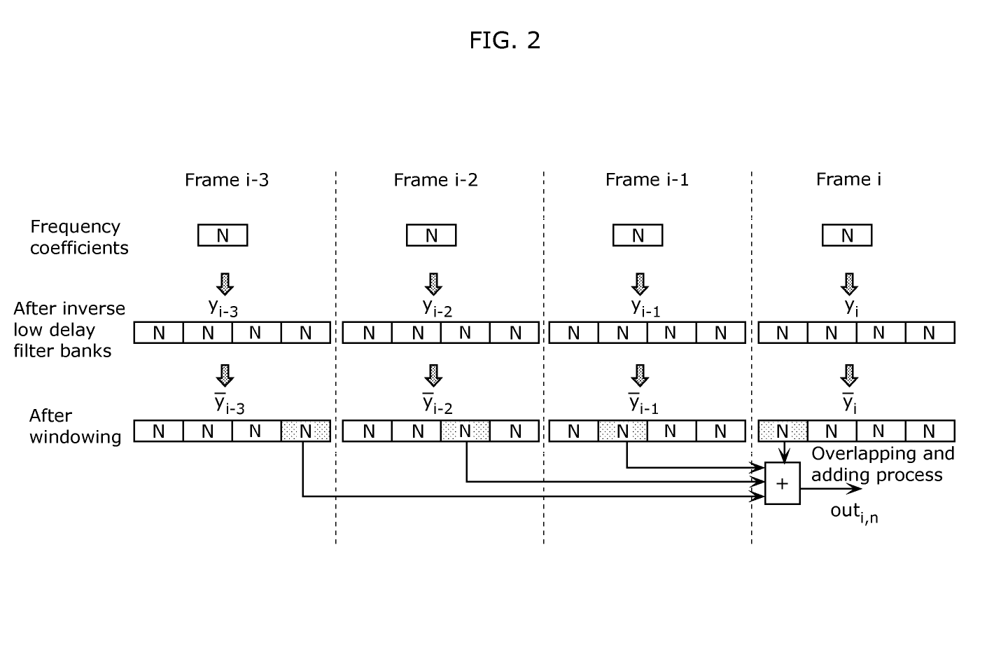

FIG. 2 illustrates the decoding process in the decoder of AAC-ELD. The output signal obtained from the decoding process has a length (frame size) of 4N. Similarly, considering the equivalent relationship between inverse MDCT and DCT-IV (see NPL 2), the inverse transformed signals for the frame i−1 are:

$${y}_{i - 1} = [ \begin{matrix}- {a}_{i - 4} {w}_{1} - {( {b}_{i - 4} {w}_{2} )}_{R} + {a}_{i - 2} {w}_{5} + {( {b}_{i - 2} {w}_{6} )}_{R} , \\ - {( {a}_{i - 4} {w}_{1} )}_{R} - {b}_{i - 4} {w}_{2} + {( {a}_{i - 2} {w}_{5} )}_{R} + {b}_{i - 2} {w}_{6} , \\ - {a}_{i - 3} {w}_{3} + {( {b}_{i - 3} {w}_{4} )}_{R} + {a}_{i - 1} {w}_{7} - {( {b}_{i - 1} {w}_{8} )}_{R} , \\ {( {a}_{i - 3} {w}_{3} )}_{R} - {b}_{i - 3} {w}_{4} - {( {a}_{i - 1} {w}_{7} )}_{R} + {b}_{i - 1} {w}_{8} , \\ {a}_{i - 4} {w}_{1} + {( {b}_{i - 4} {w}_{2} )}_{R} - {a}_{i - 2} {w}_{5} - {( {b}_{i - 2} {w}_{6} )}_{R} , \\ {( {a}_{i - 4} {w}_{1} )}_{R} + {b}_{i - 4} {w}_{2} - {( {a}_{i - 2} {w}_{5} )}_{R} - {b}_{i - 2} {w}_{6} , \\ {a}_{i - 3} {w}_{3} - {( {b}_{i - 3} {w}_{4} )}_{R} - {a}_{i - 1} {w}_{7} + {( {b}_{i - 1} {w}_{8} )}_{R} , \\ - {( {a}_{i - 3} {w}_{3} )}_{R} + {b}_{i - 3} {w}_{4} + {( {a}_{i - 1} {w}_{7} )}_{R} - {b}_{i - 1} {w}_{8}\end{matrix} ] \qquad [ Math . 6 ]$$

A synthesis window in the decoder of AAC-ELD is applied on yᵢ₋₁ to obtain the following:

y̅ᵢ₋₁ [Math. 7]

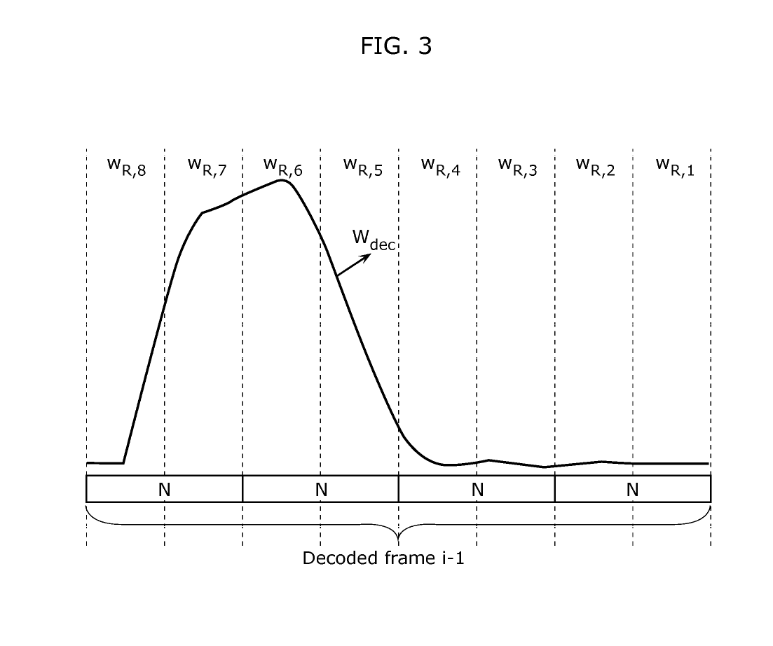

FIG. 3 illustrates the synthesis window in the decoder of AAC-ELD, which is denoted as w_{dec}. The synthesis window is the direct reverse of the analysis window in the encoder of AAC-ELD. Similar to the analysis window in the encoder of AAC-ELD, the synthesis window is divided into eight parts for the convenience as illustrated in FIG. 3. The synthesis window is expressed in the form of a vector as follows:

[w_{R,8},w_{R,7},w_{R,6},w_{R,5},w_{R,4},w_{R,3},w_{R,2},w_{R,1}] [Math. 8]

Thus, the windowed inverse transform signals

y̅ᵢ₋₁ [Math. 9]

are as follows:

$$\begin{matrix}{\overline{y}}_{i - 1} = [ \begin{matrix}( - {a}_{i - 4} {w}_{1} - {( {b}_{i - 4} {w}_{2} )}_{R} + {a}_{i - 2} {w}_{5} + {( {b}_{i - 2} {w}_{6} )}_{R} ) {w}_{R , 8} , \\ ( - {( {a}_{i - 4} {w}_{1} )}_{R} - {b}_{i - 4} {w}_{2} + {( {a}_{i - 2} {w}_{5} )}_{R} + {b}_{i - 2} {w}_{6} ) {w}_{R , 7} , \\ ( - {a}_{i - 3} {w}_{3} + {( {b}_{i - 3} {w}_{4} )}_{R} + {a}_{i - 1} {w}_{7} - {( {b}_{i - 1} {w}_{8} )}_{R} ) {w}_{R , 6} , \\ ( {( {a}_{i - 3} {w}_{3} )}_{R} - {b}_{i - 3} {w}_{4} - {( {a}_{i - 1} {w}_{7} )}_{R} + {b}_{i - 1} {w}_{8} ) {w}_{R , 5} , \\ ( {a}_{i - 4} {w}_{1} + {( {b}_{i - 4} {w}_{2} )}_{R} - {a}_{i - 2} {w}_{5} - {( {b}_{i - 2} {w}_{6} )}_{R} ) {w}_{R , 4} , \\ ( {( {a}_{i - 4} {w}_{1} )}_{R} + {b}_{i - 4} {w}_{2} - {( {a}_{i - 2} {w}_{5} )}_{R} - {b}_{i - 2} {w}_{6} ) {w}_{R , 3} , \\ ( {a}_{i - 3} {w}_{3} - {( {b}_{i - 3} {w}_{4} )}_{R} - {a}_{i - 1} {w}_{7} + {( {b}_{i - 1} {w}_{8} )}_{R} ) {w}_{R , 2} , \\ ( - {( {a}_{i - 3} {w}_{3} )}_{R} + {b}_{i - 3} {w}_{4} + {( {a}_{i - 1} {w}_{7} )}_{R} - {b}_{i - 1} {w}_{8} ) {w}_{R , 1}\end{matrix} ] \\ = {[ {c}_{- 4} , {d}_{- 4} , {c}_{- 3} , {d}_{- 3} , {c}_{- 2} , {d}_{- 2} , {c}_{- 1} , {d}_{- 1} ]}_{i - 1}\end{matrix} \qquad [ Math . 10 ]$$

In the decoding process of AAC-ELD, a current frame i is decoded in order to reconstruct the signal [aᵢ₋₁, bᵢ₋₁] of the frame i−1. To be more specific, the overlapping and adding process involving the windowed inverse transform signals of the frame i and previous three frames is applied. The overlapping and adding process illustrated in FIG. 2 is expressed as follows:

$$\begin{matrix}{out}_{i , n} = {\overline{y}}_{i , n} + {\overline{y}}_{i - 1 , n + N} + {\overline{y}}_{i - 2 , n + 2 N} + {\overline{y}}_{i - 3 , n + 3 N} , 0 \leq n < N \\ = {[ {c}_{- 4} , {d}_{- 4} ]}_{i} + {[ {c}_{- 3} , {d}_{- 3} ]}_{i - 1} + {[ {c}_{- 2} , {d}_{- 2} ]}_{i - 2} + \\ {[ {c}_{- 1} , {d}_{- 1} ]}_{i - 3}\end{matrix} \qquad [ Math . 11 ]$$

The length of the reconstructed signals is N.

The aliasing reduction can be derived based on the above overlapping and adding equation.

$$0 \leq n < \frac{N}{2} \qquad [ Math . 12 ]$$

For the above case, the following applies:

$$\begin{matrix}\begin{matrix}{out}_{i , n} = {[ {c}_{- 4} ]}_{i} + {[ {c}_{- 3} ]}_{i - 1} + {[ {c}_{- 2} ]}_{i - 2} + {[ {c}_{- 1} ]}_{i - 3} \\ = ( - {a}_{i - 3} {w}_{1} - {( {b}_{i - 3} {w}_{2} )}_{R} + {a}_{i - 1} {w}_{5} + {( {b}_{i - 1} {w}_{6} )}_{R} ) {w}_{R , 8} + \\ ( - {a}_{i - 3} {w}_{3} + {( {b}_{i - 3} {w}_{4} )}_{R} + {a}_{i - 1} {w}_{7} - {( {b}_{i - 1} {w}_{8} )}_{R} ) {w}_{R , 6} + \\ ( {a}_{i - 5} , {w}_{1} + {( {b}_{i - 5} {w}_{2} )}_{R} - {a}_{i - 3} {w}_{5} - {( {b}_{i - 3} {w}_{6} )}_{R} ) {w}_{R , 4} + \\ ( {a}_{i - 5} {w}_{3} - {( {b}_{i - 5} {w}_{4} )}_{R} - {a}_{i - 3} {w}_{7} + {( {b}_{i - 3} {w}_{8} )}_{R} ) {w}_{R , 2} \\ = {a}_{i - 5} ( {w}_{3} {w}_{R , 2} + {w}_{1} {w}_{R , 4} ) + \\ {a}_{i - 3} ( - {w}_{7} {w}_{R , 2} - {w}_{5} {w}_{R , 4} - {w}_{1} {w}_{R , 8} - {w}_{3} {w}_{R , 6} ) + \\ {a}_{i - 1} ( {w}_{7} {w}_{R , 6} + {w}_{5} {w}_{R , 8} )\end{matrix} \\ Furthermore , & [ Math . 13 ] \\ \frac{N}{2} \leq n < N & [ Math . 14 ]\end{matrix}$$

for the above case, the following applies:

$$\begin{matrix}\begin{matrix}{out}_{i , n} = {[ {d}_{- 4} ]}_{i} + {[ {d}_{- 3} ]}_{i - 1} + {[ {d}_{- 2} ]}_{i - 2} + {[ {d}_{- 1} ]}_{i - 3} \\ = ( - {( {a}_{i - 3} {w}_{1} )}_{R} - {b}_{i - 3} {w}_{2} + {( {a}_{i - 1} {w}_{5} )}_{R} + {b}_{i - 1} {w}_{6} ) {w}_{R , 7} + \\ ( {( {a}_{i - 3} {w}_{3} )}_{R} - {b}_{i - 3} {w}_{4} - {( {a}_{i - 1} {w}_{7} )}_{R} + {b}_{i - 1} {w}_{8} ) {w}_{R , 5} + \\ ( {( {a}_{i - 5} {w}_{1} )}_{R} + {b}_{i - 5} {w}_{2} - {( {a}_{i - 3} {w}_{5} )}_{R} - {b}_{i - 3} {w}_{6} ) {w}_{R , 3} + \\ ( - {( {a}_{i - 5} {w}_{3} )}_{R} + {b}_{i - 5} {w}_{4} + {( {a}_{i - 3} {w}_{7} )}_{R} - {b}_{i - 3} {w}_{8} ) {w}_{R , 1} \\ = {b}_{i - 5} ( {w}_{4} {w}_{R , 1} + {w}_{2} {w}_{R , 3} ) + \\ {b}_{i - 3} ( - {w}_{8} {w}_{R , 1} - {w}_{6} {w}_{R , 3} - {w}_{4} {w}_{R , 5} - {w}_{2} {w}_{R , 7} ) + \\ {b}_{i - 1} ( {w}_{8} {w}_{R , 5} + {w}_{6} {w}_{R , 7} )\end{matrix} & [ Math . 15 ]\end{matrix}$$

Furthermore, according to the window properties below, the signal [aᵢ₋₁, bᵢ₋₁] of the frame i−1 is reconstructed through the overlapping and adding process.

$${w}_{3} {w}_{R , 2} + {w}_{1} {w}_{R , 4} \approx 0 \\ - {w}_{7} {w}_{R , 2} - {w}_{5} {w}_{R , 4} - {w}_{1} {w}_{R , 8} - {w}_{3} {w}_{R , 6} \approx 0 \\ {w}_{7} {w}_{R , 6} + {w}_{5} {w}_{R , 8} \approx 1 \\ {w}_{4} {w}_{R , 1} + {w}_{2} {w}_{R , 3} \approx 0 \\ - {w}_{8} {w}_{R , 1} - {w}_{6} {w}_{R , 3} - {w}_{4} {w}_{R , 5} - {w}_{2} {w}_{R , 7} \approx 0 \\ {w}_{8} {w}_{R , 5} + {w}_{6} {w}_{R , 7} \approx 1 \qquad [ Math . 16 ]$$

Here, an amount of delay in the encoding and decoding processes of AAC-ELD is described.

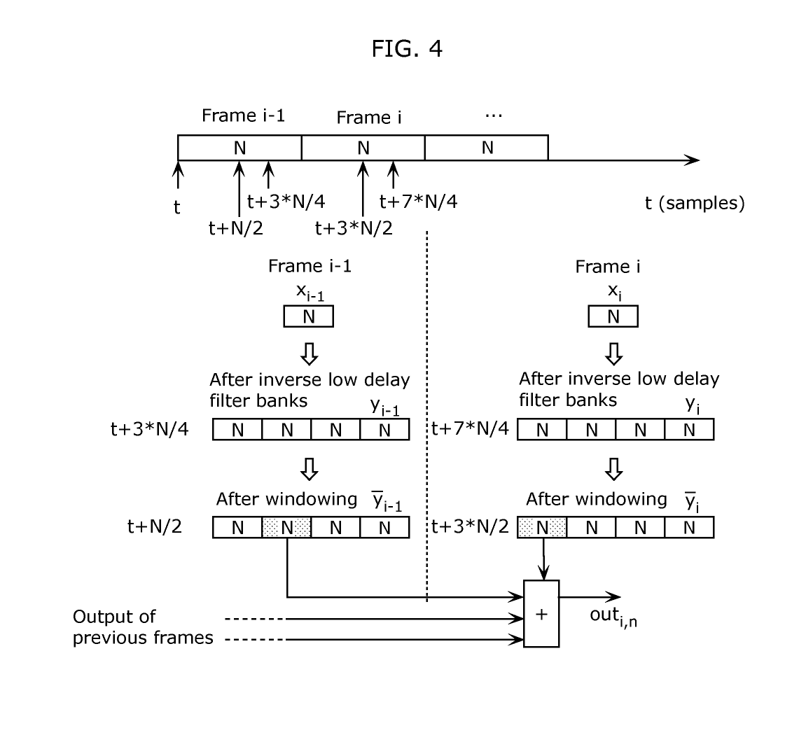

FIG. 4 illustrates the amount of delay in the encoding and decoding processes of AAC-ELD. In FIG. 4, it is assumed that the encoding process on the frame i−1 starts at the time t.

As illustrated in FIG. 1, the analysis window w₈ in the encoder of AAC-ELD corresponding to the latter N/4 samples is zero. Thus, at the time of t+3*N/4 samples, xᵢ₋₁ is ready to be MDCT-transformed and an IMDCT-transformed signal yᵢ₋₁ is obtained as illustrated in FIG. 4.

Similarly, at the time of t+7*N/4 samples, an IMDCT-transformed signal yᵢ is obtained as illustrated in FIG. 4.

A window and the overlapping and adding process are then applied on yᵢ₋₁, yᵢ to generate out_{i,n}. Here, too, as illustrated in FIG. 3, the synthesis window w_{R,8} in the decoder of AAC-ELD corresponding to the first N/4 samples is zero. Thus, at N/4 samples before

y̅ᵢ [Math. 17]

becomes available, sound output can start. In other words, sound output starts at (t+7*N/4)−N/4=t+3*N/2 samples. Therefore, the amount of delay in the encoding and decoding processes of AAC-ELD is 3*N/2 samples, which is a low delay.

As described thus far, in AAC-ELD, MDCT is performed on four consecutive frames and then, the overlapping and adding process is applied on the four frames as illustrated in FIG. 2. Use of such AAC-ELD for the hybrid codec increases the sound quality and further reduces the amount of delay. It is to be noted that the MDCT transform is also involved in TCX coding mode. In TCX coding mode, each frame includes a plurality of blocks, and the MDCT transform is performed on these consecutive blocks where subsequent blocks are overlapped so that the latter half of one block coincides with the first half of the next block.

In AAC-ELD, decoding is performed through the overlapping and adding process using previous frames and a subsequent frame as described above. Thus, aliasing is introduced at the time of decoding a transition frame, which is an initial frame after the coding mode is switched from LPD coding mode to AAC-ELD, or from AAC-ELD to LPD coding mode.

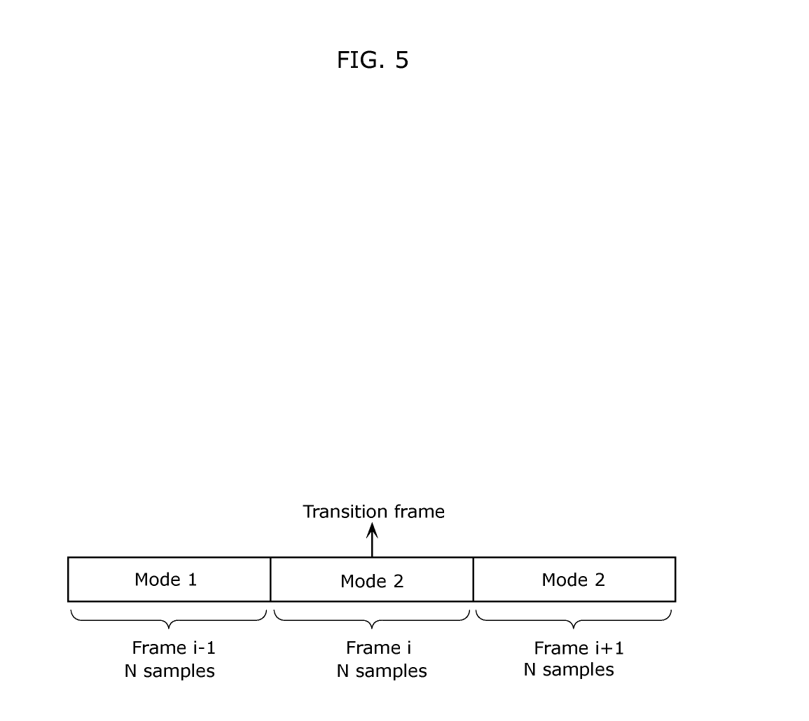

FIG. 5 illustrates a transition frame. The frame i in FIG. 5 is the transition frame. For example, when the mode 1 is AAC-ELD and the mode 2 is LPD coding mode, aliasing is introduced at the time of decoding the frame i. Similarly, when the mode 1 is LPD coding mode and the mode 2 is AAC-ELD, aliasing is introduced at the time of decoding the frame i.

The aliasing introduced in the transition frame usually causes audible artefacts. The method disclosed in PTL 1 cannot reduce the introduced aliasing because the method disclosed in PTL 1 is not adaptable to a coding scheme such as AAC-ELD which requires the overlapping process using plural previous frames.

In order to solve such a problem, a hybrid sound signal decoder according to an aspect of the present invention is a hybrid sound signal decoder which decodes a bitstream including audio frames encoded by an audio encoding process using a low delay filter bank and speech frames encoded by a speech encoding process using linear prediction coefficients, the hybrid sound signal decoder including: a low delay transform decoder which decodes the audio frames using an inverse low delay filter bank process; a speech signal decoder which decodes the speech frames; and a block switching unit configured to perform control to (i) allow a current frame included in the bitstream to be decoded by the low delay transform decoder when the current frame is an audio frame and (ii) allow the current frame to be decoded by the speech signal decoder when the current frame is a speech frame, wherein when the current frame is an ith frame which is an initial speech frame after switching from an audio frame to a speech frame, the ith frame includes an encoded first signal generated using a signal of an i−1th frame before being encoded, the i−1th frame being one frame previous to the ith frame, and the block switching unit is configured to (1) generate a signal corresponding to a first half of the i−1th frame before being encoded, by adding (a) a signal obtained by applying a window on a sum of a signal corresponding to a first half of a frame represented by a second signal and a signal obtained by folding a signal corresponding to a latter half of the frame represented by the second signal, (b) a signal obtained by applying a window on the first signal obtained by decoding of the ith frame by the speech signal decoder, and (c) a signal corresponding to a first half of a frame represented by a third signal, the second signal being obtained by applying a window on a reconstructed signal of an i−3th frame that is three frames previous to the ith frame, the reconstructed signal of the i−3th frame being obtained by decoding, by the low delay transform decoder, of an i−2th frame that is two frames previous to the ith frame, the third signal corresponding to the i−3th frame among frames represented by a signal obtained by applying the inverse low delay filter bank process and a window on the i−1th frame, and generate a signal corresponding to a latter half of the i−1th frame before being encoded, by adding (a) a signal obtained by applying a window on a sum of the signal corresponding to the latter half of the frame represented by the second signal and a signal obtained by folding the signal corresponding to the first half of the frame represented by the second signal, (b) a signal obtained by folding and applying a window on the first signal, and (c) a signal corresponding to a latter half of the frame represented by the third signal, or (2) generate the signal corresponding to the first half of the i−1th frame before being encoded, by adding (a) the signal obtained by applying a window on a sum of the signal corresponding to the first half of the frame represented by the second signal and the signal obtained by folding the signal corresponding to the latter half of the frame represented by the second signal, (b) the signal obtained by folding and applying a window on the first signal, and (c) the signal corresponding to the first half of the frame represented by the third signal, and generate the signal corresponding to the latter half of the i−1th frame before being encoded, by adding (a) the signal obtained by applying a window on a sum of the signal corresponding to the latter half of the frame represented by the second signal and the signal obtained by folding the signal corresponding to the first half of the frame represented by the second signal, (b) the signal obtained by applying a window on the first signal, and (c) the signal corresponding to the latter half of the frame represented by the third signal.

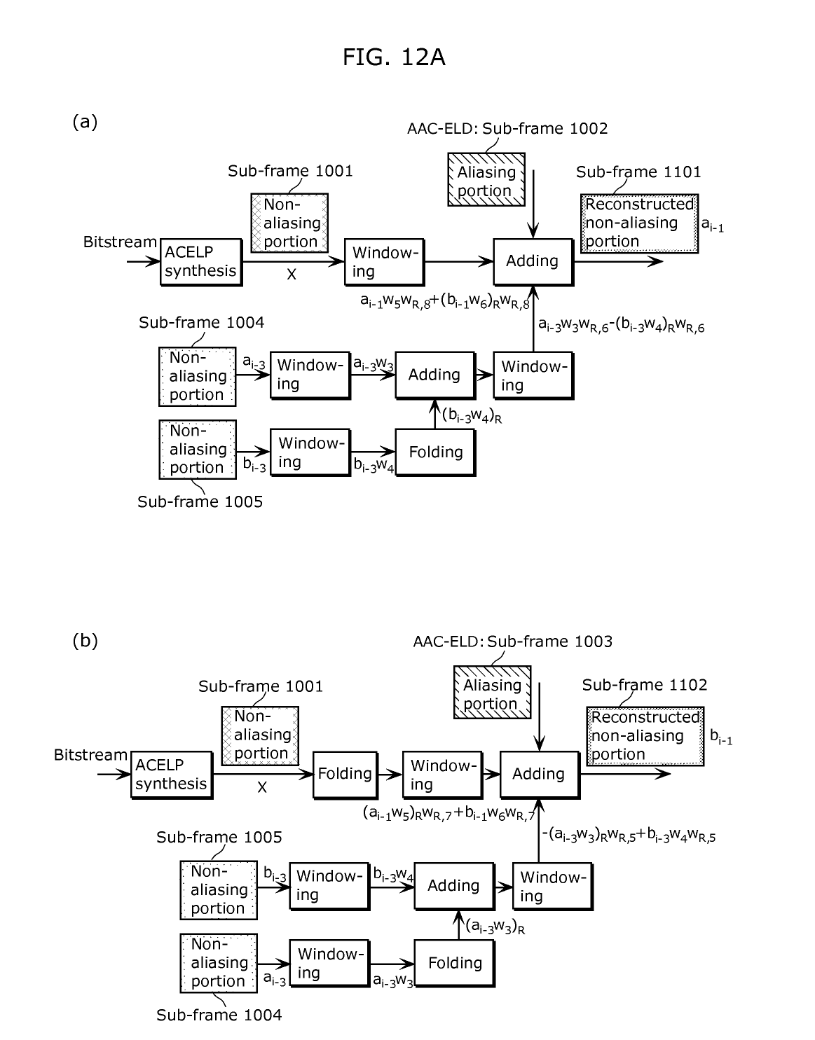

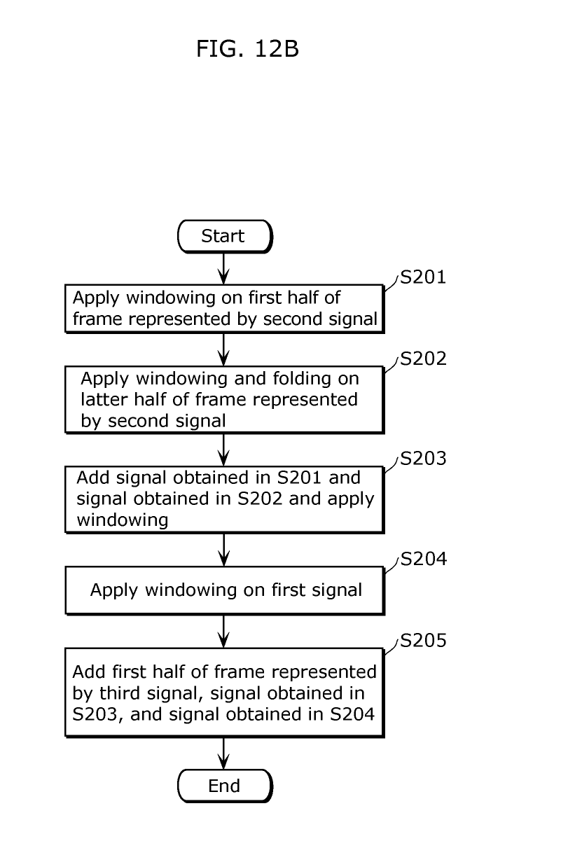

More specifically, the block switching unit performs the processing illustrated in FIG. 12A. This makes it possible to reduce the aliasing introduced when decoding the initial frame after the coding mode is switched from FD coding mode to LPD coding mode. As a result, the FD decoding technology and the LPD decoding technology can be switched seamlessly.

Furthermore, a hybrid sound signal decoder according to an aspect of the present invention may be a hybrid sound signal decoder which decodes a bitstream including audio frames encoded by an audio encoding process using a low delay filter bank and speech frames encoded by a speech encoding process using linear prediction coefficients, the hybrid sound signal decoder including: a low delay transform decoder which decodes the audio frames using an inverse low delay filter bank process; a speech signal decoder which decodes the speech frames; and a block switching unit configured to perform control to (i) allow a current frame included in the bitstream to be decoded by the low delay transform decoder when the current frame is an audio frame and (ii) allow the current frame to be decoded by the speech signal decoder when the current frame is a speech frame, wherein when the current frame is an ith frame which is an initial audio frame after switching from a speech frame to an audio frame, the block switching unit is configured to generate a reconstructed signal which is a signal corresponding to an i−1th frame before being encoded, by adding (a) a fifth signal obtained by applying a window on a sum of a fourth signal obtained by applying a window on a signal obtained by decoding of the i−1th frame by the speech signal decoder and a signal obtained by folding the fourth signal, (b) a seventh signal obtained by applying a window on a sum of a sixth signal obtained by applying a window on a signal obtained by decoding of an i−3th frame by the speech signal decoder and a signal obtained by folding the sixth signal, and (c) an eighth signal corresponding to the i−3th frame among frames represented by a signal obtained by applying the inverse low delay filter bank process and a window on the ith frame, the i−1th frame being one frame previous to the ith frame, the i−3th frame being three frames previous to the ith frame.

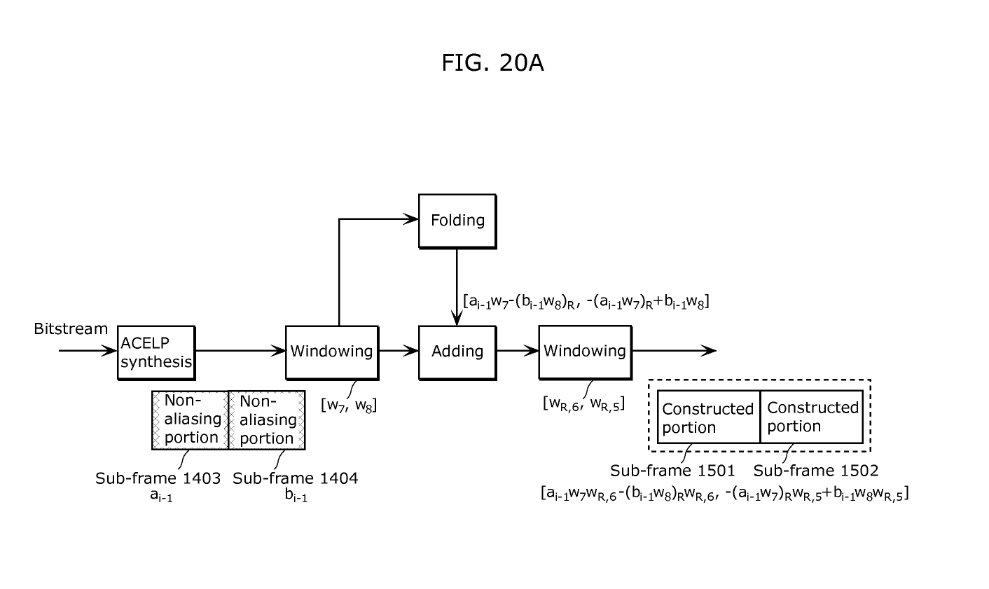

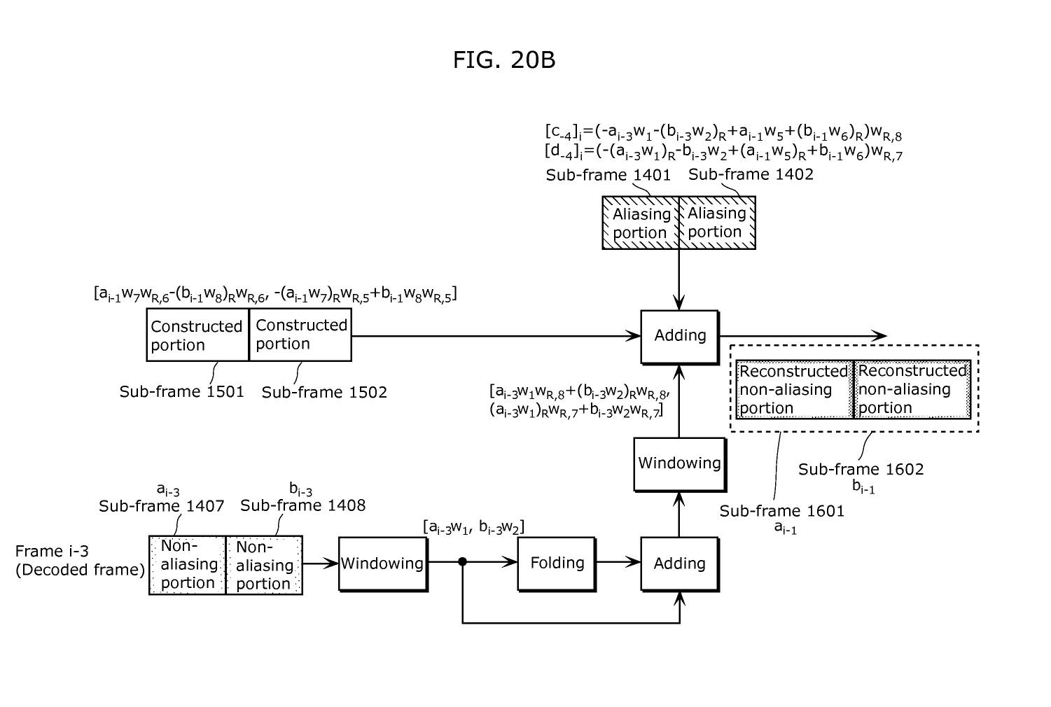

More specifically, the block switching unit performs the processing illustrated in FIG. 20A and FIG. 20B. This makes it possible to reduce the aliasing introduced when decoding the initial frame after the coding mode is switched from LPD coding mode to FD coding mode. As a result, the FD decoding technology and the LPD decoding technology can be switched seamlessly.

Furthermore, according to an aspect of the present invention, when the current frame is an i+1th frame that is one frame subsequent to the ith frame, the block switching unit may be configured to generate a signal corresponding to the ith frame before being encoded, by adding (a) a ninth signal corresponding to an i−2th frame among frames represented by a signal obtained by applying the inverse low delay filter bank process and a window on the i+1th frame, (b) a tenth signal corresponding to the i−2th frame among frames represented by a signal obtained by applying the inverse low delay filter bank process and a window on the ith frame, (c) a thirteenth signal obtained by applying a window on a combination of (c-1) a twelfth signal which is a sum of a signal corresponding to a first half of a frame represented by a signal obtained by applying a first window on an eleventh signal obtained by decoding of the i−2th frame by the speech signal decoder and a signal obtained by folding a signal corresponding to a latter half of the frame represented by the signal obtained by applying the first window on the eleventh signal and (c-2) a signal obtained by folding the twelfth signal, and (d) a fifteenth signal obtained by applying a window on a combination of (d-1) a fourteenth signal which is a sum of a signal corresponding to a first half of a frame represented by a signal obtained by applying, on the eleventh signal, a second window different from the first window and a signal obtained by folding a signal corresponding to a latter half of the frame represented by the signal obtained by applying the second window on the eleventh signal and (d-2) a signal obtained by folding the fourteenth signal and reversing a sign of the folded fourteenth signal, the i−2th frame being two frames previous to the ith frame.

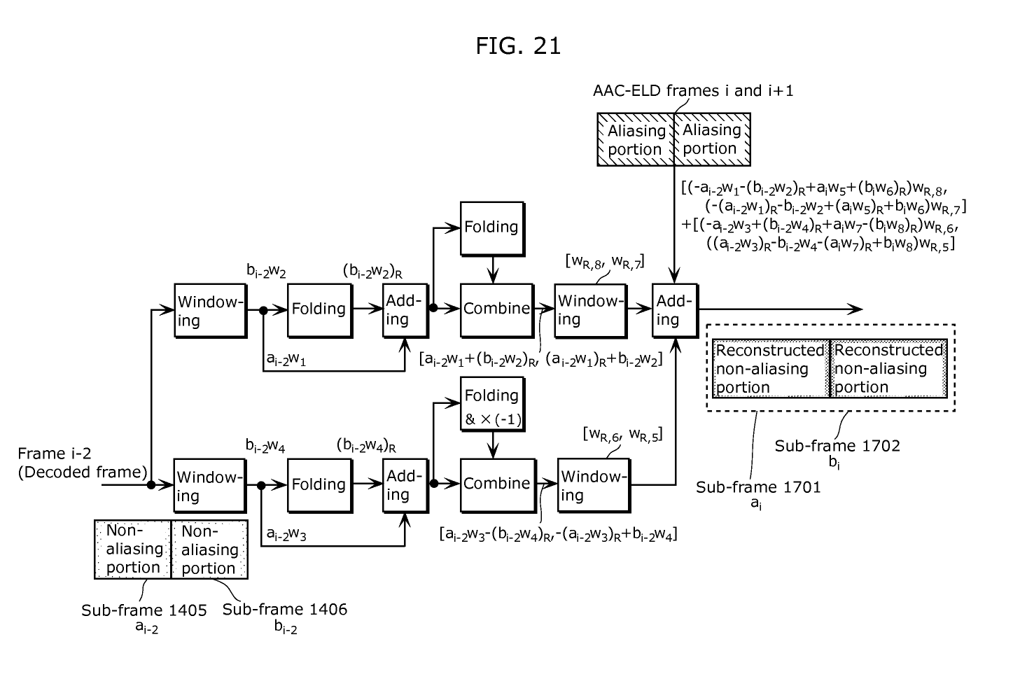

More specifically, the block switching unit performs the processing illustrated in FIG. 21. This makes it possible to reduce the aliasing introduced when decoding a frame which is one frame subsequent to the initial frame after the coding mode is switched from LPD coding mode to FD coding mode.

Furthermore, according to an aspect of the present invention, when the current frame is an i+2th frame that is two frames subsequent to the ith frame, the block switching unit may be configured to generate a signal corresponding to the i+1th frame before being encoded, by adding (a) a sixteenth signal corresponding to the i−1th frame among frames represented by a signal obtained by applying the inverse low delay filter bank process and a window on the i+2th frame, (b) a seventeenth signal corresponding to the i−1th frame among frames represented by a signal obtained by applying the inverse low delay filter bank process and a window on the i+1th frame, (c) an eighteenth signal corresponding to the i−1th frame among frames represented by a signal obtained by applying the inverse low delay filter bank process and a window on the ith frame, (d) a twenty-first signal obtained by applying a window on a combination of (d-1) a twentieth signal which is a sum of a signal corresponding to a first half of a frame represented by a signal obtained by applying a window on a nineteenth signal obtained by decoding of the i−3th frame by the speech signal decoder and a signal obtained by folding a signal corresponding to a latter half of the frame represented by the signal obtained by applying the window on the nineteenth signal and (d-2) a signal obtained by folding the twentieth signal, and (e) a twenty-third signal obtained by applying a window on a combination of (e-1) a twenty-second signal which is a sum of a signal corresponding to a first half of a frame represented by a signal obtained by applying a window on the reconstructed signal and a signal obtained by folding a signal corresponding to a latter half of the frame represented by the signal obtained by applying the window on the reconstructed signal and (e-2) a signal obtained by folding the twenty-second signal and reversing a sign of the folded twenty-second signal.

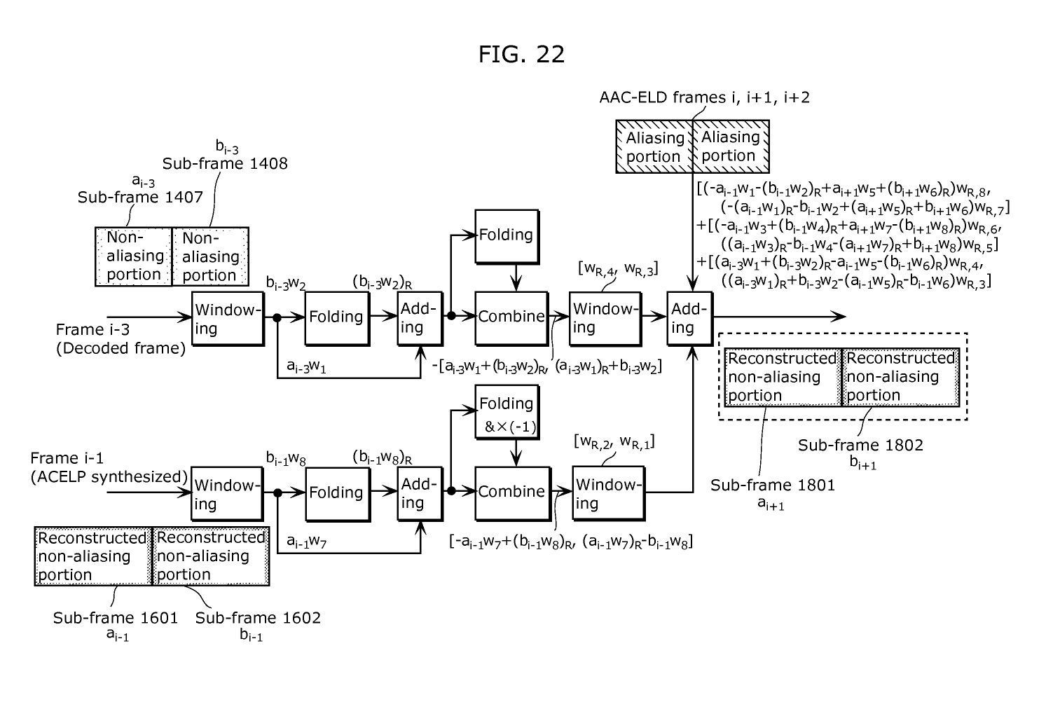

More specifically, the block switching unit performs the processing illustrated in FIG. 22. This makes it possible to reduce the aliasing introduced when decoding a frame which is two frames subsequent to the initial frame after the coding mode is switched from LPD coding mode to FD coding mode.

Furthermore, a hybrid sound signal decoder according to an aspect of the present invention may be a hybrid sound signal decoder which decodes a bitstream including audio frames encoded by an audio encoding process using a low delay filter bank and speech frames encoded by a speech encoding process using linear prediction coefficients, the hybrid sound signal decoder including: a low delay transform decoder which decodes the audio frames using an inverse low delay filter bank process; a Transform Coded Excitation (TCX) decoder which decodes the speech frames encoded in a TCX scheme; and a block switching unit configured to perform control to (i) allow a current frame included in the bitstream to be decoded by the low delay transform decoder when the current frame is an audio frame and (ii) allow the current frame to be decoded by the TCX decoder when the current frame is a speech frame, wherein when the current frame is an ith frame which is an initial speech frame after switching from an audio frame to a speech frame and which is a frame including an encoded transient signal, the ith frame includes an encoded first signal generated using a signal of an i−1th frame before being encoded, the i−1th frame being one frame previous to the ith frame, and the block switching unit is configured to (1) generate a signal corresponding to a first half of the i−1th frame before being encoded, by adding (a) a signal obtained by applying a window on a sum of a signal corresponding to a first half of a frame represented by a second signal and a signal obtained by folding a signal corresponding to a latter half of the frame represented by the second signal, (b) a signal obtained by applying a window on the first signal obtained by decoding of the ith frame by the TCX decoder, and (c) a signal corresponding to a first half of a frame represented by a third signal, the second signal being obtained by applying a window on a reconstructed signal of an i−3th frame that is three frames previous to the ith frame, the reconstructed signal of the i−3th frame being obtained by decoding, by the low delay transform decoder, of an i−2th frame that is two frames previous to the ith frame, the third signal corresponding to the i−3th frame among frames represented by a signal obtained by applying the inverse low delay filter bank process and a window on the i−1th frame, and generate a signal corresponding to a latter half of the i−1th frame before being encoded, by adding (a) a signal obtained by applying a window on a sum of the signal corresponding to the latter half of the frame represented by the second signal and a signal obtained by folding the signal corresponding to the first half of the frame represented by the second signal, (b) a signal obtained by folding and applying a window on the first signal, and (c) a signal corresponding to a latter half of the frame represented by the third signal, or (2) generate the signal corresponding to the first half of the i−1th frame before being encoded, by adding (a) the signal obtained by applying a window on a sum of the signal corresponding to the first half of the frame represented by the second signal and the signal obtained by folding the signal corresponding to the latter half of the frame represented by the second signal, (b) the signal obtained by folding and applying a window on the first signal, and (c) the signal corresponding to the first half of the frame represented by the third signal, and generate the signal corresponding to the latter half of the i−1th frame before being encoded, by adding (a) the signal obtained by applying a window on a sum of the signal corresponding to the latter half of the frame represented by the second signal and the signal obtained by folding the signal corresponding to the first half of the frame represented by the second signal, (b) the signal obtained by applying a window on the first signal, and (c) the signal corresponding to the latter half of the frame represented by the third signal.

More specifically, the block switching unit performs the processing illustrated in FIG. 12A to decode an encoded signal including a transient signal (transient frame) in FD coding mode. By doing so, the sound quality when decoding the transient frame can be increased.

Furthermore, according to an aspect of the present invention, the low delay transform decoder may be an Advanced Audio Coding—Enhanced Low Delay (AAC-ELD) decoder which decodes each of the audio frames by applying an overlapping and adding process on each of signals obtained by applying the inverse low delay filter bank process and a window on the audio frame and each of three temporally consecutive frames which are previous to the audio frame.

Furthermore, according to an aspect of the present invention, the speech signal decoder may be an Algebraic Code Excited Linear Prediction (ACELP) decoder which decodes the speech frames encoded using ACELP coefficients.

Furthermore, according to an aspect of the present invention, the speech signal decoder may be a Transform Coded Excitation (TCX) decoder which decodes the speech frames encoded in a TCX scheme.

Furthermore, a hybrid sound signal decoder according to an aspect of the present invention may be a hybrid sound signal decoder further including a synthesis error compensation device which decodes synthesis error information encoded with the current frame, wherein the synthesis error information is information indicating a difference between a signal representing the bitstream before being encoded and a signal obtained by decoding the bitstream, and the synthesis error compensation device corrects, using the decoded synthesis error information, the signal generated by the block switching unit and representing the i−1th frame before being encoded, a signal generated by the block switching unit and representing the ith frame before being encoded, or a signal generated by the block switching unit and representing an i+1th frame before being encoded.

With this, the synthesis error introduced in the hybrid sound signal decoder as a result of switching of the coding mode can be reduced, and the sound quality can be increased.

Furthermore, a hybrid sound signal encoder according to an aspect of the present invention is a hybrid sound signal encoder including: a signal classifying unit configured to analyze audio characteristics of a sound signal to determine whether a frame included in the sound signal is an audio signal or a speech signal; a low delay transform encoder which encodes the frame using a low delay filter bank; a speech signal encoder which encodes the frame by calculating linear prediction coefficients of the frame; and a block switching unit configured to perform control to (i) allow a current frame to be encoded by the low delay transform encoder when the signal classifying unit determines that the current frame is an audio signal and (ii) allow the current frame to be encoded by the speech signal encoder when the signal classifying unit determines that the current frame is a speech signal, wherein when the current frame is an ith frame which is one frame subsequent to an i−1th frame determined as a speech signal by the signal classifying unit and which is determined as an audio signal by the signal classifying unit, the block switching unit is configured to (1) allow the speech signal encoder to encode the ith frame and a signal which is a sum of a signal obtained by applying a window on a signal corresponding to a first half of the i−1th frame and a signal obtained by applying a window and folding on a signal corresponding to a latter half of the i−1th frame, or (2) allow the speech signal encoder to encode the ith frame and a signal which is a sum of a signal obtained by applying a window on the signal corresponding to the latter half of the i−1th frame and a signal obtained by applying a window and folding on the signal corresponding to the first half of the i−1th frame.

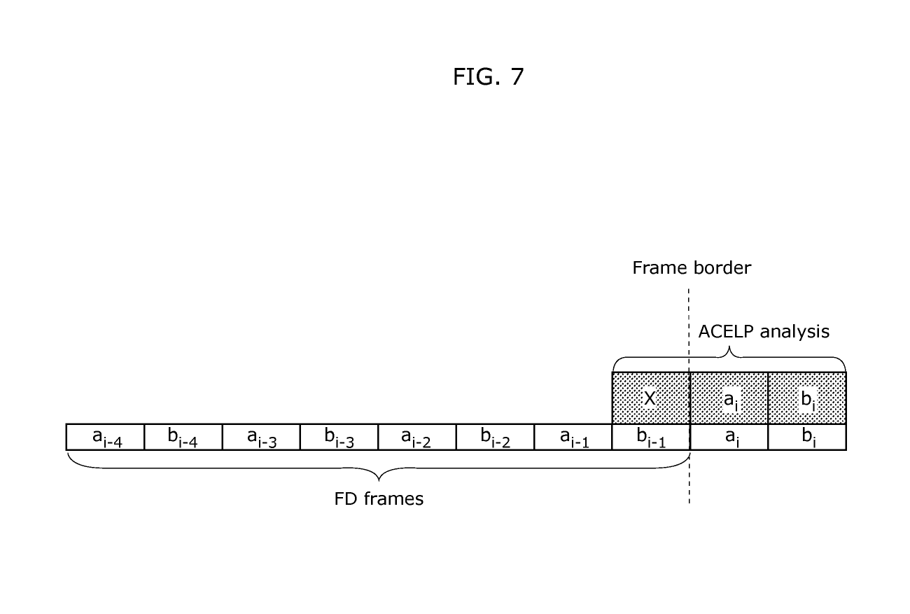

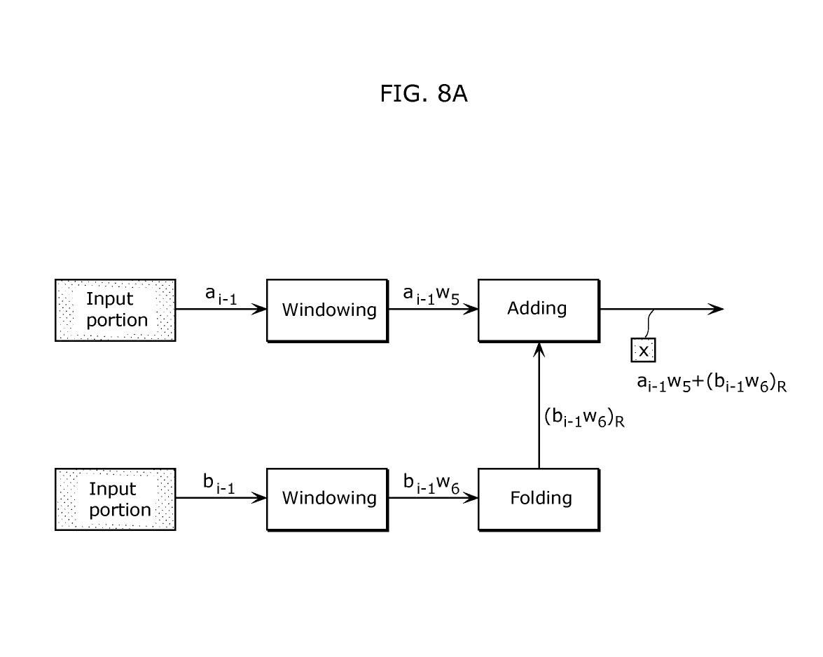

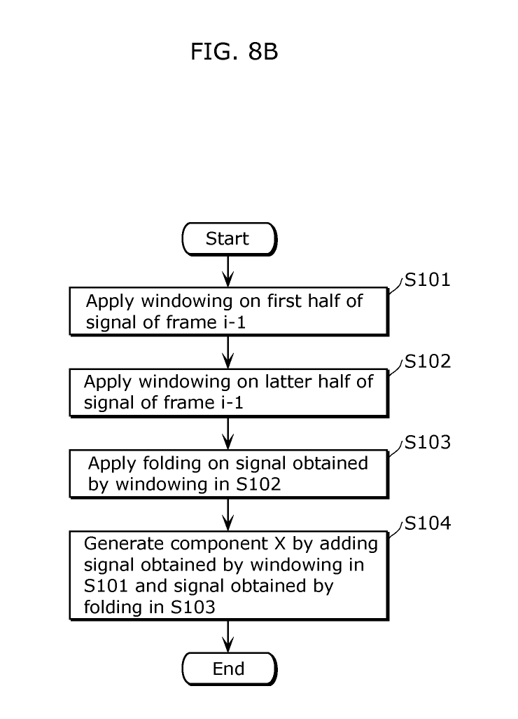

More specifically, the block switching unit performs the processing illustrated in FIG. 7 and FIG. 8A. This makes it possible to reduce the aliasing introduced when decoding the initial frame after the coding mode is switched from FD coding mode to LPD coding mode. As a result, the FD decoding technology and the LPD decoding technology can be switched seamlessly.

Furthermore, a hybrid sound signal encoder according to an aspect of the present invention may be a hybrid sound signal encoder including: a signal classifying unit configured to analyze audio characteristics of a sound signal to determine whether a frame included in the sound signal is an audio signal or a speech signal; a low delay transform encoder which encodes the frame using a low delay filter bank; a Transform Coded Excitation (TCX) encoder which encodes the frame in a TCX scheme by applying a Modified Discrete Cosine Transform (MDCT) on residuals of the linear prediction coefficients of the frame; and a block switching unit configured to perform control to (i) allow a current frame to be encoded by the low delay transform encoder when the signal classifying unit determines that the current frame is an audio signal and (ii) allow the current frame to be encoded by the TCX encoder when the signal classifying unit determines that the current frame is a speech signal, wherein when an ith frame which is the current frame is a frame determined by the signal classifying unit as an audio signal and as a transient signal an energy of which changes abruptly, the block switching unit is configured to (1) allow the TCX encoder to encode the ith frame and a signal which is a sum of a signal obtained by applying a window on a signal corresponding to a first half of an i−1th frame which is one frame previous to the ith frame and a signal obtained by applying a window and folding on a signal corresponding to a latter half of the i−1th frame, or (2) allow the TCX encoder to encode the ith frame and a signal which is a sum of a signal obtained by applying a window on the signal corresponding to the latter half of the i−1th frame and a signal obtained by applying a window and folding on the signal corresponding to the first half of the i−1th frame.

More specifically, the block switching unit performs the processing illustrated in FIG. 7 and FIG. 8A to encode a signal including a transient signal (transient frame) in FD coding mode. By doing so, the sound quality when decoding the transient frame can be increased.

Furthermore, according to an aspect of the present invention, the low delay transform encoder may be an Advanced Audio Coding—Enhanced Low Delay (AAC-ELD) encoder which encodes the frame by applying a window and a low delay filter bank process on an extended frame combining the frame and three temporally consecutive frames which are previous to the frame.

Furthermore, according to an aspect of the present invention, the speech signal encoder may be an Algebraic Code Excited Linear Prediction (ACELP) encoder which encodes the frame by generating ACELP coefficients.

Furthermore, according to an aspect of the present invention, the speech signal encoder may be a Transform Coded Excitation (TCX) encoder which encodes the frame by applying a Modified Discrete Cosine Transform (MDCT) on residuals of the linear prediction coefficients.

Furthermore, a hybrid sound signal encoder according to an aspect of the present invention may be a hybrid sound signal encoder further including: a local decoder which decodes the sound signal which has been encoded; and a local encoder which encodes synthesis error information which is a difference between the sound signal and the sound signal decoded by the local decoder.

It is to be noted that these general or specific aspects may be implemented using a system, a method, an integrated circuit, a computer program, or a computer-readable recording medium such as CD-ROM, or any combination of systems, methods, integrated circuits, computer programs, or recording media.

Hereinafter, embodiments are described with reference to the drawings.

Each of the following embodiments describes a hybrid sound signal encoder and a hybrid sound signal decoder which reduce the adverse effect of aliasing at transition between the following five coding modes and achieve seamless switching between the coding modes.
Transition from FD coding mode to ACELP coding mode (Embodiment 1)
Transition from ACELP coding mode to FD coding mode (Embodiment 2)
Transition from FD coding mode to TCX coding mode (Embodiment 3)
Transition from TCX coding mode to FD coding mode (Embodiment 4)
Transition from FD coding mode to transient signal coding mode (Embodiment 5)

It is to be noted that the following embodiments illustrate general or specific examples. The numerical values, shapes, materials, structural elements, the arrangement and connection of the structural elements, steps, the processing order of the steps etc., shown in the following embodiments are mere examples, and are therefore not intended to limit the present invention. Among the structural elements in the following embodiments, structural elements not recited in any one of the independent claims representing the most generic concepts are described as arbitrary structural elements.

### Embodiment 1

Embodiment 1 describes an encoding method performed by a hybrid sound signal encoder and a decoding method performed by a hybrid sound signal decoder when the coding mode is switched from FD coding mode to ACELP coding mode. In the following description of the embodiments, FD coding mode refers to AAC-ELD unless otherwise noted.

### [1-1. Encoding Method]

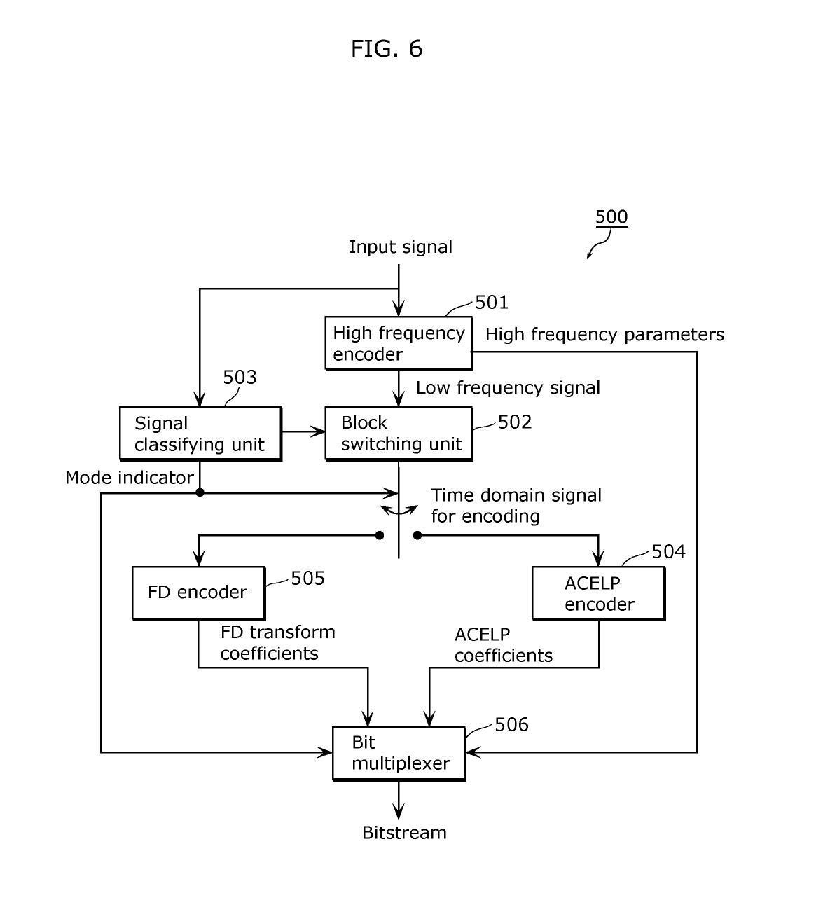

FIG. 6 is a block diagram illustrating a configuration of the hybrid sound signal encoder according to Embodiment 1.

A hybrid sound signal encoder 500 includes a high frequency encoder 501, a block switching unit 502, a signal classifying unit 503, an ACELP encoder 504, an FD encoder 505, and a bit multiplexer 506.

An input signal is sent to the high frequency encoder 501 and the signal classifying unit 503.

The high frequency encoder 501 generates (i) high frequency parameters which are signals obtained by extracting and encoding a signal in the high frequency band of the input signal and (ii) a low frequency signal which is a signal extracted from the low frequency band of the input signal. The high frequency parameters are sent to the bit multiplexer 506. The low frequency signal is sent to the block switching unit 502.

The signal classifying unit 503 analyzes the acoustic characteristics of the low frequency signal, and determines, for every number of samples N (for every frame) of the low frequency signal, whether the frame is an audio signal or a speech signal. More specifically, the signal classifying unit 503 calculates the spectral intensity of a band of the frame greater than or equal to 3 kHz and the spectral intensity of a band of the frame smaller than or equal to 3 kHz. When the spectral intensity of the band smaller than or equal to 3 kHz is greater than the spectral intensity of the remaining band, the signal classifying unit 503 determines that the frame is a signal consisting mainly of a speech signal, i.e., determines that the frame is a speech signal, and sends a mode indicator indicating the determination result to the block switching unit 502 and the bit multiplexer 506. Similarly, when the spectral intensity of the band smaller than or equal to 3 kHz is smaller than the spectral intensity of the remaining band, the signal classifying unit 503 determines that the frame is a signal consisting mainly of an audio signal, i.e., determines that the frame is an audio signal, and sends a mode indicator to the block switching unit 502 and the bit multiplexer 506.

The block switching unit 502 performs switching control to (i) allow a frame indicated by the mode indicator as an audio signal, to be encoded by the FD encoder 505 and (ii) allow a frame indicated by the mode indicator as a speech signal, to be encoded by the ACELP encoder 504. More specifically, the block switching unit 502 sends the low frequency signal received from the high frequency encoder to the FD encoder 505 and the ACELP encoder 504 according to the mode indicator on a frame-by-frame basis.

The FD encoder 505 encodes the frame in AAC-ELD coding mode based on the control by the block switching unit 502, and sends FD transform coefficients generated by the encoding to the bit multiplexer 506.

The ACELP encoder 504 encodes the frame in ACELP coding mode based on the control by the block switching unit 502, and sends ACELP coefficients generated by the encoding to the bit multiplexer 506.

The bit multiplexer 506 generates a bitstream by synthesizing the coding mode indicator, the high frequency parameters, the FD transform coefficients, and the ACELP coefficients.

Although not shown in the diagram, the hybrid sound signal encoder 500 may include a storage unit which temporarily stores a frame (signal).

Next, the following describes the control performed by the block switching unit 502 when the coding mode is switched from FD coding mode to ACELP coding mode.

FIG. 7 illustrates frames encoded when the coding mode is switched from FD coding mode to ACELP coding mode.

In this case, when the frame i is to be encoded, a signal added with a component X generated from a signal [aᵢ₋₁, bᵢ₋₁] of the previous frame i−1 is encoded. More specifically, the block switching unit 502 generates an extended frame by combining the component X and a signal [aᵢ, bᵢ] of the frame i. The extended frame is in a length of (N+N/2). The extended frame is sent to the ACELP encoder 504 by the block switching unit 502 and encoded in ACELP coding mode.

More specifically, the component X is generated in the manner described below.

FIG. 8A illustrates an example of a method of generating the component X. FIG. 8B is a flowchart of the method of generating the component X.

First, the window w₅ is applied on the input portion aᵢ₋₁, which is the first half of the signal of the frame i−1, to obtain a component aᵢ₋₁w₅ (S101 in FIG. 8B). Similarly, the window w₆ is applied on the input portion bᵢ₋₁, which is the latter half of the signal of the frame i−1, to obtain bᵢ₋₁w₆ (S102 in FIG. 8B). Next, folding is applied on bᵢ₋₁w₆ (S103 in FIG. 8B).

It is to be noted that in this Description, “apply folding on a signal” means rearranging, for each signal vector, the samples constituting the signal vector in the temporally reverse order.

By doing so, the reverse order of bᵢ₋₁w₆, denoted as (bᵢ₋₁w₆)_{R}, is obtained. Lastly, the component X is obtained by adding aᵢ₋₁w₅ and (bᵢ₋₁w₆)_{R} (S104 in FIG. 8B).

The obtained component X is used by the decoder for decoding, together with plural previous frames. This allows appropriate reconstruction of the signal [aᵢ₋₁, bᵢ₋₁] of the frame i−1.

Although folding is applied on bᵢ₋₁w₆ in the above description, folding may be applied on aᵢ₋₁w₅. That is to say, the component X may be (aᵢ₋₁w₅)_{R}+bᵢ₋₁w₆.

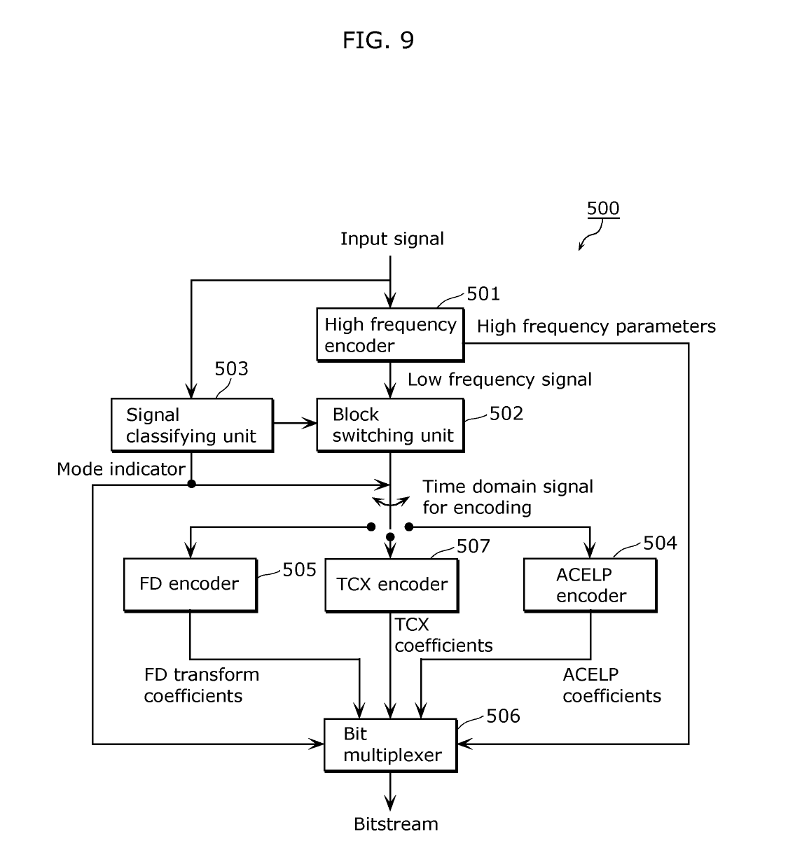

It is to be noted that the hybrid sound signal encoder 500 may further include a TCX encoder 507 as illustrated in FIG. 9.

The TCX encoder 507 encodes a frame in TCX coding mode based on the control by the block switching unit 502, and sends TCX coefficients generated by the encoding to the bit multiplexer 506.

### [1-2. Decoding Method]

The following describes a hybrid sound signal decoder which decodes a signal encoded by the hybrid sound signal encoder 500 as illustrated in FIG. 8A.

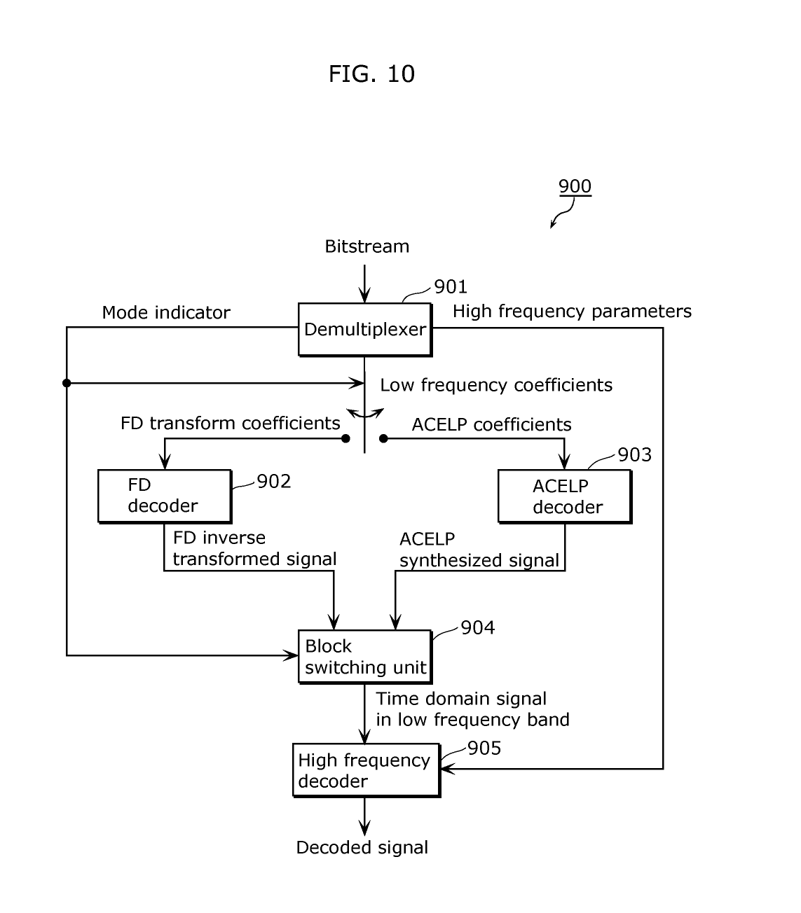

FIG. 10 is a block diagram illustrating a configuration of the hybrid sound signal decoder according to Embodiment 1.

The hybrid sound signal decoder 900 includes a demultiplexer 901, an FD decoder 902, an ACELP decoder 903, a block switching unit 904, and a high frequency decoder 905.

The demultiplexer 901 demultiplexes a bitstream. More specifically, the demultiplexer 901 separates the bitstream into a mode indicator, high frequency parameters, and an encoded signal. The mode indicator is sent to the block switching unit 904, the high frequency parameters are sent to the high frequency decoder 905, and the encoded signal (FD transform coefficients and ACELP coefficients) is sent to the corresponding FD decoder 902 and ACELP decoder 903 on a frame-by-frame basis.

The FD decoder 902 generates an FD inverse transformed signal from the FD transform coefficients through the AAC-ELD decoding process described using FIG. 2. In other words, the FD decoder 902 decodes the frame encoded in FD coding mode.

The ACELP decoder 903 generates an ACELP synthesized signal from the ACELP coefficients through the ACELP decoding process. In other words, the ACELP decoder 903 decodes the frame encoded in ACELP coding mode.

The FD inverse transformed signal and the ACELP synthesized signal are sent to the block switching unit 904.

The block switching unit 904 receives the FD inverse transformed signal obtained by the decoding, by the FD decoder 902, of the frame indicated by the mode indicator as an audio signal. The block switching unit 904 also receives the ACELP synthesized signal obtained by the decoding, by the ACELP decoder 903, of the frame indicated by the mode indicator as a speech signal.

The high frequency decoder 905 reconstructs the input signal using the high frequency parameters sent from the demultiplexer and a time domain signal in the low frequency band sent from the block switching unit 904.

Although not shown in the diagram, the hybrid sound signal decoder 900 may include a storage unit which temporarily stores a frame (signal).

Next, the following describes the switching control (decoding method) performed by the block switching unit 904 when the signal to be decoded is switched from the signal encoded in FD coding mode to the signal encoded in ACELP coding mode.

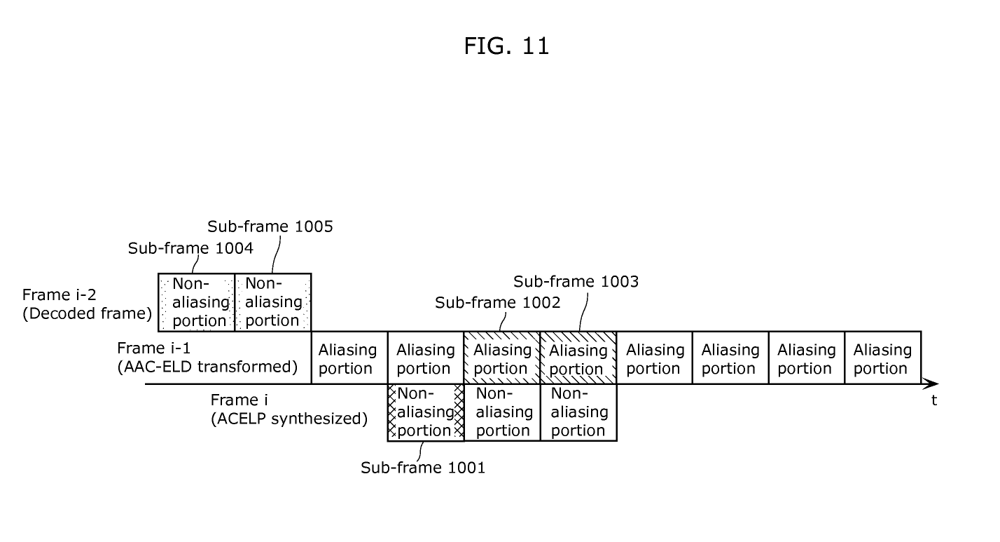

FIG. 11 schematically illustrates the switching control (decoding method) performed by the block switching unit 904 when the signal to be decoded is switched from the signal encoded in FD coding mode to the signal encoded in ACELP coding mode. As illustrated in FIG. 11, the frame i−1 is a frame encoded in FD coding mode, and the frame i, which is the current frame to be decoded, is a frame encoded in ACELP coding mode.

As described above, the signal of the frame i−1 can be reconstructed by decoding the current frame i in the case where signals encoded in FD coding mode are consecutively included. In other words, in the case of FIG. 11, signals up to the signal of the frame i−2 can be reconstructed through the ordinary FD decoding process. However, because the current frame i is encoded in ACELP coding mode, reconstructing the signal of the frame i−1 using the ordinary method causes an unnatural sound due to aliasing components. That is to say, the signal of the frame i−1 becomes aliasing portions as illustrated in FIG. 11.

To reduce the aliasing components, the block switching unit 904 performs the decoding process using three signals described below.

Firstly, a signal (first signal) of the component X of the ACELP synthesized signal obtained by decoding the current frame i through the ACELP decoding process is used for reconstructing the signal of the frame i−1 having reduced aliasing components. This signal is denoted as a sub-frame 1001 in FIG. 11, and is the component X described using FIG. 8A.

The current frame i is a frame encoded in ACELP coding mode and is in a length of 3N/2. Thus, the ACELP synthesized signal obtained by decoding the frame i through the ACELP decoding process is denoted as y_{i,n}^{acelp}, where

$$0 \leq n < \frac{3}{2} N \qquad [ Math . 18 ]$$

Therefore, the extended portion corresponding to the component X is as follows:

$${X}_{i , n} = {y}_{i , n}^{acelp} , 0 \leq n < \frac{N}{2} \qquad [ Math . 19 ]$$

As described using FIG. 8A, the component X is specifically aᵢ₋₁w₅+(bᵢ₋₁w₆)_{R}.

Secondly, to reconstruct the signal of the frame i−1 having reduced aliasing components, a signal (third signal) is used which corresponds to a frame i−3 among frames represented by a signal obtained by applying inverse transform on the current frame i−1 using the AAC-ELD low delay filter bank and then applying a window on the inverse transformed current frame i−1. This signal is denoted as a sub-frame 1002 and a sub-frame 1003.

More specifically, this signal is obtained by applying, using the AAC-ELD low delay filter bank, inverse transform on the frame i−1 with a length of 4N as an ordinary frame, and then applying a window on the inverse transformed frame i−1. The inverse transformed signal is expressed as follows:

y̅ᵢ₋₁=[c₋₄,d₋₄,c₋₃,d₋₃,c₋₂,d₋₂,c₋₁,d₋₁]ᵢ₋₁ [Math. 20]

The signal (two aliasing portions denoted as the sub-frame 1002 and the sub-frame 1003 in FIG. 11) corresponding to the frame i−3 is extracted from the inverse transformed signal as shown below. In detail,

[c₋₃]ᵢ₋₁=−aᵢ₋₃w₃w_{R,6}+(bᵢ₋₃w₄)_{R}w_{R,6}+aᵢ₋₁w₇w_{R,6}−(bᵢ₋₁w₈)_{R}w_{R,6}

and

[d₋₃]ᵢ₋₁=(aᵢ₋₃w₃)_{R}w_{R,5}−bᵢ₋₃w₄w_{R,5}−(aᵢ₋₁w₇)_{R}w_{R,5}+bᵢ₋₁w₈w_{R,5} [Math. 22]

are signals corresponding to the sub-frame 1002 and the sub-frame 1003, respectively.

Thirdly, a signal (second signal) [aᵢ₋₃, bᵢ₋₃] of the frame i−3 obtained by decoding the current frame i−2 through the FD decoding process is used for reconstructing the signal of the frame i−1 having reduced aliasing components. The signal of the frame i−3 is denoted as a sub-frame 1004 and a sub-frame 1005 in FIG. 11.

As described thus far, the signal of the frame i−1 having reduced aliasing components is reconstructed using: the signal aᵢ₋₁w₅+(bᵢ₋₁w₆)_{R} denoted as the sub-frame 1001; the signal [c₋₃]ᵢ₋₁ denoted as the sub-frame 1002; the signal [d₋₃]ᵢ₋₁ denoted as the sub-frame 1003; and the signal [aᵢ₋₃, bᵢ₋₃] denoted as the sub-frames 1004 and 1005, as illustrated in FIG. 11.

The following specifically describes a method of reconstructing, using the above signals, the signal of the frame i−1 having reduced aliasing components.

(a) of FIG. 12A illustrates a method of reconstructing aᵢ₋₁ which is the samples in the first half of the signal of the frame i−1. FIG. 12B is a flowchart of the method of reconstructing aᵢ₋₁ which is the samples in the first half of the signal of the frame i−1.

First, the window w₃ is applied on aᵢ₋₃ which is the sub-frame 1004 (the first half of the frame represented by the second signal) to obtain aᵢ₋₃w₃ (S201 in FIG. 12B). Next, the window w₄ is applied on bᵢ₋₃ which is the sub-frame 1005 (the latter half of the frame represented by the second signal) to obtain bᵢ₋₃w₄. After that, folding is applied on bᵢ₋₃w₄ to obtain (bᵢ₋₃w₄)_{R}, which is the reverse order of bᵢ₋₃w₄ (S202 in FIG. 12B).

Next, windowing is applied on a signal obtained by adding aᵢ₋₃w₃ and (bᵢ₋₃w₄)_{R}, to obtain aᵢ₋₃w₃w_{R,6}−(bᵢ₋₃w₄)_{R}w_{R,6} (S203 in FIG. 12B).

The synthesis window w_{R,8} is applied on aᵢ₋₁w₅+(bᵢ₋₁w₆)_{R} which is the sub-frame 1001 (the component X, the first signal), to obtain aᵢ₋₁w₅w_{R,8}+(bᵢ₋₁w₆)_{R}w_{R,8} (S204 in FIG. 12B).

Furthermore, the sub-frame 1002 (the first half of the frame represented by the third signal) which is the inverse transformed signal is as follows:

−aᵢ₋₃w₃w_{R,6}+(bᵢ₋₃w₄)_{R}w_{R,6}+aᵢ₋₁w₇w_{R,6}−(bᵢ₋₁w₈)_{R}w_{R,6} [Math. 23]

These signals are added to obtain aᵢ₋₁(w₅w_{R,8}+w₇w_{R,6}) (S205 in FIG. 12B).

Considering the window properties discussed earlier, the following is true:

w₅w_{R,8}+w₇w_{R,6}≈1 [Math. 24]

Thus, a sub-frame 1101 is obtained which is the first half of the signal of the frame i−1 having reduced aliasing components.

Similarly, (b) of FIG. 12A illustrates a method of reconstructing bᵢ₋₁ which is the samples in the latter half of the signal of the frame i−1. The process in (b) of FIG. 12A is the same as that in (a) of FIG. 12A except that folding is applied on the sub-frame 1001 in (b) of FIG. 12A. This allows a sub-frame 1102 to be obtained which is the latter half of the signal of the frame i−1 having reduced aliasing components.

Decoding the current frame i generates a signal [aᵢ₋₁, bᵢ₋₁] of the frame i−1 which is combination of the sub-frames 1101 and 1102.

It is to be noted that in the above description, windowing is applied on the sub-frame 1001 in (a) of FIG. 12A, whereas folding and windowing are applied on the sub-frame 1001 in (b) of FIG. 12A. These are the processes performed when the component X is expressed as aᵢ₋₁w₅+(bᵢ₋₁w₆)_{R} as above. When the component X is (aᵢ₋₁w₅)_{R}+bᵢ₋₁w₆, folding and windowing are applied on the sub-frame 1001 in (a) of FIG. 12A, whereas windowing is applied on the sub-frame 1001 in (b) of FIG. 12A.

### [1-3. Amount of Delay]

Next, the following describes the amount of delay in the encoding and decoding processes according to Embodiment 1 described above.

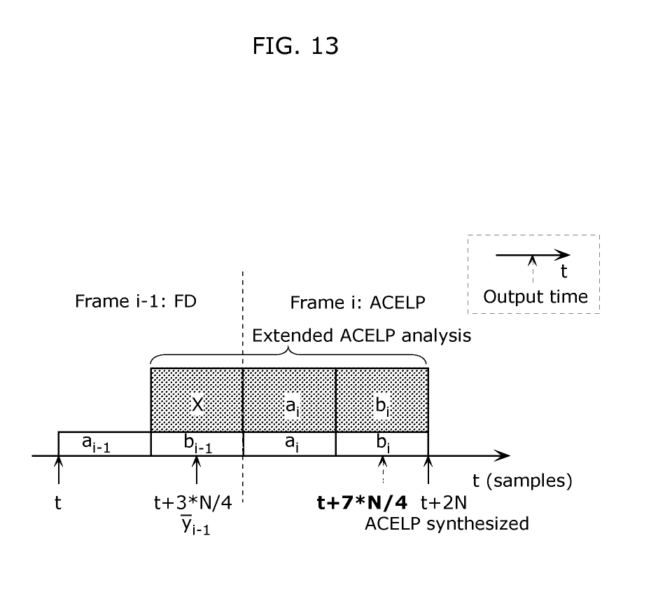

FIG. 13 illustrates the amount of delay in the encoding and decoding processes according to Embodiment 1. In FIG. 13, it is assumed that the encoding process on the frame i−1 starts at a time t.

As discussed earlier, due to the window features of the low delay filter bank in AAC-ELD, the IMDCT transformed output

y̅ᵢ₋₁ [Math. 25]

of the frame i−1 is obtained at the time t+3*N/4 samples. Thus, the sub-frames 1002 and 1003 are obtained at the time t+3*N/4 samples.

The sub-frames 1004 and 1005 are already obtained because they are signals reconstructed by decoding previous frames.

At the time t+2N samples, the ACELP synthesized signal of the frame i is obtained. Thus, the sub-frame 1001 (component X) is obtained at the time t+2N samples. However, because the synthesis window w_{R,8} which is zero for the first N/4 samples is applied to the sub-frame 1001, the sound output can start N/4 samples before the sub-frame 1001 is completely obtained.

Thus, the amount of delay when the signal [aᵢ₋₁, bᵢ₋₁] is reconstructed and output using the sub-frames 1001 to 1005 as described above is 2N−N/4=7*N/4 samples.

### [1-4. Conclusion]

As described above, the hybrid sound signal encoder 500 and the hybrid sound signal decoder 900 can reduce the aliasing introduced when decoding a transition frame which is the initial frame after the coding mode is switched from FD coding mode to ACELP coding mode, and realize seamless switching between the FD decoding technology and the ACELP decoding technology.

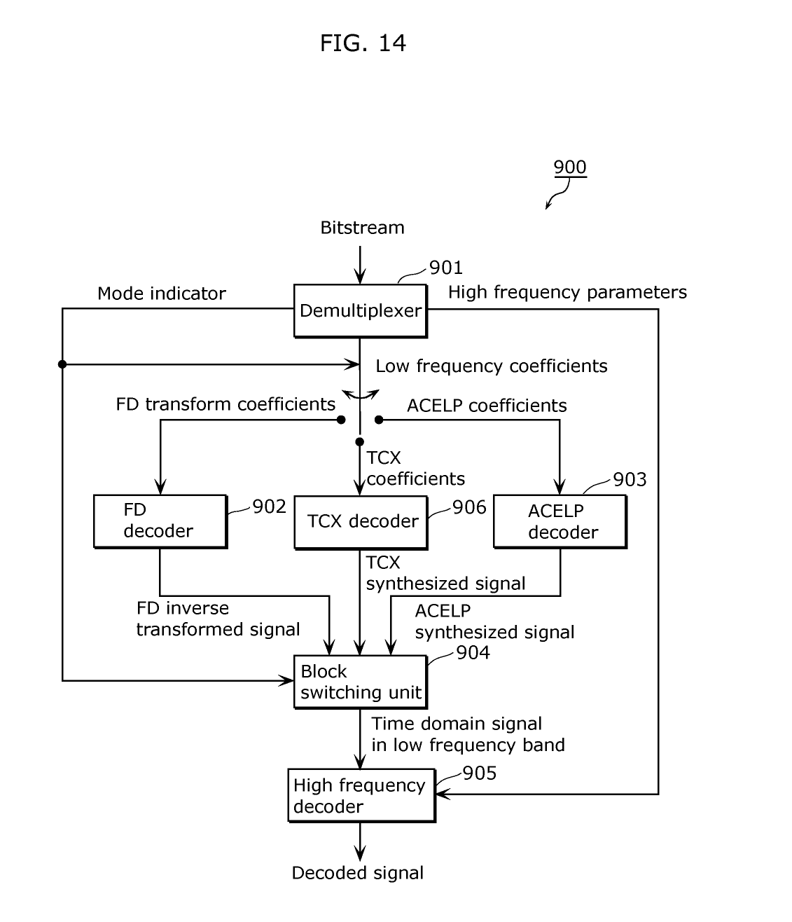

It is to be noted that the hybrid sound signal decoder 900 may further include a TCX decoder 906 as illustrated in FIG. 14.

The TCX decoder 906 illustrated in FIG. 14 generates a TCX synthesized signal from TCX coefficients through the TCX decoding process. In other words, the TCX decoder 906 decodes a frame encoded in TCX coding mode.

To achieve even higher sound quality, the hybrid sound signal decoder 900 may further include a synthesis error compensation (SEC) device.

The SEC process is performed at the time when the current frame i is decoded to generate a final synthesis signal. The purpose of adding the SEC device is to reduce (cancel) synthesis errors introduced by the switching of coding modes in the hybrid sound signal decoder 900, to improve the sound quality.

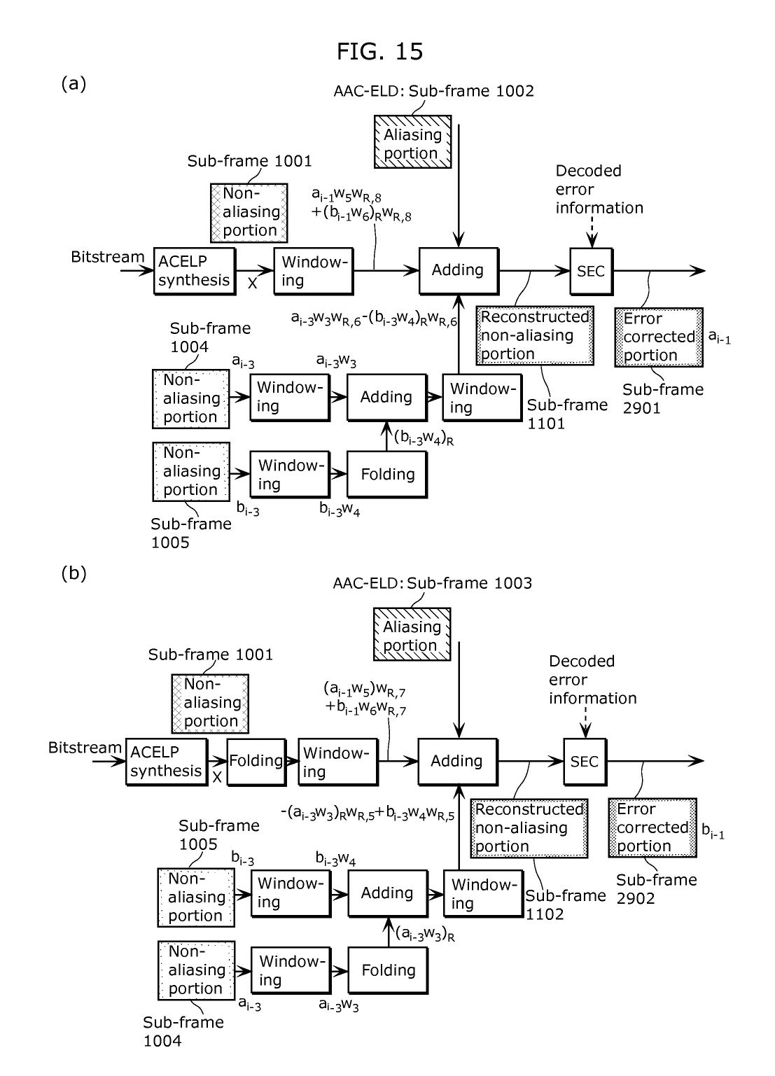

FIG. 15 illustrates a method of reconstructing the signal of the frame i−1 using the synthesis error compensation device. The SEC process is performed on the reconstructed signal [aᵢ₋₁, bᵢ₋₁] to efficiently compensate the time-domain aliasing effects.

The SEC device decodes synthesis error information which is included in the current frame and has been calculated through a transform using a method such as DCT-IV or AVQ at the time of encoding. The decoded synthesis error information is added to the reconstructed signal [aᵢ₋₁, bᵢ₋₁] through the SEC process, so that the reconstructed signal is corrected. More specifically, the sub-frame 1101 is corrected to a sub-frame 2901 as illustrated in (a) of FIG. 15, and the sub-frame 1102 is corrected to a sub-frame 2902 as illustrated in (b) of FIG. 15.

For the SEC process to be performed by the hybrid sound signal decoder 900, the synthesis error information needs to have been encoded by the hybrid sound signal encoder 500.

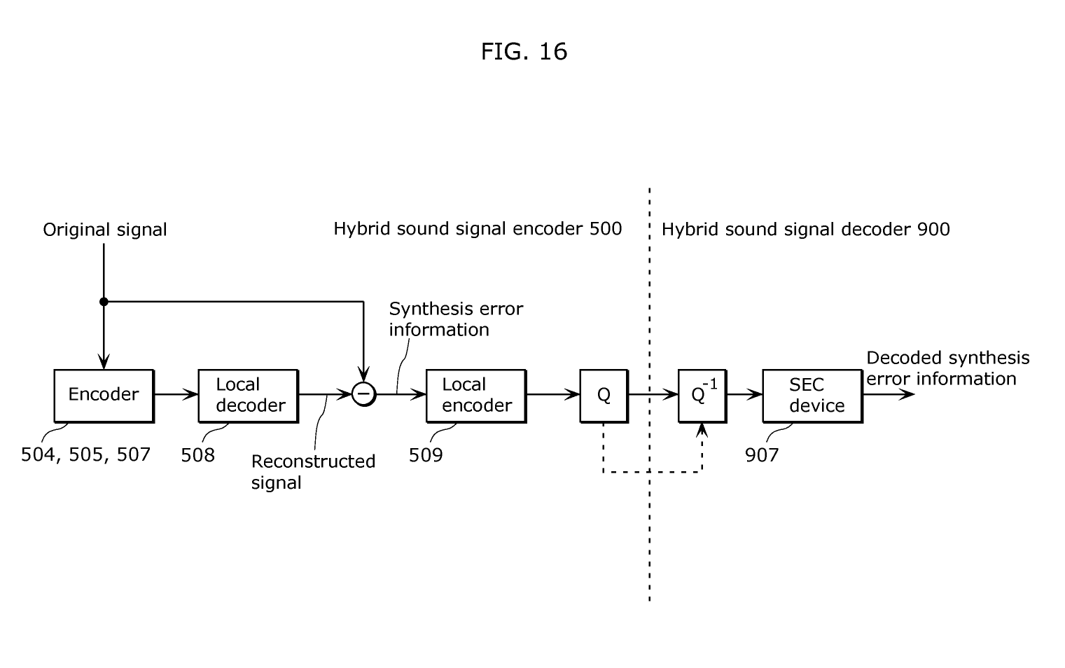

FIG. 16 illustrates a method of encoding and decoding the synthesis error information.

As illustrated in FIG. 16, when the synthesis error information is to be encoded, the hybrid sound signal encoder 500 includes a local decoder 508 and a local encoder.

The local decoder 508 decodes an original signal (signal before being encoded) encoded by the encoder (the ACELP encoder 504, the FD encoder 505, or the TCX encoder 507). The difference between the reconstructed signal (decoded original signal) and the original signal is the synthesis error information.

The local encoder 509 encodes (transforms) the synthesis error information using DCT-IV, Adaptive Vector Quantization (AVQ), or the like. The encoded synthesis error information is decoded (inverse transformed) by an SEC device 907 included in the hybrid sound signal decoder 900, and is used for correction of the reconstructed signal through the SEC process as described using FIG. 15.

### Embodiment 2

Embodiment 2 describes an encoding method performed by the hybrid sound signal encoder 500 and a decoding method performed by the hybrid sound signal decoder 900 when the coding mode is switched from ACELP coding mode to FD coding mode. It is to be noted that the configurations of the hybrid sound signal encoder 500 and the hybrid sound signal decoder 900 are the same as those in Embodiment 1.

### [2-1. Encoding Method]

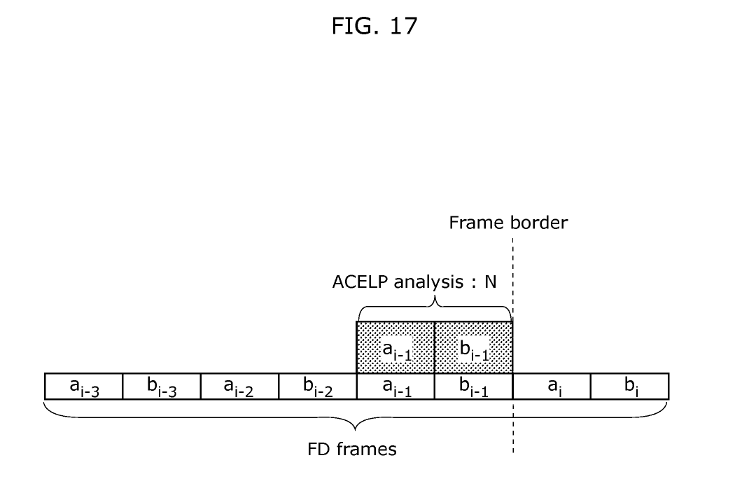

FIG. 17 illustrates frames encoded when the coding mode is switched from ACELP coding mode to FD coding mode.

The frame i−1 is encoded in ACELP coding mode. The frame i is concatenated with the three previous frames i−3, i−2, and i−1 to be encoded in FD coding mode.

### [2-2. Decoding Method]

The following describes a decoding method performed by the hybrid sound signal decoder 900 to decode a signal encoded by the hybrid sound signal encoder 500 as illustrated in FIG. 17.

Normally, when the current frame i is to be decoded, the overlapping and adding process is performed using the three previous frames i−3, i−2, and i−1 as described above to obtain the signal of the frame i−1.

However, the overlapping and adding process is a process performed based on the premise that consecutive frames are all encoded in FD coding mode. Here, when the frame i is a transition frame at which the coding mode is switched from ACELP coding mode to FD coding mode, it means that the three previous frames i−3, i−2, and i−1 have been encoded in ACELP coding mode. Thus, aliasing is introduced if the current frame i is decoded by the normal FD decoding process. Similarly, aliasing is also introduced in frames i+1 and i+2 because three previous frames include one or more frames encoded in ACELP coding mode.

### [2-2-1. Method of Decoding Current Frame i]

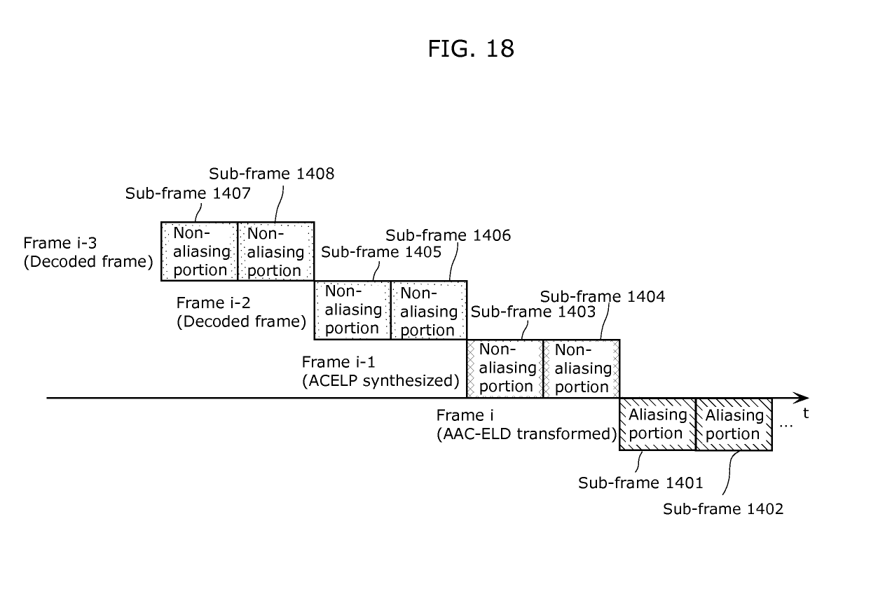

FIG. 18 schematically illustrates the switching control (decoding method) performed by the block switching unit 904 when the signal to be decoded is switched from the signal encoded in ACELP coding mode to the signal encoded in FD coding mode.

When the current frame i is to be decoded to reconstruct the signal [aᵢ₋₁, bᵢ₋₁] of the frame i−1, the block switching unit 904 performs the decoding process using three signals described below to reduce the aliasing components.

Firstly, a signal is used which corresponds to the frame i−3 among frames represented by a signal obtained by applying inverse transform on the current frame i using the AAC-ELD low delay filter bank and then applying a window on the inverse transformed current frame i. This signal is denoted as a sub-frame 1401 and a sub-frame 1402 in FIG. 18.

Secondly, the ACELP synthesized signal [aᵢ₋₁, bᵢ₋₁] obtained by decoding the current frame i−1 through the ACELP decoding process is used. This signal is denoted as a sub-frame 1403 and a sub-frame 1404 in FIG. 18.

Thirdly, the signal [aᵢ₋₃, bᵢ₋₃] of the frame i−3 obtained by decoding the current frame i−3 through the ACELP decoding process is used. The signal of the frame i−3 is denoted as a sub-frame 1407 and a sub-frame 1408 in FIG. 18.

Next, the decoding process using the above three signals is described in more detail.

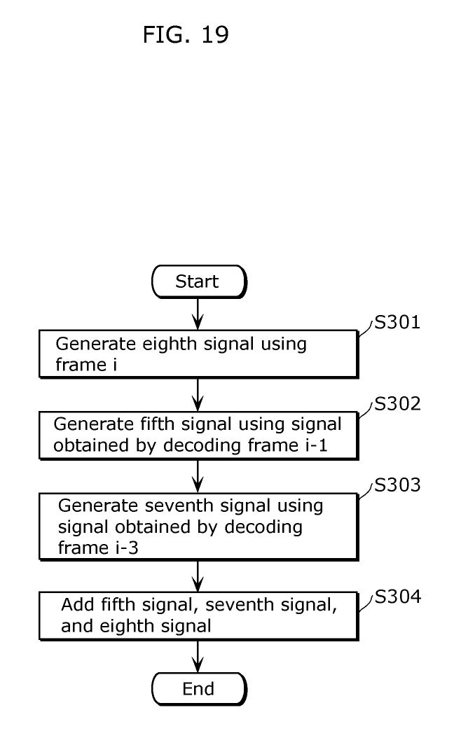

FIG. 19 is a flowchart of a method of reconstructing the signal [aᵢ₋₁, bᵢ₋₁] of the frame i−1.

A signal (eighth signal) is generated by applying inverse transform on the current frame i using the AAC-ELD low delay filter bank and then applying a window on the inverse transformed current frame i (S301 in FIG. 19). The eighth signal is given by the following equation:

$${\overline{y}}_{i} = [ \begin{matrix}( - {a}_{i - 3} {w}_{1} - {( {b}_{i - 3} {w}_{2} )}_{R} + {a}_{i - 1} {w}_{5} + {( {b}_{i - 1} {w}_{6} )}_{R} ) {w}_{R , 8} , \\ ( - {( {a}_{i - 3} {w}_{1} )}_{R} - {b}_{i - 3} {w}_{2} + {( {a}_{i - 1} {w}_{5} )}_{R} + {b}_{i - 1} {w}_{6} ) {w}_{R , 7} , \\ ( - {a}_{i - 2} {w}_{3} + {( {b}_{i - 2} {w}_{4} )}_{R} + {a}_{i} {w}_{7} - {( {b}_{i} {w}_{8} )}_{R} ) {w}_{R , 6} , \\ ( {( {a}_{i - 2} {w}_{3} )}_{R} - {b}_{i - 2} {w}_{4} - {( {a}_{i} {w}_{7} )}_{R} + {b}_{i} {w}_{8} ) {w}_{R , 5} , \\ ( {a}_{i - 3} {w}_{1} + {( {b}_{i - 3} {w}_{2} )}_{R} - {a}_{i - 1} {w}_{5} - {( {b}_{i - 1} {w}_{6} )}_{R} ) {w}_{R , 4} , \\ ( {( {a}_{i - 3} {w}_{1} )}_{R} + {b}_{i - 3} {w}_{2} - {( {a}_{i - 1} {w}_{5} )}_{R} - {b}_{i - 1} {w}_{6} ) {w}_{R , 3} , \\ ( {a}_{i - 2} {w}_{3} - {( {b}_{i - 2} {w}_{4} )}_{R} - {a}_{1} {w}_{7} + {( {b}_{1} {w}_{8} )}_{R} ) {w}_{R , 2} , \\ ( - {( {a}_{i - 2} {w}_{3} )}_{R} + {b}_{i - 2} {w}_{4} + {( {a}_{i} {w}_{7} )}_{R} - {b}_{i} {w}_{8} ) {w}_{R , 1}\end{matrix} ] \qquad [ Math . 26 ]$$

The signal (signal denoted as the sub-frames 1401 and 1402 in FIG. 18) corresponding to the frame i−3 among the frames represented by the above signal is given by the following equations:

[c₋₄]ᵢ=(−aᵢ₋₃w₁−(bᵢ₋₃w₂)_{R}+aᵢ₋₁w₅+(bᵢ₋₁w₆)_{R})w_{R,8} [Math. 27]

[d₋₄]ᵢ]=(−(aᵢ₋₃w₁)_{R}−bᵢ₋₃w₂+(aᵢ₋₁w₅)_{R}+bᵢ₋₁w₆)w_{R,7} [Math. 28]

FIG. 20A illustrates an example of a method of reconstructing the signal [aᵢ₋₁, bᵢ₋₁] of the frame i−1. A signal obtained by adding up (i) a signal (fourth signal) obtained by applying a window on a signal obtained by decoding the frame i−1 through the ACELP decoding process and (ii) a signal obtained by applying folding on the fourth signal is expressed as follows:

[aᵢ₋₁w₇−(bᵢ₋₁w₈)_{R},−(aᵢ₋₁w₇)_{R}+bᵢ₋₁w₈] [Math. 29]

The window [w_{R,6}, w_{R,5}] is applied on

[aᵢ₋₁w₇−(bᵢ₋₁w₈)_{R},−(aᵢ₋₁w₇)_{R}+bᵢ₋₁w₈] [Math. 30]

By doing so, a signal

[aᵢ₋₁w₇w_{R,6}−(bᵢ₋₁w₈)_{R}w_{R,6},−(aᵢ₋₁w₇)_{R}w_{R,5}+bᵢ₋₁w₈w_{R,5}] [Math. 31]

(fifth signal) is generated (S302 in FIG. 19). The fifth signal is denoted as a sub-frame 1501 and a sub-frame 1502 in FIG. 20A.

FIG. 20B also illustrates an example of a method of reconstructing the signal [aᵢ₋₁, bᵢ₋₁] of the frame i−1. A signal obtained by adding up (i) a sixth signal obtained by applying a window on a signal obtained by decoding the frame i−3 through the ACELP decoding process and (ii) a signal obtained by applying folding on the sixth signal is expressed as follows:

[aᵢ₋₃w₁+(bᵢ₋₃w₂)_{R},(aᵢ₋₃w₁)_{R}+bᵢ₋₃w₂] [Math. 32]

The window [w_{R,8}, w_{R,7}] is applied on this signal. By doing so,

[aᵢ₋₃w₁w_{R,8}+(bᵢ₋₃w₂)_{R}w_{R,8},(aᵢ₋₃w₁)_{R}w_{R,7}+bᵢ₋₃w₂w_{R,7}] [Math. 33]

(seventh signal) is obtained (S303 in FIG. 19).

As illustrated in FIG. 20B, the reconstructed signal [aᵢ₋₁, bᵢ₋₁] of the frame i−1 is generated by adding the seventh signal, the fifth signal (the sub-frame 1501 and the sub-frame 1502), and the eighth signal (the sub-frame 1401 and the sub-frame 1402) which is the aliasing components extracted from the frame i (S304 in FIG. 19).

[2-2-2. Method of Decoding Current Frame i+1]

When the current frame i+1 is to be decoded to reconstruct the signal [aᵢ, bᵢ] of the frame i, the block switching unit 904 performs the decoding process using three signals described below to reduce the aliasing components.

Firstly, a signal (ninth signal) is used which corresponds to the frame i−2 among frames represented by a signal obtained by applying inverse transform on the current frame i+1 using the AAC-ELD low delay filter bank and then applying a window on the inverse transformed current frame i+1. The signal obtained by applying inverse transform on the current frame i+1 using the AAC-ELD low delay filter bank and then applying a window on the inverse transformed current frame i+1 is expressed as:

y̅ᵢ₊₁ [Math. 34]

y̅ᵢ₊₁ [Math. 35]

The portion (aliasing portion) which is extracted from the above signal and corresponds to the frame i−2 is as follows:

[c₋₄,d₋₄]ᵢ₊₁=[(−aᵢ₋₂w₁−(bᵢ₋₂w₂)_{R}+aᵢw₅+(bᵢw₆)_{R})w_{R,8},(−(aᵢ₋₂w₁)_{R}−bᵢ₋₂w₂+(aᵢw₅)_{R}+bᵢw₆)w_{R,7}] [Math. 36]

Secondly, a signal (tenth signal) is used which corresponds to the frame i−2 among frames represented by a signal obtained by applying inverse transform on the current frame i using the AAC-ELD low delay filter bank and then applying a window on the inverse transformed current frame i. The signal obtained by applying inverse transform on the current frame i using the AAC-ELD low delay filter bank and then applying a window on the inverse transformed current frame i is expressed as:

y̅ᵢ [Math. 37]

The portion which is extracted from this equation and corresponds to the frame i−2 is as follows:

[c₋₃,d₋₃]ᵢ=[(−aᵢ₋₂w₃+(bᵢ₋₂w₄)_{R}+aᵢw₇−(bᵢw₈)_{R})w_{R,6},((aᵢ₋₂w₃)_{R}−bᵢ₋₂w₄−(aᵢw₇)_{R}+bᵢw₈)w_{R,5}] [Math. 38]

Thirdly,

y̅ᵢ [Math. 39]

in addition to (i) the portion which is extracted from the above signal and corresponds to the frame i−2 and

y̅ᵢ₊₁ [Math. 40]

(ii) the portion which is extracted from the above signal and corresponds to the frame i−2, the signal [aᵢ₋₂, bᵢ₋₂] of the current frame i−2 obtained by decoding the frame i−2 through the ACELP decoding process is used. This signal is denoted as a sub-frame 1405 and a sub-frame 1406 in FIG. 18.

FIG. 21 illustrates an example of a method of reconstructing the signal of the frame i.

A signal corresponding to the first half of the frame represented by a signal obtained by applying the window [w₁, w₂] (first windowing) on a signal (eleventh signal) [aᵢ₋₂, bᵢ₋₂] of the frame i−2 is expressed as aᵢ₋₂W₁. A twelfth signal is generated by adding, to the above signal aᵢ₋₂W₁, a signal (bᵢ₋₂W₂)_{R} obtained by applying folding on a signal bᵢ₋₂W₂ which corresponds to the latter half of the frame represented by the signal obtained by applying the window on the signal of the frame i−2.

Furthermore, by combining (concatenating) the twelfth signal with a signal obtained by applying folding on the twelfth signal, a signal

[(aᵢ₋₂w₁+(bᵢ₋₂w₂)_{R},(aᵢ₋₂w₁)_{R}+bᵢ₋₂w₂] [Math. 41]

is obtained. Here, the window [w_{R,8}, w_{R,7}] is applied on

[(aᵢ₋₂w₁+(bᵢ₋₂w₂)_{R},(aᵢ₋₂w₁)_{R}+bᵢ₋₂w₂] [Math. 42]

By doing so, a thirteenth signal (aliasing components)

[(aᵢ₋₂w₁+(bᵢ₋₂w₂)_{R})w_{R,8},((aᵢ₋₂w₁)_{R}+bᵢ₋₂w₂)w_{R,7}] [Math. 43]

is obtained.

A signal corresponding to the first half of a frame represented by a signal obtained by applying the window [w₃, w₄] (second windowing) on the signal of the frame i−2 is expressed as aᵢ₋₂W₃. A fourteenth signal is generated by adding, to the above signal aᵢ₋₂W₃, a signal (bᵢ₋₂W₄)_{R} obtained by applying folding on a signal bᵢ₋₂W₄ which corresponds to the latter half of the frame represented by the signal obtained by applying the window on the signal of the frame i−2.

Furthermore, by combining (concatenating) the fourteenth signal with a signal obtained by (i) applying folding on the fourteenth signal and (ii) reversing the sign (multiplying by −1) of the folded fourteenth signal, the following signal is obtained.

[(aᵢ₋₂w₃−(bᵢ₋₂w₄)_{R},−(aᵢ₋₂w₃)_{R}+bᵢ₋₂w₄] [Math. 44]

Here, the window [w_{R,6}, w_{R,6}] is applied on

[(aᵢ₋₂w₃−(bᵢ₋₂w₄)_{R},−(aᵢ₋₂w₃)_{R}+bᵢ₋₂w₄] [Math. 45]

By doing so, a fifteenth signal (aliasing components)

[(aᵢ₋₂w₃−(bᵢ₋₂w₄)_{R})w_{R,6},(−(aᵢ₋₂w₃)_{R}+bᵢ₋₂w₄)w_{R,5}] [Math. 46]

is obtained.

Lastly, as illustrated in FIG. 21, to obtain a signal [aᵢ, bᵢ] of the frame i having reduced aliasing, the thirteenth signal and the fifteenth signal are added to the ninth signal and the tenth signal which are respectively extracted from

$$\begin{matrix} {\overline{y}}_{i + 1} & [ Math . 47 ] \\ {\overline{y}}_{i} & [ Math . 48 ] \\ [ \begin{matrix}( - {a}_{i - 2} {w}_{1} - {( {b}_{i - 2} {w}_{2} )}_{R} + {a}_{i} {w}_{5} + {( {b}_{i} {w}_{6} )}_{R} ) {w}_{R , 8} , \\ ( - {( {a}_{i - 2} {w}_{1} )}_{R} - {b}_{i - 2} {w}_{2} + {( {a}_{i} {w}_{5} )}_{R} + {b}_{i} {w}_{6} ) {w}_{R , 7}\end{matrix} ] + [ \begin{matrix}( - {a}_{i - 2} {w}_{3} + {( {b}_{i - 2} {w}_{4} )}_{R} + {a}_{i} {w}_{7} - {( {b}_{i} {w}_{8} )}_{R} ) {w}_{R , 6} , \\ ( {( {a}_{i - 2} {w}_{3} )}_{R} - {b}_{i - 2} {w}_{4} - {( {a}_{i} {w}_{7} )}_{R} + {b}_{i} {w}_{8} ) {w}_{R , 5}\end{matrix} ] + [ \begin{matrix}( {a}_{i - 2} {w}_{1} + {( {b}_{i - 2} {w}_{2} )}_{R} ) {w}_{R , 8} , \\ ( {( {a}_{i - 2} {w}_{1} )}_{R} + {b}_{i - 2} {w}_{2} ) {w}_{R , 7}\end{matrix} ] + [ \begin{matrix}( {a}_{i - 2} {w}_{3} - {( {b}_{i - 2} {w}_{4} )}_{R} ) {w}_{R , 6} , \\ ( - {( {a}_{i - 2} {w}_{3} )}_{R} + {b}_{i - 2} {w}_{4} ) {w}_{R , 5}\end{matrix} ] = [ {a}_{i} ( {w}_{5} {w}_{R , 8} + {w}_{7} {w}_{R , 6} ) , {b}_{i} ( {w}_{6} {w}_{R , 7} + {w}_{8} {w}_{R , 5} ) ] & [ Math . 49 ]\end{matrix}$$

Here, considering the window properties discussed above, the signal [aᵢ, bᵢ] (sub-frames 1701 and 1702) of the frame i is reconstructed from the current frame i+1.

[2-2-3. Method of Decoding Current Frame i+2]

When the current frame i+2 is to be decoded to reconstruct the signal [aᵢ₊₁, bᵢ₊₁] of the frame i+1, the block switching unit 904 performs the decoding process using five signals described below to reduce the aliasing components.

Firstly, a signal (sixteenth signal) is used which corresponds to the frame i−1 (aliasing portion) among frames represented by a signal obtained by applying inverse transform on the frame i+2 using the AAC-ELD low delay filter bank and then applying a window on the inverse transformed frame i+2. The signal obtained by applying the inverse transform on the frame i+2 using the AAC-ELD low delay filter bank and then applying the window on the inverse transformed frame i+2 is expressed as:

y̅ᵢ₊₂ [Math. 50]

y̅ᵢ₊₂ [Math. 51]

The portion (aliasing portion) which is extracted from the above signal and corresponds to the frame i−1 is as follows:

[c₋₄,d₋₄]ᵢ₊₂=[(−aᵢ₋₁w₁−(bᵢ₋₁w₂)_{R}+aᵢ₊₁w₅+(bᵢ₊₁w₆)_{R})w_{R,8},(−(aᵢ₋₁w₁)_{R}−bᵢ₋₁w₂+(aᵢ₊₁w₅)_{R}+bᵢ₊₁w₆)w_{R,7}] [Math. 52]

Secondly, a signal (eighteenth signal) is used which corresponds to the frame i−1 (aliasing portion) among frames represented by a signal obtained by applying inverse transform on the frame i using the AAC-ELD low delay filter bank and then applying a window on the inverse transformed frame i. The signal obtained by applying the inverse transform on the frame i using the AAC-ELD low delay filter bank and then applying the window on the inverse transformed frame i is expressed as:

y̅ᵢ [Math. 53]

Thirdly, a signal (seventeenth signal) is used which corresponds to the frame i−1 (aliasing portion) among frames represented by a signal obtained by applying inverse transform on the frame i+1 using the AAC-ELD low delay filter bank and then applying a window on the inverse transformed frame i+1. The signal obtained by applying the inverse transform on the frame i+1 using the AAC-ELD low delay filter bank and then applying the window on the inverse transformed frame i+1 is expressed as:

y̅ᵢ₊₁ [Math. 54]

The eighteenth signal is as follows:

[c₋₃,d₋₃]ᵢ₊₁=[(−aᵢ₋₁w₃+(bᵢ₋₁w₄)_{R}+aᵢ₊₁w₇−(bᵢ₊₁w₈)_{R})w_{R,6},((aᵢ₋₁w₃)_{R}−bᵢ₋₁w₄−(aᵢ₊₁w₇)_{R}+bᵢ₊₁w₈)w_{R,5}] [Math. 55]

The seventeenth signal is as follows:

[c₋₂,d₋₂]ᵢ=[(aᵢ₋₃w₁+(bᵢ₋₃w₂)_{R}+aᵢ₋₁w₅−(bᵢ₋₁w₆)_{R})w_{R,4},((aᵢ₋₃w₁)_{R}+bᵢ₋₃w₂−(aᵢ₋₁w₅)_{R}−bᵢ₋₁w₆)w_{R,3}] [Math. 56]

Fourthly, in addition to (i) the eighteenth signal extracted from the signal

y̅ᵢ [Math. 57]

(ii) the seventeenth signal extracted from the signal

y̅ᵢ₊₁ [Math. 58]

and (iii) the sixteenth signal extracted from the signal

y̅ᵢ₊₂ [Math. 59]

a signal (nineteenth signal) denoted as the sub-frame 1407 and the sub-frame 1408 in FIG. 18 is used. The sub-frame 1407 and the sub-frame 1408 are the signal [aᵢ₋₃, bᵢ₋₃] obtained by decoding the frame i−3 through the ACELP decoding process.

Fifthly, the reconstructed signal [aᵢ₋₁, bᵢ₋₁] of the frame i−1 denoted as a sub-frame 1601 and a sub-frame 1602 in FIG. 20B is used.

FIG. 22 illustrates an example of a method of reconstructing the signal of the frame i+1.

A signal corresponding to the first half of a frame represented by a signal obtained by applying the window [w₁, w₂] on the signal [aᵢ₋₃, bᵢ₋₃] (nineteenth signal) of the frame i−3 is expressed as aᵢ₋₃W₁. A twentieth signal is generated by adding, to the above signal aᵢ₋₃W₁, a signal (bᵢ₋₃W₂)_{R} obtained by applying folding on a signal bᵢ₋₃W₂ which corresponds to the latter half of the frame represented by the signal obtained by applying the window on the signal of the frame i−3.

Furthermore, by combining (concatenating) the twentieth signal with a signal obtained by applying folding on the twentieth signal, the signal

−[aᵢ₋₃w₁+(bᵢ₋₃w₂)_{R},(aᵢ₋₃w₁)_{R}+bᵢ₋₃w₂] [Math. 60]

is obtained. Here, the window [w_{R,4}, w_{R,3}] is applied on

−[aᵢ₋₃w₁+(bᵢ₋₃w₂)_{R},(aᵢ₋₃w₁)_{R}+bᵢ₋₃w₂] [Math. 61]

By doing so, a twenty-first signal (aliasing components)

−[(aᵢ₋₃w₁+(bᵢ₋₃w₂)_{R})w_{R,4},((aᵢ₋₃w₁)_{R}+bᵢ₋₃w₂)w_{R,3}] [Math. 62]

is obtained.

A signal corresponding to the first half of a frame represented by a signal obtained by applying the window [w₇, w₈] on the reconstructed signal [aᵢ₋₁, bᵢ₋₁] of the frame i−1 is expressed as aᵢ₋₁W₇. A twenty-second signal is generated by adding, to the above signal aᵢ₋₁W₇, a signal (bᵢ₋₁W₈)_{R} obtained by applying folding on a signal bᵢ₋₁W₈ which corresponds to the latter half of the frame represented by the signal obtained by applying the window on the signal of the frame i−1.

Furthermore, by combining (concatenating) the twenty-second signal with a signal obtained by (i) applying folding on the twenty-second signal and (ii) reversing the sign (multiplying by −1) of the folded twenty-second signal, a signal

[−aᵢ₋₁w₇+(bᵢ₋₁w₈)_{R},(aᵢ₋₁w₇)_{R}−bᵢ₋₁w₈] [Math. 63]

is obtained. Here, the window [w_{R,2}, w_{R,1}] is applied on

[−aᵢ₋₁w₇+(bᵢ₋₁w₈)_{R},(aᵢ₋₁w₇)_{R}−bᵢ₋₁w₈] [Math. 64]

By doing so, a twenty-third signal (aliasing components)

[(−aᵢ₋₁w₇+(bᵢ₋₁w₈)_{R})w_{R,2},((aᵢ₋₁w₇)_{R}−bᵢ₋₁w₈)w_{R,1}] [Math. 65]

is obtained.

Lastly, as illustrated in FIG. 22, to obtain the signal [aᵢ₊₁, bᵢ₊₁] of the frame i+1 having reduced aliasing, the sixteenth signal, the seventeenth signal, and the eighteenth signal which are extracted from

y̅ᵢ [Math. 66]

y̅ᵢ₊₁ [Math. 67]

and

y̅ᵢ₊₂ [Math. 68]

are added to the twenty-first signal and the twenty-third signal.

$$\begin{matrix} [ Math . 69 ] & \\ [ \begin{matrix}( - {a}_{i - 1} {w}_{1} - {( {b}_{i - 1} {w}_{2} )}_{R} + {a}_{i + 1} {w}_{5} + {( {b}_{i + 1} {w}_{6} )}_{R} ) {w}_{R , 8} , \\ ( - {( {a}_{i - 1} {w}_{1} )}_{R} - {b}_{i - 1} {w}_{2} + {( {a}_{i + 1} {w}_{5} )}_{R} + {b}_{i + 1} {w}_{6} ) {w}_{R , 7}\end{matrix} ] + [ \begin{matrix}( - {a}_{i - 1} {w}_{3} + {( {b}_{i - 1} {w}_{4} )}_{R} + {a}_{i + 1} {w}_{7} - {( {b}_{i + 1} {w}_{8} )}_{R} ) {w}_{R , 6} , \\ ( {( {a}_{i - 1} {w}_{3} )}_{R} - {b}_{i - 1} {w}_{4} - {( {a}_{i + 1} {w}_{7} )}_{R} + {b}_{i + 1} {w}_{8} ) {w}_{R , 5}\end{matrix} ] + [ \begin{matrix}( {a}_{i - 3} {w}_{1} + {( {b}_{i - 3} {w}_{2} )}_{R} - {a}_{i - 1} {w}_{5} - {( {b}_{i - 1} {w}_{6} )}_{R} ) {w}_{R , 4} , \\ ( {( {a}_{i - 3} {w}_{1} )}_{R} + {b}_{i - 3} {w}_{2} - {( {a}_{i - 1} {w}_{5} )}_{R} - {b}_{i - 1} {w}_{6} ) {w}_{R , 3}\end{matrix} ] - [ \begin{matrix}( {a}_{i - 3} {w}_{1} + {( {b}_{i - 3} {w}_{2} )}_{R} ) {w}_{R , 4} , \\ ( {( {a}_{i - 3} {w}_{1} )}_{R} + {b}_{i - 3} {w}_{2} ) {w}_{R , 3}\end{matrix} ] + [ \begin{matrix}( - {a}_{i - 1} {w}_{7} + {( {b}_{i - 1} {w}_{8} )}_{R} ) {w}_{R , 2} , \\ ( {( {a}_{i - 1} {w}_{7} )}_{R} - {b}_{i - 1} {w}_{8} ) {w}_{R , 1}\end{matrix} ] = [ \begin{matrix}- {a}_{i - 1} ( {w}_{1} {w}_{R , 8} + {w}_{3} {w}_{R , 6} + {w}_{5} {w}_{R , 4} + {w}_{7} {w}_{R , 2} ) + \\ {a}_{i + 1} ( {w}_{5} {w}_{R , 8} + {w}_{7} {w}_{R , 6} ) , \\ - {b}_{i - 1} ( {w}_{2} {w}_{R , 7} + {w}_{4} {w}_{R , 5} + {w}_{6} {w}_{R , 3} + {w}_{8} {w}_{R , 1} ) + \\ {b}_{i + 1} ( {w}_{6} {w}_{R , 7} + {w}_{8} {w}_{R , 5} )\end{matrix} ] & \end{matrix}$$

Here, considering the window properties discussed above, the signal [aᵢ₊₁, bᵢ₊₁] (sub-frames 1801 and 1802) of the frame i+1 is reconstructed from the current frame i+2.

### [2-3. Amount of Delay]

Next, the following describes the amount of delay in the encoding and decoding processes according to Embodiment 2 described above.

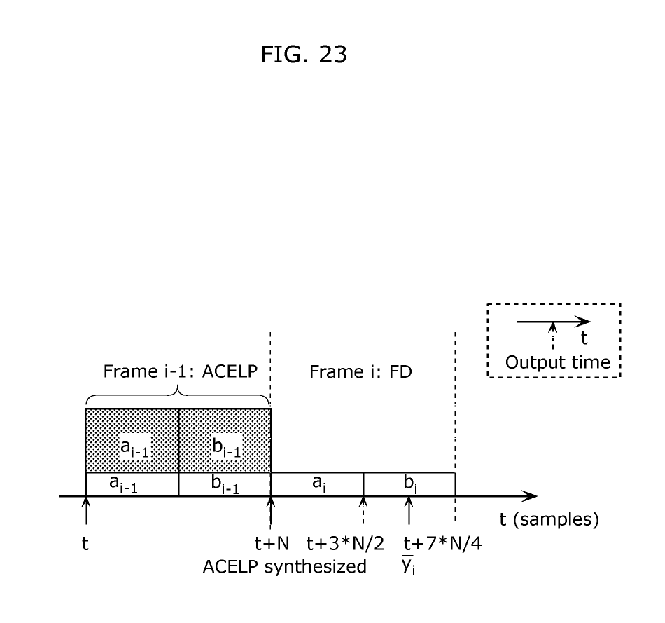

FIG. 23 illustrates the amount of delay in the encoding and decoding processes according to Embodiment 2. In FIG. 23, it is assumed that the encoding process on the frame i−1 starts at a time t.

The ACELP synthesized signal of the frame i−1 is obtained at the time t+N samples. Thus, the sub-frames 1501 and 1502 (sub-frames 1403 and 1404) are obtained at the time t+N samples.

The sub-frames 1407 and 1408 are already obtained because they are signals reconstructed by decoding previous frames.

As discussed earlier, due to the window features of the low delay filter bank in AAC-ELD, the IMDCT transformed output of the frame i is obtained at the time t+7*N/4 samples. Thus, the sub-frames 1401 and 1402 are obtained at the time t+7*N/4 samples. However, because the synthesis window w_{R,8} which is zero for the first N/4 samples is applied to the sub-frame 1401, the sound output can start N/4 samples before the sub-frame 1401 is completely obtained.

Thus, the output of the signal [aᵢ₋₁, bᵢ₋₁] reconstructed in the above manner starts at the time t+3*N/2 samples, and the amount of delay is (t+3*N/2)-t=3*N/2 samples.

### [2-4. Conclusion]

As described in Embodiment 2, the hybrid sound signal encoder 500 and the hybrid sound signal decoder 900 can reduce the aliasing introduced when decoding a transition frame which is the initial frame after the coding mode is switched from ACELP coding mode to FD coding mode, and realize seamless switching between the ACELP decoding process and the FD decoding process.

It is to be noted that, as in Embodiment 1, the hybrid sound signal decoder 900 according to Embodiment 2 may further include the TCX decoder 906 as illustrated in FIG. 14.

As in Embodiment 1, the hybrid sound signal decoder 900 according to Embodiment 2 may further include a synthesis error compensation (SEC) device to achieve even higher sound quality.

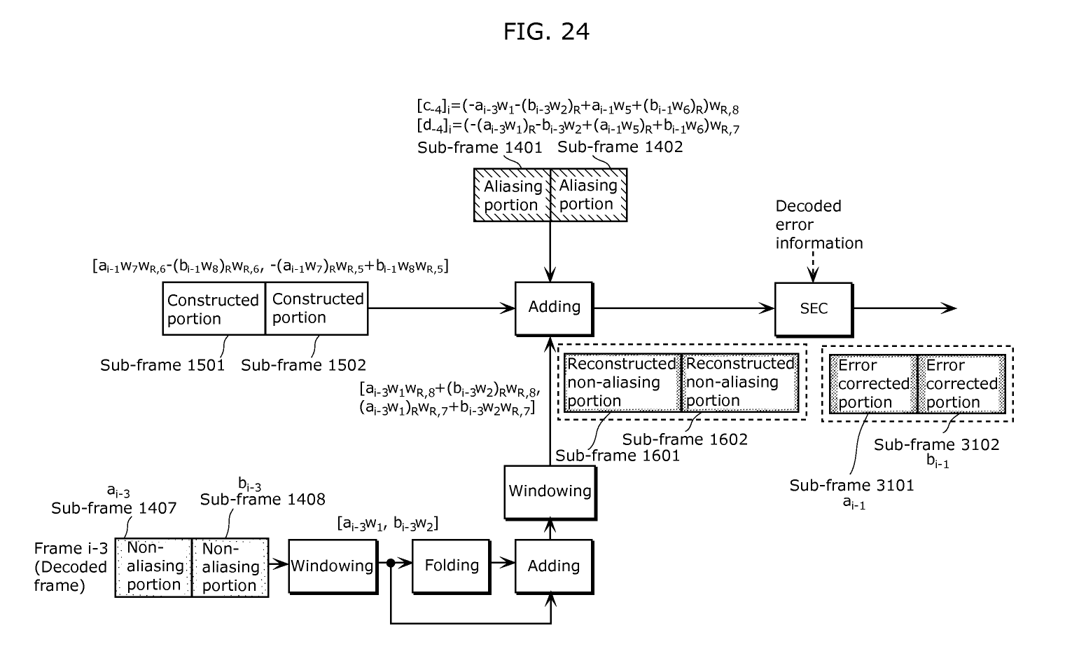

FIG. 24 illustrates a method of reconstructing the signal [aᵢ₋₁, bᵢ₋₁] of the frame i−1 using the SEC device. The configuration illustrated in FIG. 24 is the configuration illustrated in FIG. 20B with addition of the SEC device. As illustrated in FIG. 24, the sub-frames 1601 and 1602 are corrected to sub-frames 3101 and 3102, respectively, by the SEC process.

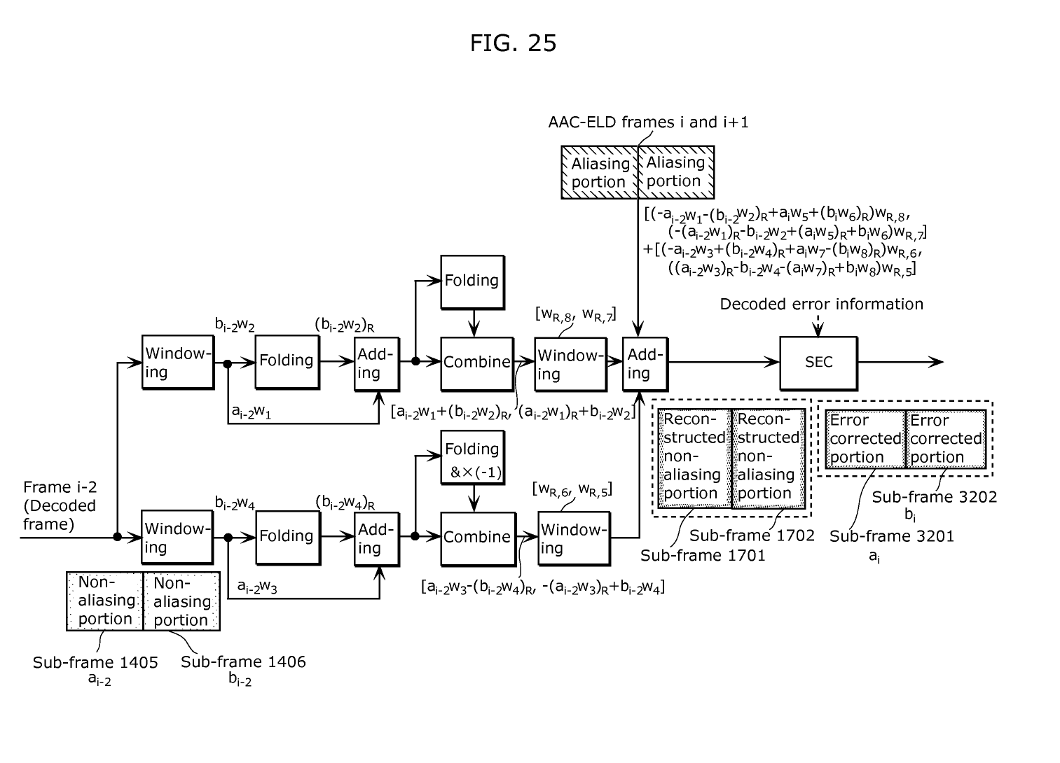

FIG. 25 illustrates a method of reconstructing the signal [aᵢ, bᵢ] of the frame i using the SEC device. The configuration illustrated in FIG. 25 is the configuration illustrated in FIG. 21 with addition of the SEC device. As illustrated in FIG. 25, the sub-frames 1701 and 1702 are corrected to sub-frames 3201 and 3202, respectively, by the SEC process.

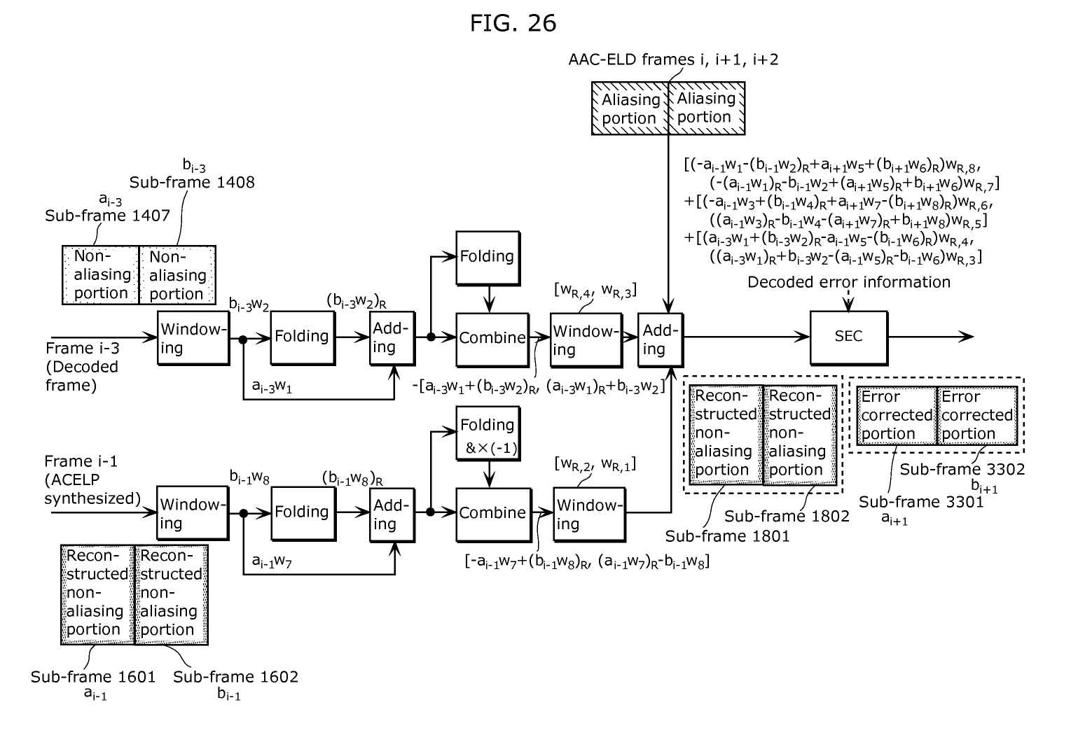

FIG. 26 illustrates a method of reconstructing the signal [a₁₊₁, bᵢ₊₁] of the frame i+1 using the SEC device. The configuration illustrated in FIG. 26 is the configuration illustrated in FIG. 22 with addition of the SEC device. As illustrated in FIG. 26, the sub-frames 1801 and 1802 are corrected to sub-frames 3301 and 3302, respectively, by the SEC process.

As described above, compensation of the synthesis error included in the reconstructed signal using the SEC device provided in the decoder further increases the sound quality.

### Embodiment 3

Embodiment 3 describes an encoding method performed by the hybrid sound signal encoder 500 and a decoding method performed by the hybrid sound signal decoder 900 when the coding mode is switched from FD coding mode to TCX coding mode.

The configuration of the hybrid sound signal encoder 500 is the same as the configuration illustrated in FIG. 9, but the ACELP encoder 504 in FIG. 9 is optional. Similarly, the configuration of the hybrid sound signal decoder 900 is the same as the configuration illustrated in FIG. 14, but the ACELP decoder 903 in FIG. 14 is optional.

### [3-1. Encoding Method]

First, the following describes the control performed by the block switching unit 502 when the coding mode is switched from FD coding mode to TCX coding mode.

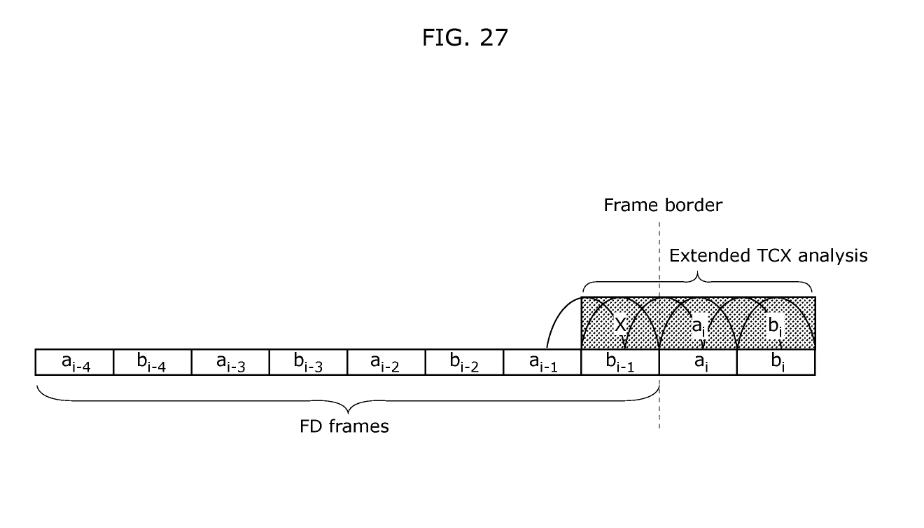

FIG. 27 illustrates frames encoded when the coding mode is switched from FD coding mode to TCX coding mode.

In this case, when the frame i is to be encoded, a signal added with the component X generated from the signal [aᵢ₋₁, bᵢ₋₁] of the previous frame i−1 is encoded. More specifically, the block switching unit 502 generates an extended frame by combining the component X and the signal [aᵢ, bᵢ] of the frame i. The extended frame is in a length of (N+N/2). The extended frame is sent to the TCX encoder 507 by the block switching unit 502 and encoded in TCX coding mode.

The component X is generated with the same method as that described using FIG. 8A and FIG. 8B.

### [3-2. Decoding Method]

Next, the following describes the switching control (decoding method) performed by the block switching unit 904 when the signal to be decoded is switched from the signal encoded in FD coding mode to the signal encoded in TCX coding mode.

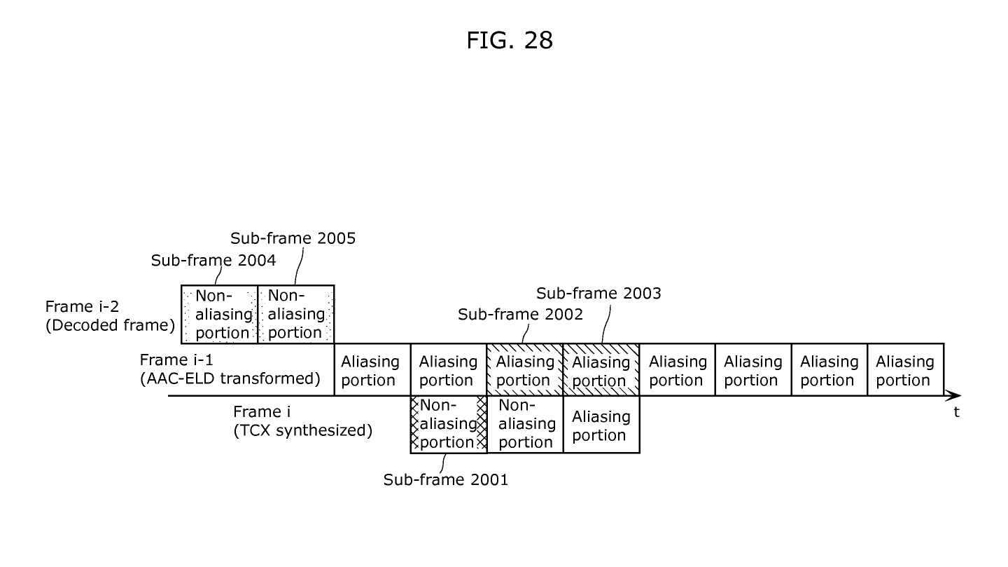

FIG. 28 schematically illustrates the switching control (decoding method) performed by the block switching unit 904 when the signal to be decoded is switched from the signal encoded in FD coding mode to the signal encoded in TCX coding mode. As illustrated in FIG. 28, the frame i−1 is a frame encoded in FD coding mode, and the frame i, which is the current frame to be decoded, is a frame encoded in TCX coding mode.

As described above, the signal of the frame i−1 can be reconstructed by decoding the current frame i in the case where signals encoded in FD coding mode are consecutively included. In other words, in the case of FIG. 11, signals up to the signal of the frame i−2 can be reconstructed through the ordinary FD decoding process. However, because the current frame i is encoded in TCX coding mode, reconstructing the signal of the frame i−1 using the ordinary method causes an unnatural sound due to aliasing components. That is to say, the signal of the frame i−1 becomes aliasing portions as illustrated in FIG. 11.

To reduce the aliasing components, the block switching unit 904 performs the decoding process using three signals described below.

Firstly, a signal of the component X of the TCX synthesized signal obtained by decoding the current frame i through the TCX decoding process is used for reconstructing the signal of the frame i−1 having reduced aliasing components. This signal is denoted as a sub-frame 2001 in FIG. 28, and is the component X described using FIG. 8A.

As described using FIG. 8A, the component X is specifically aᵢ₋₁w₅+(bᵢ₋₁w₆)_{R}.

Secondly, to reconstruct the signal of the frame i−1 having reduced aliasing components, a signal is used which corresponds to the frame i−3 among frames represented by a signal obtained by applying inverse transform on the frame i−1 using the AAC-ELD low delay filter bank and then applying a window on the inverse transformed frame i−1. This signal is denoted as a sub-frame 2002 and a sub-frame 2003 in FIG. 28.

More specifically, this signal is obtained by applying, using the AAC-ELD low delay filter bank, inverse transform on the frame i−1 with a length of 4N as an ordinary frame, and then applying a window on the inverse transformed frame i−1. The inverse transformed signal is expressed as follows:

y̅ᵢ₋₁ [Math. 70]

The signal (aliasing portions denoted as the sub-frame 2002 and the sub-frame 2003 in FIG. 28) corresponding to the frame i−3 is extracted from the above inverse transformed signal as shown below. In detail,

[c₋₃]ᵢ₋₁=−aᵢ₋₃w₃w_{R,6}+(bᵢ₋₃w₄)_{R}w_{R,6}+aᵢ₋₁w₇w_{R,6}−(bᵢ₋₁w₈)_{R}w_{R,6} [Math. 71]

and

[d₋₃]ᵢ₋₁=(aᵢ₋₃w₃)_{R}w_{R,5}−bᵢ₋₃w₄w_{R,5}−(aᵢ₋₁w₇)_{R}w_{R,5}+bᵢ₋₁w₈w_{R,5} [Math. 72]

are signals corresponding to the sub-frame 2002 and the sub-frame 2003, respectively.

Thirdly, the signal [aᵢ₋₃, bᵢ₋₃] of the frame i−3 obtained by decoding the frame i−2 through the FD decoding process is used for reconstructing the signal of the frame i−1 having reduced aliasing components. The signal of the frame i−3 is denoted as a sub-frame 2004 and a sub-frame 2005 in FIG. 28.

The method of reconstructing, using the above signals, the signal of the frame i−1 having reduced aliasing components is the same as the method described using FIG. 12A and FIG. 12B. More specifically, the sub-frames 1001, 1002, 1003, 1004, and 1005 in FIG. 12A are replaced with the sub-frames 2001, 2002, 2003, 2004, and 2005 in FIG. 28, respectively. With this method, the signal [aᵢ₋₁, bᵢ₋₁] of the frame i is reconstructed.

### [3-3. Amount of Delay]

Next, the following describes the amount of delay in the encoding and decoding processes according to Embodiment 3 described above.

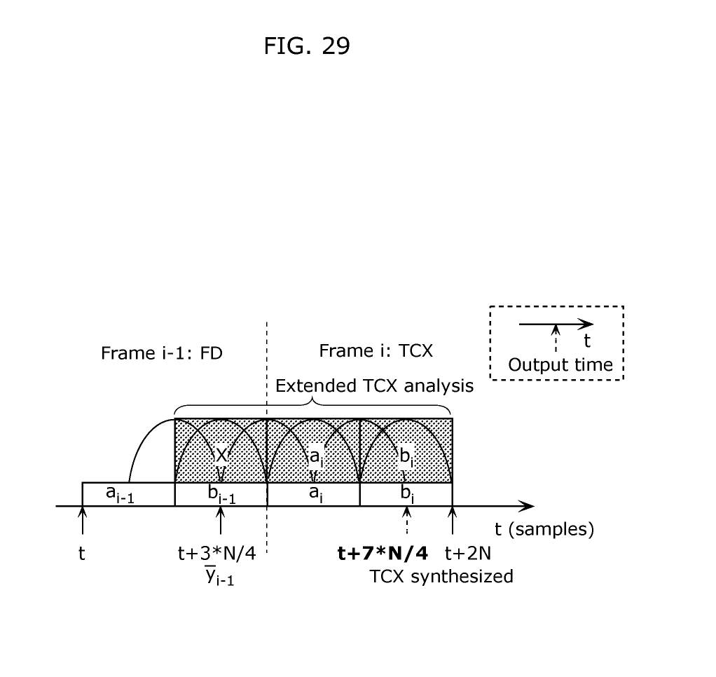

FIG. 29 illustrates the amount of delay in the encoding and decoding processes according to Embodiment 3. In FIG. 29, it is assumed that the encoding process on the frame i−1 starts at a time t.

As discussed earlier, due to the window features of the low delay filter bank in AAC-ELD, the IMDCT transformed output

y̅ᵢ₋₁ [Math. 73]

of the frame i−1 is obtained at the time t+3*N/4 samples. Thus, the sub-frames 2002 and 2003 are obtained at the time t+3*N/4 samples.

The sub-frames 2004 and 2005 are already obtained because they are signals reconstructed by decoding previous frames.

At the time t+2N samples, the TCX synthesized signal of the frame i is obtained. Thus, the sub-frame 2001 (component X) is obtained at the time t+2N samples. However, because the synthesis window w_{R,8} which is zero for the first N/4 samples is applied to the sub-frame 2001, the sound output can start N/4 samples before the sub-frame 2001 is completely obtained.

Thus, the amount of delay when the signal [aᵢ₋₁, bᵢ₋₁] is reconstructed and output using the sub-frames 2001 to 2005 as described above is 2N/4−N/4=7*N/4 samples.

### [3-4. Conclusion]

As described above, the hybrid sound signal encoder 500 and the hybrid sound signal decoder 900 can reduce the aliasing introduced when decoding a transition frame which is the initial frame after the coding mode is switched from FD coding mode to TCX coding mode, and realize seamless switching between the FD decoding technology and the TCX decoding technology.

To achieve even higher sound quality, the hybrid sound signal decoder 900 may further include a synthesis error compensation (SEC) device. The signal reconstructing method in this case is the same as that illustrated in FIG. 15.

### Embodiment 4

Embodiment 4 describes an encoding method performed by the hybrid sound signal encoder 500 and a decoding method performed by the hybrid sound signal decoder 900 when the coding mode is switched from TCX coding mode to FD coding mode.

The configuration of the hybrid sound signal encoder 500 is the same as the configuration illustrated in FIG. 9, but the ACELP encoder 504 in FIG. 9 is optional. Similarly, the configuration of the hybrid sound signal decoder 900 is the same as the configuration illustrated in FIG. 14, but the ACELP decoder 903 in FIG. 14 is optional.

### [4-1. Encoding Method]

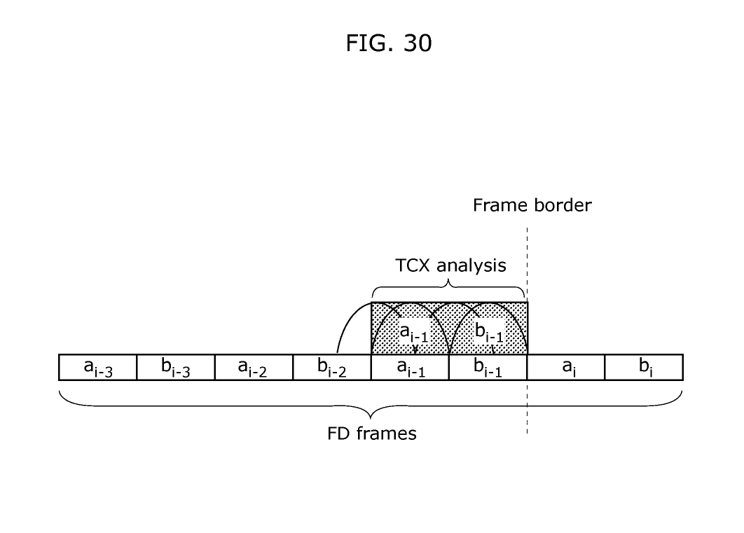

FIG. 30 illustrates frames encoded when the coding mode is switched from TCX coding mode to FD coding mode.

The frame i−1 is encoded in TCX coding mode. The frame i is concatenated with the three previous frames i−3, i−2, and i−1 to be encoded in FD coding mode.

### [4-2. Decoding Method]

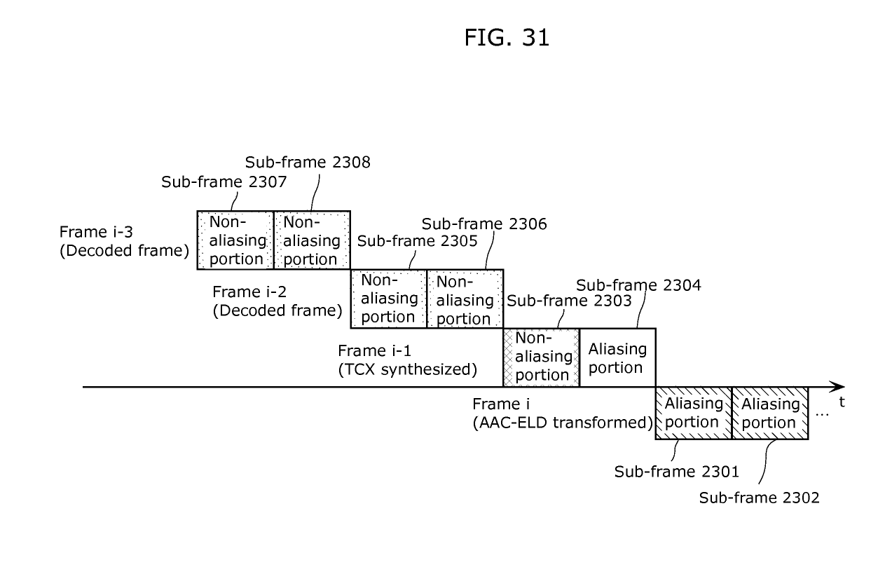

The following describes a decoding method performed by the hybrid sound signal decoder 900 to decode a signal encoded by the hybrid sound signal encoder 500 as illustrated in FIG. 31.

### [4-2-1. Method of Decoding Current Frame i]

When the current frame i is to be decoded, the block switching unit 904 performs the decoding process using three signals described below to reduce the aliasing components.

Firstly, a signal is used which corresponds to the frame i−3 among frames represented by a signal obtained by applying inverse transform on the current frame i using the AAC-ELD low delay filter bank and then applying a window on the inverse transformed current frame i. This signal is denoted as a sub-frame 2301 and a sub-frame 2302 in FIG. 31.

Secondly, a TCX synthesized signal [aᵢ₋₁, bᵢ₋₁] is used which is obtained by decoding the frame i−1 through the TCX decoding process. This signal is denoted as a sub-frame 2303 and a sub-frame 2304 in FIG. 31.

Thirdly, the signal [aᵢ₋₃, bᵢ₋₃] of the frame i−3 is used which is obtained by decoding the frame i−3 through the TCX decoding process. The signal of the frame i−3 is denoted as a sub-frame 2307 and a sub-frame 2308 in FIG. 31.

The signal (eighth signal denoted as the sub-frame 2301 and the sub-frame 2302 in FIG. 31) corresponding to the frame i−3 among the frames represented by the signal obtained by applying inverse transform on the current frame i using the AAC-ELD low delay filter bank and then applying a window on the inverse transformed current frame i is given by the following equations:

[c₋₄]ᵢ=(−aᵢ₋₂w₁−(bᵢ₋₃w₂)_{R}+aᵢ₊₁w₅+(bᵢ₋₁w₆)_{R})w_{R,8} [Math. 74]

[d₋₄]ᵢ=(−(aᵢ₋₃w₁)_{R}−bᵢ₋₃w₂+(aᵢ₋₁w₅)_{R}+bᵢ₋₁w₆)w_{R,7} [Math. 75]

For convenience of the description, the TCX synthesized signal [aᵢ₋₁, bᵢ₋₁] obtained by decoding the frame i−1 through the TCX decoding process is divided as follows:

$$[ \underbrace{{a}_{i - 1}}_{N / 2} , \underbrace{{b}_{i - 1 , 1}}_{N / 4} , \underbrace{{b}_{i - 1 , 2}}_{N / 4} ] \qquad [ Math . 76 ]$$

To correspond to this, the window [w₇, w₈] is divided as follows:

$$[ \underbrace{{w}_{7}}_{N / 2} , \underbrace{{w}_{8 , 1}}_{N / 4} , \underbrace{{w}_{8 , 2}}_{N / 4} ] \qquad [ Math . 77 ]$$

The TCX synthesized signal denoted as the sub-frames 2303 and 2304 contains the aliasing components because a subsequent frame has not been encoded in TCX coding mode. The TCX synthesized signal is thus expressed as follows:

$$[ \underbrace{{a}_{i - 1}}_{N / 2} , \underbrace{{b}_{i - 1 , 1}}_{N / 4} , \underbrace{{b}_{i - 1 , 2} + aliasing}_{N / 4} ] \qquad [ Math . 78 ]$$

Here, taking the properties of the analysis window w₈ into consideration, i.e., taking w_{8,2}=0 into consideration, application of the window [w₇, w₈] on the TCX synthesized signal

$$\begin{matrix}[ \underbrace{{a}_{i - 1}}_{N / 2} , \underbrace{{b}_{i - 1 , 1}}_{N / 4} , \underbrace{{b}_{i - 1 , 2} + aliasing}_{N / 4} ] \\ gives & [ Math . 79 ] \\ [ \underbrace{{a}_{i - 1}}_{N / 2} {w}_{7} , \underbrace{{b}_{i - 1 , 1} {w}_{8 , 1}}_{N / 4} , 0 ] & [ Math . 80 ]\end{matrix}$$

This is actually equivalent to

$$[ \underbrace{{a}_{i - 1}}_{N / 2} {w}_{7} , \underbrace{{b}_{i - 1} {w}_{8}}_{N / 2} ] \qquad [ Math . 81 ]$$

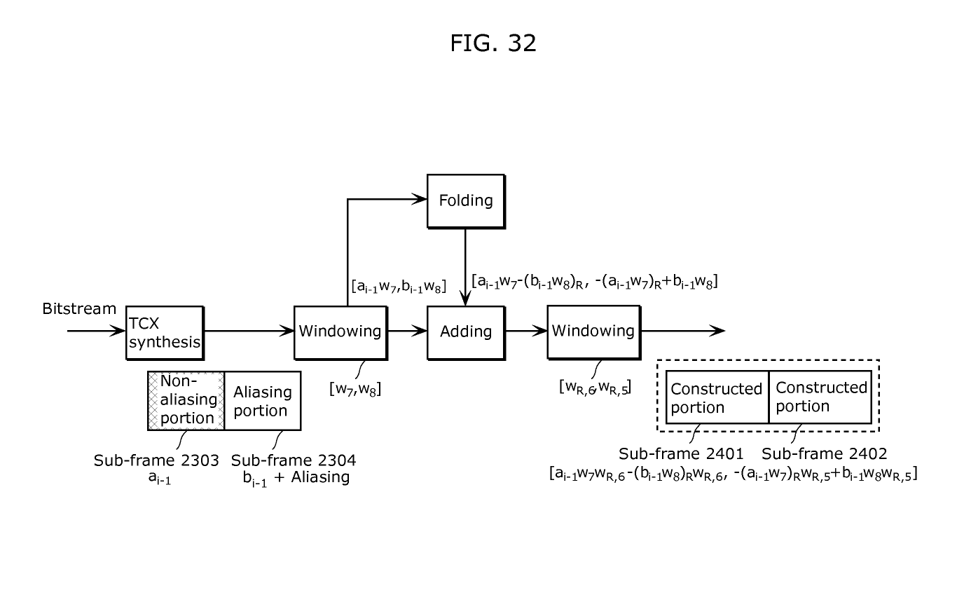

illustrated in FIG. 32.

Thus, the method of generating sub-frames 2401 and 2402 illustrated in FIG. 32 is the same as the method illustrated in FIG. 20A.

This means that the subsequent process is the same as the method described using FIG. 20B. More specifically, the sub-frames 1401, 1402, 1407, 1408, 1501, and 1502 in FIG. 20B are replaced with the sub-frames 2301, 2302, 2307, 2308, 2401, and 2402, respectively.

[4-2-2. Method of Decoding Current Frame i+1]

When the current frame i+1 is to be decoded, the block switching unit 904 performs the decoding process using three signals described below to reduce the aliasing components.

Firstly, a signal (ninth signal) is used which corresponds to the frame i−2 among frames represented by a signal obtained by applying inverse transform on the current frame i+1 using the AAC-ELD low delay filter bank and then applying a window on the inverse transformed current frame i+1.

Secondly, a signal (tenth signal) is used which corresponds to the frame i−2 among frames represented by a signal obtained by applying inverse transform on the frame i using the AAC-ELD low delay filter bank and then applying a window on the inverse transformed frame i.

The above ninth signal and tenth signal are the same as those described using FIG. 21.

Thirdly, the signal [aᵢ₋₂, bᵢ₋₂] of the current frame i−2 is used which is obtained by decoding the frame i−2 through the TCX decoding process. This signal is denoted as a sub-frame 2305 and a sub-frame 2306 in FIG. 31.

The method of decoding the current frame i+1 using the above three signals is the same as the method described using FIG. 21. Specifically, the sub-frames 1405 and 1406 in FIG. 21 are replaced with the sub-frames 2305 and 2306, respectively.

[4-2-3. Method of Decoding Current Frame i+2]

When the current frame i+2 is to be decoded, the block switching unit 904 performs the decoding process using five signals described below to reduce the aliasing components.

Firstly, a signal (sixteenth signal) is used which corresponds to the frame i−1 (aliasing portion) among frames represented by a signal obtained by applying inverse transform on the frame i+2 using the AAC-ELD low delay filter bank and then applying a window on the inverse transformed frame i+2.

Secondly, a signal (eighteenth signal) is used which corresponds to the frame i−1 (aliasing portion) among frames represented by a signal obtained by applying inverse transform on the frame i using the AAC-ELD low delay filter bank and then applying a window on the inverse transformed frame i.

Thirdly, a signal (seventeenth signal) is used which corresponds to the frame i−1 (aliasing portion) among frames represented by a signal obtained by applying inverse transform on the frame i+1 using the AAC-ELD low delay filter bank and then applying a window on the inverse transformed frame i+1.

The above sixteenth signal, seventeenth signal, and eighteenth signal are the same as those described using FIG. 22.

Fourthly, a signal [aᵢ₋₃, bᵢ₋₃] obtained by decoding the frame i−3 through the TCX decoding process is used.

Fifthly, a signal [aᵢ₋₁, bᵢ₋₁] obtained by decoding the frame i−1 through the TCX decoding process is used.

The method of decoding the current frame i+2 using the above five signals is the same as the method described using FIG. 22. Specifically, the sub-frames 1407 and 1408 in FIG. 22 are replaced with the sub-frames 2307 and 2308, respectively. Furthermore, the sub-frames 1601 and 1602 illustrated in FIG. 22 are replaced with a frame generated by the method described in relation to the method of decoding the current frame i (method of replacing a frame with a frame in TCX coding mode in FIG. 20B).

### [4-3. Amount of Delay]

Next, the following describes the amount of delay in the encoding and decoding processes according to Embodiment 4 described above.

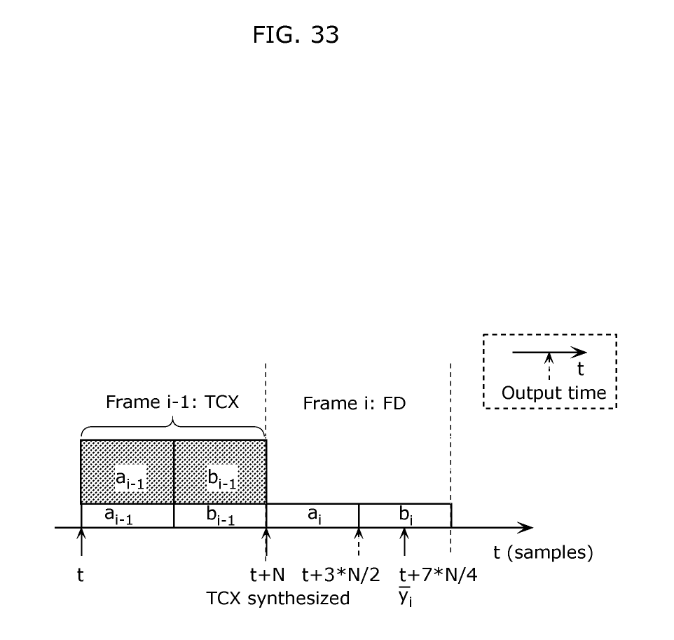

FIG. 33 illustrates the amount of delay in the encoding and decoding processes according to Embodiment 4. In FIG. 33, it is assumed that the encoding process on the frame i−1 starts at a time t.

The TCX synthesized signal of the frame i−1 is obtained at the time t+N samples. Thus, the sub-frames 2401 and 2402 (sub-frames 2303 and 2304) are obtained at the time t+N samples.

The sub-frames 2307 and 2308 are already obtained because they are signals reconstructed by decoding previous frames.

As discussed earlier, due to the window features of the low delay filter bank in AAC-ELD, the IMDCT transformed output of the frame i is obtained at the time t+7*N/4 samples. Thus, the sub-frames 2301 and 2302 are obtained at the time t+7*N/4 samples. However, because the synthesis window w_{R,8} which is zero for the first N/4 samples is applied to the sub-frame 2301, the sound output can start N/4 samples before the sub-frame 2301 is completely obtained.

Thus, the output of the signal [aᵢ₋₁, bᵢ₋₁] reconstructed in the above manner starts at the time t+3*N/2 samples, and the amount of delay is (t+3*N/2)−t=3*N/2 samples.

### [4-4. Conclusion]

As described above, the hybrid sound signal encoder 500 and the hybrid sound signal decoder 900 can reduce the aliasing introduced when decoding a transition frame which is the initial frame after the coding mode is switched from TCX coding mode to FD coding mode, and realize seamless switching between the TCX decoding technology and the FD decoding technology.

To achieve even higher sound quality, the hybrid sound signal decoder 900 may further include a synthesis error compensation (SEC) device. The signal reconstructing method in this case is the same as that illustrated in FIG. 24 to FIG. 26.

### Embodiment 5

Embodiment 5 describes an encoding method performed by a hybrid sound signal encoder when encoding a transient signal and a decoding method performed by a hybrid sound signal decoder when decoding a transient signal. In Embodiment 5, the configuration of the hybrid sound signal encoder 500 is the same as the configuration illustrated in FIG. 9, but the ACELP encoder 504 in FIG. 9 is optional. Similarly, the configuration of the hybrid sound signal decoder 900 is the same as the configuration illustrated in FIG. 14, but the ACELP decoder 903 in FIG. 14 is optional.

A long window (window having a long time width) is used in FD coding mode, and thus FD coding mode is not suitable for encoding a transient signal, whose energy (=signal power, i.e., a value which varies proportionately with a sum of squares of the amplitude of a sound signal included in a frame to be encoded) changes abruptly. In other words, a short window (window having a short time width) may be used when processing a transient signal.

### [5-1. Encoding Method]

First, when the current frame i is a transient signal (transient frame), a signal added with a component X generated from a signal [aᵢ₋₁, bᵢ₋₁] of the previous frame i−1 is encoded to encode the current frame i. More specifically, the block switching unit 502 generates an extended frame by combining the component X and a signal [aᵢ, bᵢ] of the frame i. The extended frame is in a length of (N+N/2). The extended frame is sent to the TCX encoder 507 by the block switching unit 502 and encoded in TCX coding mode. Here, the TCX encoder 507 performs TCX encoding in short window mode of the MDCT filter bank. The encoded frame here is the same as that described using FIG. 27. The component X is generated by the same method as that described using FIG. 8A and FIG. 8B.

Although the determination as to whether or not the current frame i is a transient signal is based on, for example, whether or not the energy of the current frame is above a predetermined threshold, the present invention is not limited to this method.

### [5-2. Decoding Method]

A method of decoding the transient frame encoded in the above manner is the same as the decoding method performed when the signal to be decoded is switched from a signal encoded in FD coding mode to a signal encoded in TCX coding mode. That is to say, it is the same as the method described using FIG. 12A or FIG. 28.

The amount of delay in the encoding and decoding processes according to Embodiment 5 is the same as that of Embodiments 1 and 3, i.e., 7*N/4 samples.

### [5-3. Conclusion]

As described above, the sound quality can be further increased by the hybrid sound signal encoder 500 encoding, in TCX coding mode, the transient frame when the encoding is being performed in FD coding mode, and by the hybrid sound signal decoder 900 decoding the encoded transient frame.

To achieve even higher sound quality, the hybrid sound signal decoder 900 may further include a synthesis error compensation (SEC) device. The signal reconstructing method in this case is the same as that illustrated in FIG. 15.

### (Variation)

Although an aspect of the present invention has been described based on the above embodiments, the present invention is not limited to such embodiments.

For example, a CELP scheme other than ACELP, such as Vector Sum Excited Linear Prediction (VSELP) coding mode, may be used as LPD coding mode. A CELP scheme other than ACELP may be used for the decoding process, too.

Although the present embodiment has mainly described AAC-ELD mode as an example of FD coding mode, the present invention is applicable not only to AAC-ELD mode but also to a coding scheme which requires the overlapping process with plural previous frames.

The following cases are also included in the present invention.

(1) Each of the above-described devices can be realized specifically in the form of a computer system that includes a microprocessor, a ROM, a RAM, a hard disk unit, a display unit, a keyboard, a mouse, and the like. The RAM or the hard disk unit has a computer program stored therein. Each device achieves its function through the microprocessor's operation according to the computer program. Here, the computer program is a combination of plural instruction codes indicating instructions to the computer for achieving predetermined functions.

(2) The structural elements included in each of the above-described devices may be partly or entirely realized in the form of a single system Large Scale Integrated Circuit (LSI). The system LSI is an ultra-multifunctional LSI produced by integrating plural components on one chip, and is specifically a computer system that includes a microprocessor, a ROM, a RAM, and the like. The ROM has a computer program stored therein. The system LSI achieves its function as the microprocessor loads the computer program from the ROM into the RAM and performs an operation, such as computation, according to the loaded computer program.

(3) The structural elements included in each of the above-described devices may be partly or entirely realized in the form of an IC card or a single module that is removably connectable to the device. The IC card or the module is a computer system that includes a microprocessor, a ROM, a RAM, and the like. The IC card or the module may include the above-described ultra-multifunctional LSI. The IC card or the module achieves its function through the microprocessor's operation according to a computer program. The IC card or the module may be tamper resistant.

(4) The present invention may also be realized in the form of the methods described above. These methods may be realized in the form of a computer program that is implemented by a computer, or may be realized in the form of a digital signal which includes a computer program.

The present invention may also be realized in the form of a computer-readable recording medium, such as a flexible disk, a hard disk, a CD-ROM, an MO, a DVD, a DVD-ROM, a DVD-RAM, a Blu-ray Disc (BD), or a semiconductor memory, which has the computer program or the digital signal recorded thereon. The present invention may also be realized in the form of the digital signal recorded on these recording media.

The present invention may also be realized in the form of the computer program or the digital signal transmitted via an electric communication line, a wired or wireless communication line, a network such as the Internet, data broadcasting, and the like.

The present invention may also be realized in the form of a computer system that includes a microprocessor and a memory. In this case, the memory has a computer program stored therein, and the microprocessor may operate according to the computer program.

The program or the digital signal may be transferred after being recorded on a recording medium, or may be transferred via a network and the like, so that another independent computer system can execute the program or the digital signal.

(5) The above embodiments and variation may be combined.

The present invention is not limited to these embodiments or variation thereof. Those skilled in the art will readily appreciate that many modifications can be made to these embodiments or variation thereof and the structural elements of different embodiments or variation thereof can be combined to form another embodiment without materially departing from the novel teachings and advantages of the present invention. Accordingly, all such modifications are intended to be included within the scope of the present invention.

### INDUSTRIAL APPLICABILITY

The hybrid sound signal decoder and the hybrid sound signal encoder according to the present invention can encode and decode sound signals with high sound quality and low delay, and can be used for broadcasting systems, mobile TVs, mobile phone communication, teleconferences, and so on.

### REFERENCE SIGNS LIST

500 Hybrid sound signal encoder
501 High frequency encoder
502 Block switching unit
503 Signal classifying unit
504 ACELP encoder
505 FD encoder
506 Bit multiplexer
507 TCX encoder
508 Local decoder
509 Local encoder
900 Hybrid sound signal decoder
901 Demultiplexer
902 FD decoder
903 ACELP decoder
904 Block switching unit
905 High frequency decoder
906 TCX decoder
907 SEC device
1001 to 1005, 1101, 1102 Sub-frame
1401 to 1408, 1501, 1502, 1601, 1602 Sub-frame
1701, 1702, 1801, 1802 Sub-frame
2001 to 2005, 2301 to 2308, 2401, 2402 Sub-frame
2901, 2902, 3101, 3102, 3201, 3202 Sub-frame
3301, 3302 Sub-frame

1. A hybrid sound signal decoder which decodes a bitstream including audio frames encoded by an audio encoding process using a low delay filter bank and speech frames encoded by a speech encoding process using linear prediction coefficients, the hybrid sound signal decoder comprising:
a low delay transform decoder which decodes the audio frames using an inverse low delay filter bank process;
a speech signal decoder which decodes the speech frames; and
a block switching unit configured to perform control to (i) allow a current frame included in the bitstream to be decoded by the low delay transform decoder when the current frame is an audio frame and (ii) allow the current frame to be decoded by the speech signal decoder when the current frame is a speech frame,
wherein when the current frame is an ith frame which is an initial speech frame after switching from an audio frame to a speech frame,
the ith frame includes an encoded first signal generated using a signal of an i−1th frame before being encoded, the i−1th frame being one frame previous to the ith frame, and
the block switching unit is configured to
(1) generate a signal corresponding to a first half of the i−1th frame before being encoded, by adding (a) a signal obtained by applying a window on a sum of a signal corresponding to a first half of a frame represented by a second signal and a signal obtained by folding a signal corresponding to a latter half of the frame represented by the second signal, (b) a signal obtained by applying a window on the first signal obtained by decoding of the ith frame by the speech signal decoder, and (c) a signal corresponding to a first half of a frame represented by a third signal, the second signal being obtained by applying a window on a reconstructed signal of an i−3th frame that is three frames previous to the ith frame, the reconstructed signal of the i−3th frame being obtained by decoding, by the low delay transform decoder, of an i−2th frame that is two frames previous to the ith frame, the third signal corresponding to the i−3th frame among frames represented by a signal obtained by applying the inverse low delay filter bank process and a window on the i−1th frame, and
generate a signal corresponding to a latter half of the i−1th frame before being encoded, by adding (a) a signal obtained by applying a window on a sum of the signal corresponding to the latter half of the frame represented by the second signal and a signal obtained by folding the signal corresponding to the first half of the frame represented by the second signal, (b) a signal obtained by folding and applying a window on the first signal, and (c) a signal corresponding to a latter half of the frame represented by the third signal, or
(2) generate the signal corresponding to the first half of the i−1th frame before being encoded, by adding (a) the signal obtained by applying a window on a sum of the signal corresponding to the first half of the frame represented by the second signal and the signal obtained by folding the signal corresponding to the latter half of the frame represented by the second signal, (b) the signal obtained by folding and applying a window on the first signal, and (c) the signal corresponding to the first half of the frame represented by the third signal, and
generate the signal corresponding to the latter half of the i−1th frame before being encoded, by adding (a) the signal obtained by applying a window on a sum of the signal corresponding to the latter half of the frame represented by the second signal and the signal obtained by folding the signal corresponding to the first half of the frame represented by the second signal, (b) the signal obtained by applying a window on the first signal, and (c) the signal corresponding to the latter half of the frame represented by the third signal.

2. A hybrid sound signal decoder which decodes a bitstream including audio frames encoded by an audio encoding process using a low delay filter bank and speech frames encoded by a speech encoding process using linear prediction coefficients, the hybrid sound signal decoder comprising:
a low delay transform decoder which decodes the audio frames using an inverse low delay filter bank process;
a speech signal decoder which decodes the speech frames; and
a block switching unit configured to perform control to (i) allow a current frame included in the bitstream to be decoded by the low delay transform decoder when the current frame is an audio frame and (ii) allow the current frame to be decoded by the speech signal decoder when the current frame is a speech frame,
wherein when the current frame is an ith frame which is an initial audio frame after switching from a speech frame to an audio frame,
the block switching unit is configured to generate a reconstructed signal which is a signal corresponding to an i−1th frame before being encoded, by adding (a) a fifth signal obtained by applying a window on a sum of a fourth signal obtained by applying a window on a signal obtained by decoding of the i−1th frame by the speech signal decoder and a signal obtained by folding the fourth signal, (b) a seventh signal obtained by applying a window on a sum of a sixth signal obtained by applying a window on a signal obtained by decoding of an i−3th frame by the speech signal decoder and a signal obtained by folding the sixth signal, and (c) an eighth signal corresponding to the i−3th frame among frames represented by a signal obtained by applying the inverse low delay filter bank process and a window on the ith frame, the i−1th frame being one frame previous to the ith frame, the i−3th frame being three frames previous to the ith frame.

3. The hybrid sound signal decoder according to claim 2,
wherein when the current frame is an i+1th frame that is one frame subsequent to the ith frame,
the block switching unit is configured to generate a signal corresponding to the ith frame before being encoded, by adding (a) a ninth signal corresponding to an i−2th frame among frames represented by a signal obtained by applying the inverse low delay filter bank process and a window on the i+1th frame, (b) a tenth signal corresponding to the i−2th frame among frames represented by a signal obtained by applying the inverse low delay filter bank process and a window on the ith frame, (c) a thirteenth signal obtained by applying a window on a combination of (c-1) a twelfth signal which is a sum of a signal corresponding to a first half of a frame represented by a signal obtained by applying a first window on an eleventh signal obtained by decoding of the i−2th frame by the speech signal decoder and a signal obtained by folding a signal corresponding to a latter half of the frame represented by the signal obtained by applying the first window on the eleventh signal and (c-2) a signal obtained by folding the twelfth signal, and (d) a fifteenth signal obtained by applying a window on a combination of (d-1) a fourteenth signal which is a sum of a signal corresponding to a first half of a frame represented by a signal obtained by applying, on the eleventh signal, a second window different from the first window and a signal obtained by folding a signal corresponding to a latter half of the frame represented by the signal obtained by applying the second window on the eleventh signal and (d-2) a signal obtained by folding the fourteenth signal and reversing a sign of the folded fourteenth signal, the i−2th frame being two frames previous to the ith frame.

4. The hybrid sound signal decoder according to claim 3,
wherein when the current frame is an i+2th frame that is two frames subsequent to the ith frame,
the block switching unit is configured to generate a signal corresponding to the i+1th frame before being encoded, by adding (a) a sixteenth signal corresponding to the i−1th frame among frames represented by a signal obtained by applying the inverse low delay filter bank process and a window on the i+2th frame, (b) a seventeenth signal corresponding to the i−1th frame among frames represented by a signal obtained by applying the inverse low delay filter bank process and a window on the i+1th frame, (c) an eighteenth signal corresponding to the i−1th frame among frames represented by a signal obtained by applying the inverse low delay filter bank process and a window on the ith frame, (d) a twenty-first signal obtained by applying a window on a combination of (d-1) a twentieth signal which is a sum of a signal corresponding to a first half of a frame represented by a signal obtained by applying a window on a nineteenth signal obtained by decoding of the i−3th frame by the speech signal decoder and a signal obtained by folding a signal corresponding to a latter half of the frame represented by the signal obtained by applying the window on the nineteenth signal and (d-2) a signal obtained by folding the twentieth signal, and (e) a twenty-third signal obtained by applying a window on a combination of (e-1) a twenty-second signal which is a sum of a signal corresponding to a first half of a frame represented by a signal obtained by applying a window on the reconstructed signal and a signal obtained by folding a signal corresponding to a latter half of the frame represented by the signal obtained by applying the window on the reconstructed signal and (e-2) a signal obtained by folding the twenty-second signal and reversing a sign of the folded twenty-second signal.

5. A hybrid sound signal decoder which decodes a bitstream including audio frames encoded by an audio encoding process using a low delay filter bank and speech frames encoded by a speech encoding process using linear prediction coefficients, the hybrid sound signal decoder comprising:
a low delay transform decoder which decodes the audio frames using an inverse low delay filter bank process;
a Transform Coded Excitation (TCX) decoder which decodes the speech frames encoded in a TCX scheme; and
a block switching unit configured to perform control to (i) allow a current frame included in the bitstream to be decoded by the low delay transform decoder when the current frame is an audio frame and (ii) allow the current frame to be decoded by the TCX decoder when the current frame is a speech frame,
wherein when the current frame is an ith frame which is an initial speech frame after switching from an audio frame to a speech frame and which is a frame including an encoded transient signal,
the ith frame includes an encoded first signal generated using a signal of an i−1th frame before being encoded, the i−1th frame being one frame previous to the ith frame, and
the block switching unit is configured to
(1) generate a signal corresponding to a first half of the i−1th frame before being encoded, by adding (a) a signal obtained by applying a window on a sum of a signal corresponding to a first half of a frame represented by a second signal and a signal obtained by folding a signal corresponding to a latter half of the frame represented by the second signal, (b) a signal obtained by applying a window on the first signal obtained by decoding of the ith frame by the TCX decoder, and (c) a signal corresponding to a first half of a frame represented by a third signal, the second signal being obtained by applying a window on a reconstructed signal of an i−3th frame that is three frames previous to the ith frame, the reconstructed signal of the i−3th frame being obtained by decoding, by the low delay transform decoder, of an i−2th frame that is two frames previous to the ith frame, the third signal corresponding to the i−3th frame among frames represented by a signal obtained by applying the inverse low delay filter bank process and a window on the i−1th frame, and
generate a signal corresponding to a latter half of the i−1th frame before being encoded, by adding (a) a signal obtained by applying a window on a sum of the signal corresponding to the latter half of the frame represented by the second signal and a signal obtained by folding the signal corresponding to the first half of the frame represented by the second signal, (b) a signal obtained by folding and applying a window on the first signal, and (c) a signal corresponding to a latter half of the frame represented by the third signal, or
(2) generate the signal corresponding to the first half of the i−1th frame before being encoded, by adding (a) the signal obtained by applying a window on a sum of the signal corresponding to the first half of the frame represented by the second signal and the signal obtained by folding the signal corresponding to the latter half of the frame represented by the second signal, (b) the signal obtained by folding and applying a window on the first signal, and (c) the signal corresponding to the first half of the frame represented by the third signal, and
generate the signal corresponding to the latter half of the i−1th frame before being encoded, by adding (a) the signal obtained by applying a window on a sum of the signal corresponding to the latter half of the frame represented by the second signal and the signal obtained by folding the signal corresponding to the first half of the frame represented by the second signal, (b) the signal obtained by applying a window on the first signal, and (c) the signal corresponding to the latter half of the frame represented by the third signal.

6. The hybrid sound signal decoder according to claim 1,
wherein the low delay transform decoder is an Advanced Audio Coding—Enhanced Low Delay (AAC-ELD) decoder which decodes each of the audio frames by applying an overlapping and adding process on each of signals obtained by applying the inverse low delay filter bank process and a window on the audio frame and each of three temporally consecutive frames which are previous to the audio frame.

7. The hybrid sound signal decoder according to claim 1,
wherein the speech signal decoder is an Algebraic Code Excited Linear Prediction (ACELP) decoder which decodes the speech frames encoded using ACELP coefficients.

8. The hybrid sound signal decoder according to claim 1,
wherein the speech signal decoder is a Transform Coded Excitation (TCX) decoder which decodes the speech frames encoded in a TCX scheme.

9. The hybrid sound signal decoder according to claim 1, further comprising
a synthesis error compensation device which decodes synthesis error information encoded with the current frame,
wherein the synthesis error information is information indicating a difference between a signal representing the bitstream before being encoded and a signal obtained by decoding the bitstream, and
the synthesis error compensation device corrects, using the decoded synthesis error information, the signal generated by the block switching unit and representing the i−1th frame before being encoded, a signal generated by the block switching unit and representing the ith frame before being encoded, or a signal generated by the block switching unit and representing an i+1th frame before being encoded.

10. A hybrid sound signal encoder comprising:
a signal classifying unit configured to analyze audio characteristics of a sound signal to determine whether a frame included in the sound signal is an audio signal or a speech signal;
a low delay transform encoder which encodes the frame using a low delay filter bank;
a speech signal encoder which encodes the frame by calculating linear prediction coefficients of the frame; and
a block switching unit configured to perform control to (i) allow a current frame to be encoded by the low delay transform encoder when the signal classifying unit determines that the current frame is an audio signal and (ii) allow the current frame to be encoded by the speech signal encoder when the signal classifying unit determines that the current frame is a speech signal,
wherein when the current frame is an ith frame which is one frame subsequent to an i−1th frame determined as a speech signal by the signal classifying unit and which is determined as an audio signal by the signal classifying unit,
the block switching unit is configured to
(1) allow the speech signal encoder to encode the ith frame and a signal which is a sum of a signal obtained by applying a window on a signal corresponding to a first half of the i−1th frame and a signal obtained by applying a window and folding on a signal corresponding to a latter half of the i−1th frame, or
(2) allow the speech signal encoder to encode the ith frame and a signal which is a sum of a signal obtained by applying a window on the signal corresponding to the latter half of the i−1th frame and a signal obtained by applying a window and folding on the signal corresponding to the first half of the i−1th frame.

11. A hybrid sound signal encoder comprising:
a signal classifying unit configured to analyze audio characteristics of a sound signal to determine whether a frame included in the sound signal is an audio signal or a speech signal;
a low delay transform encoder which encodes the frame using a low delay filter bank;
a Transform Coded Excitation (TCX) encoder which encodes the frame in a TCX scheme by applying a Modified Discrete Cosine Transform (MDCT) on residuals of the linear prediction coefficients of the frame; and
a block switching unit configured to perform control to (i) allow a current frame to be encoded by the low delay transform encoder when the signal classifying unit determines that the current frame is an audio signal and (ii) allow the current frame to be encoded by the TCX encoder when the signal classifying unit determines that the current frame is a speech signal,
wherein when an ith frame which is the current frame is a frame determined by the signal classifying unit as an audio signal and as a transient signal an energy of which changes abruptly,
the block switching unit is configured to
(1) allow the TCX encoder to encode the ith frame and a signal which is a sum of a signal obtained by applying a window on a signal corresponding to a first half of an i−1th frame which is one frame previous to the ith frame and a signal obtained by applying a window and folding on a signal corresponding to a latter half of the i−1th frame, or
(2) allow the TCX encoder to encode the ith frame and a signal which is a sum of a signal obtained by applying a window on the signal corresponding to the latter half of the i−1th frame and a signal obtained by applying a window and folding on the signal corresponding to the first half of the i−1th frame.

12. The hybrid sound signal encoder according to claim 10,
wherein the low delay transform encoder is an Advanced Audio Coding—Enhanced Low Delay (AAC-ELD) encoder which encodes the frame by applying a window and a low delay filter bank process on an extended frame combining the frame and three temporally consecutive frames which are previous to the frame.

13. The hybrid sound signal encoder according to claim 10,
wherein the speech signal encoder is an Algebraic Code Excited Linear Prediction (ACELP) encoder which encodes the frame by generating ACELP coefficients.

14. The hybrid sound signal encoder according to claim 10,
wherein the speech signal encoder is a Transform Coded Excitation (TCX) encoder which encodes the frame by applying a Modified Discrete Cosine Transform (MDCT) on residuals of the linear prediction coefficients.

15. The hybrid sound signal encoder according to claim 10, further comprising:
a local decoder which decodes the sound signal which has been encoded; and
a local encoder which encodes synthesis error information which is a difference between the sound signal and the sound signal decoded by the local decoder.

16. A sound signal decoding method for decoding a bitstream including audio frames encoded by an audio encoding process using a low delay filter bank and speech frames encoded by a speech encoding process using linear prediction coefficients, the sound signal decoding method comprising:
decoding the audio frames using an inverse low delay filter bank process;
decoding the speech frames; and
performing control to (i) allow a current frame included in the bitstream to be decoded in the decoding of the audio frames using the inverse low delay filter bank process when the current frame is an audio frame and (ii) allow the current frame to be decoded in the decoding of the speech frames when the current frame is a speech frame,
wherein when the current frame is an ith frame which is an initial speech frame after switching from an audio frame to a speech frame,
the ith frame includes an encoded first signal generated using a signal of an i−1th frame before being encoded, the i−1th frame being one frame previous to the ith frame, and
in the performing of control,
(1) a signal is generated which corresponds to a first half of the i−1th frame before being encoded, by adding (a) a signal obtained by applying a window on a sum of a signal corresponding to a first half of a frame represented by a second signal and a signal obtained by folding a signal corresponding to a latter half of the frame represented by the second signal, (b) a signal obtained by applying a window on the first signal obtained by decoding of the ith frame in the decoding of the speech frames, and (c) a signal corresponding to a first half of a frame represented by a third signal, the second signal being obtained by applying a window on a reconstructed signal of an i−3th frame that is three frames previous to the ith frame, the reconstructed signal of the i−3th frame being obtained by decoding, in the decoding of the audio frames using the inverse low delay filter bank process, of an i−2th frame that is two frames previous to the ith frame, the third signal corresponding to the i−3th frame among frames represented by a signal obtained by applying the inverse low delay filter bank process and a window on the i−1th frame, and
a signal is generated which corresponds to a latter half of the i−1th frame before being encoded, by adding (a) a signal obtained by applying a window on a sum of the signal corresponding to the latter half of the frame represented by the second signal and a signal obtained by folding the signal corresponding to the first half of the frame represented by the second signal, (b) a signal obtained by folding and applying a window on the first signal, and (c) a signal corresponding to a latter half of the frame represented by the third signal, or
(2) the signal is generated which corresponds to the first half of the i−1th frame before being encoded, by adding (a) the signal obtained by applying a window on a sum of the signal corresponding to the first half of the frame represented by the second signal and the signal obtained by folding the signal corresponding to the latter half of the frame represented by the second signal, (b) the signal obtained by folding and applying a window on the first signal, and (c) the signal corresponding to the first half of the frame represented by the third signal, and
the signal is generated which corresponds to the latter half of the i−1th frame before being encoded, by adding (a) the signal obtained by applying a window on a sum of the signal corresponding to the latter half of the frame represented by the second signal and the signal obtained by folding the signal corresponding to the first half of the frame represented by the second signal, (b) the signal obtained by applying a window on the first signal, and (c) the signal corresponding to the latter half of the frame represented by the third signal.

17. A sound signal decoding method for decoding a bitstream including audio frames encoded by an audio encoding process using a low delay filter bank and speech frames encoded by a speech encoding process using linear prediction coefficients, the sound signal decoding method comprising:
decoding the audio frames using an inverse low delay filter bank process;
decoding the speech frames; and
performing control to (i) allow a current frame included in the bitstream to be decoded in the decoding of the audio frames using the inverse low delay filter bank process when the current frame is an audio frame and (ii) allow the current frame to be decoded in the decoding of the speech frames when the current frame is a speech frame,
wherein in the performing of control,
when the current frame is an ith frame which is an initial audio frame after switching from a speech frame to an audio frame,
a reconstructed signal is generated which is a signal corresponding to an i−1th frame before being encoded, by adding (a) a fifth signal obtained by applying a window on a sum of a fourth signal obtained by applying a window on a signal obtained by decoding of the i−1th frame in the decoding of the speech frames and a signal obtained by folding the fourth signal, (b) a seventh signal obtained by applying a window on a sum of a sixth signal obtained by applying a window on a signal obtained by decoding of an i−3th frame in the decoding of the speech frames and a signal obtained by folding the sixth signal, and (c) an eighth signal corresponding to the i−3th frame among frames represented by a signal obtained by applying the inverse low delay filter bank process and a window on the ith frame, the i−1th frame being one frame previous to the ith frame, the i−3th frame being three frames previous to the ith frame.

18. A sound signal decoding method for decoding a bitstream including audio frames encoded by an audio encoding process using a low delay filter bank and speech frames encoded by a speech encoding process using linear prediction coefficients, the sound signal decoding method comprising:
decoding the audio frames using an inverse low delay filter bank process;
decoding the speech frames encoded in a Transform Coded Excitation (TCX) scheme; and
performing control to (i) allow a current frame included in the bitstream to be decoded in the decoding of the audio frames using the inverse low delay filter bank process when the current frame is an audio frame and (ii) allow the current frame to be decoded in the decoding of the speech frames encoded in the TCX scheme when the current frame is a speech frame,
wherein when the current frame is an ith frame which is an initial speech frame after switching from an audio frame to a speech frame and which is a frame including an encoded transient signal an energy of which changes abruptly,
the ith frame includes an encoded first signal generated using a signal of an i−1th frame before being encoded, the i−1th frame being one frame previous to the ith frame, and
in the performing of control,
(1) a signal is generated which corresponds to a first half of the i−1th frame before being encoded, by adding (a) a signal obtained by applying a window on a sum of a signal corresponding to a first half of a frame represented by a second signal and a signal obtained by folding a signal corresponding to a latter half of the frame represented by the second signal, (b) a signal obtained by applying a window on the first signal obtained by decoding of the ith frame in the decoding of the speech frames encoded in the TCX scheme, and (c) a signal corresponding to a first half of a frame represented by a third signal, the second signal being obtained by applying a window on a reconstructed signal of an i−3th frame that is three frames previous to the ith frame, the reconstructed signal of the i−3th frame being obtained by decoding, in the decoding of the audio frames using the inverse low delay filter bank process, of an i−2th frame that is two frames previous to the ith frame, the third signal corresponding to the i−3th frame among frames represented by a signal obtained by applying the inverse low delay filter bank process and a window on the i−1th frame, and
a signal is generated which corresponds to a latter half of the i−1th frame before being encoded, by adding (a) a signal obtained by applying a window on a sum of the signal corresponding to the latter half of the frame represented by the second signal and a signal obtained by folding the signal corresponding to the first half of the frame represented by the second signal, (b) a signal obtained by folding and applying a window on the first signal, and (c) a signal corresponding to a latter half of the frame represented by the third signal, or
(2) the signal is generated which corresponds to the first half of the i−1th frame before being encoded, by adding (a) the signal obtained by applying a window on a sum of the signal corresponding to the first half of the frame represented by the second signal and the signal obtained by folding the signal corresponding to the latter half of the frame represented by the second signal, (b) the signal obtained by folding and applying a window on the first signal, and (c) the signal corresponding to the first half of the frame represented by the third signal, and
the signal is generated which corresponds to the latter half of the i−1th frame before being encoded, by adding (a) the signal obtained by applying a window on a sum of the signal corresponding to the latter half of the frame represented by the second signal and the signal obtained by folding the signal corresponding to the first half of the frame represented by the second signal, (b) the signal obtained by applying a window on the first signal, and (c) the signal corresponding to the latter half of the frame represented by the third signal.

19. A sound signal encoding method comprising:
analyzing audio characteristics of a sound signal to determine whether a frame included in the sound signal is an audio signal or a speech signal;
encoding the frame using a low delay filter bank;
encoding the frame by calculating linear prediction coefficients of the frame; and
performing control to (i) allow a current frame to be encoded in the encoding of the frame using the low delay filter bank when it is determined in the analyzing that the current frame is an audio signal and (ii) allow the current frame to be encoded in the encoding of the frame by calculating the linear prediction coefficients of the frame when it is determined in the analyzing that the current frame is a speech signal,
wherein in the performing of control,
when the current frame is an ith frame which is one frame subsequent to an i−1th frame determined as a speech signal in the analyzing and which is determined as an audio signal in the analyzing,
(1) the ith frame and a signal which is a sum of a signal obtained by applying a window on a signal corresponding to a first half of the i−1th frame and a signal obtained by applying a window and folding on a signal corresponding to a latter half of the i−1th frame are allowed to be encoded in the encoding of the frame by calculating the linear prediction coefficients of the frame, or
(2) the ith frame and a signal which is a sum of a signal obtained by applying a window on the signal corresponding to the latter half of the i−1th frame and a signal obtained by applying a window and folding on the signal corresponding to the first half of the i−1th frame are allowed to be encoded in the encoding of the frame by calculating the linear prediction coefficients of the frame.

20. A sound signal encoding method comprising:
analyzing audio characteristics of a sound signal to determine whether a frame included in the sound signal is an audio signal or a speech signal;
encoding the frame using a low delay filter bank;
encoding the frame in a Transform Coded Excitation (TCX) scheme by applying a Modified Discrete Cosine Transform (MDCT) on residuals of linear prediction coefficients of the frame; and
performing control to (i) allow a current frame to be encoded in the encoding of the frame using the low delay filter bank when it is determined in the analyzing that the current frame is an audio signal and (ii) allow the current frame to be encoded in the encoding of the frame in the TCX scheme when it is determined in the analyzing that the current frame is a speech signal,
wherein in the performing of control,
when an ith frame which is the current frame is a frame determined in the analyzing as an audio signal and as a transient signal an energy of changes abruptly,
(1) the ith frame and a signal which is a sum of a signal obtained by applying a window on a signal corresponding to a first half of an i−1th frame which is one frame previous to the ith frame and a signal obtained by applying a window and folding on a signal corresponding to a latter half of the i−1th frame are allowed to be encoded in the encoding of the frame in the TCX scheme, or
(2) the ith frame and a signal which is a sum of a signal obtained by applying a window on the signal corresponding to the latter half of the i−1th frame and a signal obtained by applying a window and folding on the signal corresponding to the first half of the i−1th frame are allowed to be encoded in the encoding of the frame in the TCX scheme.
